(19) United States
(12) Patent Application Publication
(10) Pub. No.: US 2006/0080321 A1
(43) Pub. Date: Apr. 13, 2006

(54) System and method for processing requests for contextual information

(75) Inventors: Jeremy Horn, Forest Hills, NY (US); Lai Kwan Wong, Flushing, NY (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: WhenU.com, Inc., New York, NY (US)

(21) Appl. No.: 11/192,319

(22) Filed: Jul. 29, 2005

Related U.S. Application Data
(63) Continuation-in-part of application No. 10/946,620, filed on Sep. 22, 2004.
(63) Continuation-in-part of application No. 11/065,300, filed on Feb. 25, 2005.
(63) Continuation-in-part of application No. 11/094,475, filed on Mar. 31, 2005.

(51) Int. Cl. G06F 17/30

(52) U.S. Cl. 707/10

(57) ABSTRACT

A system and method for processing a request for contextual information. The method comprises the steps of receiving a request for contextual information from a client, determining particulars of the request. The method also comprises the step of determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

### RELATED APPLICATION

The present patent application is a continuation-in-part of a previously filed utility patent application entitled “System and Method for Providing Contextual Information,” filed Sep. 22, 2004, as U.S. patent application Ser. No. 10/946,620. The present patent application is also a continuation-in-part of a previously filed utility patent application entitled “Enhancement and Diagnostic Tools for Use in a Contextual Information Environment,” filed Feb. 25, 2005, as U.S. patent application Ser. No. 11/065,300. The present patent application is also a continuation-in-part of a previously filed utility patent application entitled “System and Method for Determining Whether to Present Contextual Information,” filed Mar. 31, 2005, as U.S. patent application Ser. No. 11/094,475. The present application is also a continuation-in-part of a utility patent application entitled “System and Method for Integrating Contextuality Determinations,” filed on even date herewith, as U.S. patent application Ser. No. ______. The specifications and drawings of the utility patent applications are specifically and entirely incorporated herein by reference.

### FIELD OF THE INVENTION

The present invention is directed to systems and methods for processing requests for contextual information received from a client station.

### BACKGROUND OF THE INVENTION

The impact of the Internet on commercial activity has been significant. Users can browse thousands of web sites and pages to make purchases or obtain information on virtually any topic. As more users get comfortable with online transactions, demand for services that fully exploit the online marketplace will undoubtedly increase.

Online advertisers is one group that seeks to capture online traffic. While most online advertising occurs randomly—i.e., irrespective of the user's online activities—some advertising is directed based on a user's demonstrated interest. For example, advertising can be based on the user's browsing history, the content of web sites or pages visited, and online searches conducted by the user. While current directed advertising is an improvement over random advertising, it suffers from several notable drawbacks. First, advertisements have to be directly connected to the activity, circumstance, or occurrence that initiates presentation to the user. That is, each advertisement must be directly connected to those web sites or pages, for example, that trigger its presentation. Second, current systems do not allow administrators of online advertising systems to readily define, edit, and/or delete rules for directed advertising. Third, current systems do not provide various enhancement and diagnostic tools and features that streamline the determination, development, coordination and delivery of contextual information.

These and other problems exist.

### SUMMARY OF THE INVENTION

An object of the present invention is to overcome the aforementioned and other drawbacks existing in prior art systems and methods.

The various systems and methods described herein may comprise or operate server-side logic that enhances or augments client-side contextuality determinations or requests sent to a server, for example, for resolution or fulfillment. Client-side contextuality determinations or requests may comprise any request for contextual information relevant to a user's interaction with a network and/or application or program, such as those provided by the various systems and methods described below and in FIGS. 1-46e. In some embodiments, SP logic module 470 may parse and analyze incoming requests for contextual information and make supplemental decisions that enhance or refine the request to increase the probability that the contextual information ultimately provided in response to the request is of high value and relevancy. Such supplemental decisions may comprise: (1) enhancing, adding, or deleting select particulars of the request, (2) determining at least one appropriate sponsor or provider to fulfill the request, and (3) determining which of the appropriate contextual information (received from the appropriate sponsors or providers) to present to the client in response to the request.

For example, assume a user is browsing a network (e.g., Internet) and sending email to a friend from a particular client station. The user's interaction with the Internet and with the email application or program may result in a contextuality request being generated by the client station that comprises particulars about the user's interaction with the Internet and the email application or program. Such particulars may comprise URLs, keywords, search terms, phrases, strings, tokens, concepts, or any other data or information related to a user's browsing history or, if the user permits, the content or context of the user's email correspondence. That is, the request may comprise contextuality determinations about the user's interaction with the network and/or the user's interaction with the application or program. Upon receiving the request from client station, a central control station (e.g., SP logic module), for example, may process and analyze the request's particulars to enhance the ability of the request to produce contextual information of high value and relevance. For example, particular keywords may be added to the request or replaced if doing so enhances the request's ability to produce valuable contextual information. The central control module (e.g., SP logic module) may also determine which particular sponsors or provides may fulfill the request, and which contextual information will ultimately be delivered to the client station for presentation. In some embodiments, SP logic module may make a determination whether a trigger decision (e.g., request) made at a client station, including all component variables, may be improved.

For example, if a request arrives at SP logic module that contains a category for automobiles. However, historically users have responded favorably (e.g., initiated or clicked on) advertisements that relate specifically to a particular manufacturer of cars. SP logic may therefore make a determination to enhance the request by adding a keyword, for example, that results in or increases the likelihood that an advertisement from that particular manufacturer will be pulled.

In some embodiments, the SP logic module may enhance the response (e.g., contextual information) received from a sponsor or provider in response to a client-side decision to show contextually relevant information. In some embodiments, enhancements are made without using personally identifiable information (PII) of a user or a user's browsing activity or history. That is, in some embodiments, no such information is transmitted to or used by SP logic module to perform the various features and functionality described herein.

According to one embodiment of the invention, a method for processing a request for contextual information is provided. The method comprises receiving a request for contextual information from a client; determining particulars of the request; and determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

In another embodiment of the invention, a system for processing a request for contextual information is provided. The system comprises a request interface module for receiving a request for contextual information from a client; a request processing module for determining particulars of the request; and determination means for determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

In another embodiment of the invention, a system for processing a request for contextual information is provided. The system comprises request reception means for receiving a request for contextual information from a client; request determination means for determining particulars of the request; and response determination means for determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a block diagram illustrating a system for providing contextual information, according to one embodiment of the invention.

FIG. 2 is a block diagram illustrating exemplary modules associated with a contextual information module, according to one embodiment of the invention.

FIG. 3 illustrates a method for providing contextual information, according to one embodiment of the invention.

FIG. 4 illustrates a method for providing contextual information, according to one embodiment of the invention.

FIG. 4a illustrates a method for providing contextual information, according to one embodiment of the invention.

FIG. 5 illustrates a method for creating a plurality of concept schemes, according to one embodiment of the invention.

FIG. 6 illustrates a general process flow for providing contextual information, according to one embodiment of the invention.

FIG. 7 illustrates information comprising a concept scheme for determining contextual information to provide a user, according to one embodiment of the invention.

FIG. 8 illustrates information relevant to a particular form of contextual information, according to one embodiment of the invention.

FIG. 9 illustrates information comprising a concept scheme for determining contextual information to provide a user, according to one embodiment of the invention.

FIG. 10 illustrates information relevant to sending a request with details to a sponsor or provider to identify contextual information to provide a user, according to one embodiment of the invention.

FIG. 11 is a block diagram illustrating exemplary modules associated with a contextual information module, according to one embodiment of the invention.

FIG. 12 is a block diagram illustrating exemplary modules associated with a session ID module, according to one embodiment of the invention.

FIG. 12a illustrates a process flow of various actions resulting from user-initiated activities.

FIG. 12b illustrates a method for monitoring, tracking and/or tracing actions resulting from user-initiated activity, according to one embodiment of the invention.

FIG. 13 is a block diagram illustrating exemplary modules associated with a download module, according to one embodiment of the invention.

FIG. 13a illustrates a process flow of downloaded or updated data or information, according to one embodiment of the invention.

FIG. 13b illustrates a method for downloading or updating data or information, according to one embodiment of the invention.

FIG. 13c illustrates a method for downloading or updating data or information, according to one embodiment of the invention.

FIG. 13d illustrates a method for downloading or updating data or information, according to one embodiment of the invention.

FIG. 14 is a block diagram illustrating exemplary modules associated with a geographic locator module, according to one embodiment of the invention.

FIG. 14a illustrates a process flow of determining geographic location based on IP address, according to one embodiment of the invention.

FIG. 14b illustrates a method for determining geographic location based on IP address, according to one embodiment of the invention.

FIG. 15 is a block diagram illustrating exemplary modules associated with a search term/phrase extractor module, according to one embodiment of the invention.

FIG. 15a illustrates a process flow for determining appropriate rule(s) for extracting search terms/phrases from a uniform resource locator, according to one embodiment of the invention.

FIG. 15b illustrates a method for determining the appropriate rule(s) for extracting search term(s)/phras(es) from a uniform resource locator, according to one embodiment of the invention.

FIG. 16 is a block diagram illustrating exemplary modules associated with a conversion failure identification module, according to one embodiment of the invention.

FIG. 16a is a process flow diagram illustrating paths generated by user-initiation of an online advertisement.

FIG. 16b is a method for tracking or tracing paths of user-initiated actions, according to one embodiment of the invention.

FIG. 17 is a block diagram illustrating exemplary modules associated with a scalable storage module, according to one embodiment of the invention.

FIG. 17a is a process flow diagram illustrating use of behavioral data and information, according to one embodiment of the invention.

FIG. 17b is a method for storing data or information, according to one embodiment of the invention.

FIG. 17c is a method using behavior data or information to determine whether to present contextual information to a user.

FIG. 18 is a block diagram illustrating an exemplary contextual information gateway module associated with a contextual information module, according to one embodiment of the invention.

FIG. 19 is a block diagram illustrating exemplary modules associated with the contextual information gateway module, according to one embodiment of the invention.

FIG. 19a is a block diagram illustrating exemplary modules associated with the rules module of the contextual information gateway module, according to one embodiment of the invention.

FIG. 20 illustrates a process flow of a method for determine whether to present contextual information to a user, according to one embodiment of the invention.

FIG. 21 illustrates a table of rule parameters that demonstrate the functionality of the various systems and methods of the invention.

FIG. 22 illustrates a general process flow for providing contextual information, according to one embodiment of the invention.

FIG. 23 illustrates a method for providing contextual information, according to one embodiment of the invention.

FIG. 24 illustrates a method for providing contextual information, according to one embodiment of the invention.

FIG. 25 illustrates a method for defining a rule for determining whether to provide contextual information, according to one embodiment of the invention.

FIG. 26 illustrates a method for providing contextual information, according to one embodiment of the invention.

FIG. 27 illustrates an integrated contextuality engine (ICE) module 270 and an ICE application/display module 272, according to one embodiment of the invention.

FIG. 27a illustrates a system for integrating contextuality determinations, according to one embodiment of the invention.

FIG. 27b illustrates a process flow showing the integration of contextual information, according to one embodiment of the invention.

FIG. 27c illustrates an ICE module, according to one embodiment of the invention.

FIG. 27d illustrates an ICE application/display module, according to one embodiment of the invention.

FIG. 28 illustrates a process for integrating contextuality determinations, according to one embodiment of the invention.

FIG. 29 illustrates exemplary modules associated with ICE module or a client station, according to one embodiment of the invention.

FIG. 30 illustrates exemplary modules associated with a content decision module, according to one embodiment of the invention.

FIG. 31 illustrates a process flow for processing contextual information requests, according to one embodiment of the invention.

FIG. 32 illustrates exemplary modules associated with a flag CR module, according to one embodiment of the invention.

FIG. 33 illustrates exemplary modules associated with an initial pull module, according to one embodiment of the invention.

FIG. 34 illustrates exemplary modules associated with a per-browser queue module, according to one embodiment of the invention.

FIG. 35 illustrates exemplary modules associated with a partner management system module, according to one embodiment of the invention.

FIG. 36 illustrates exemplary modules associated with a delayed contextual inventory module, according to one embodiment of the invention.

FIG. 37 illustrates exemplary modules associated with a page links trigger module, according to one embodiment of the invention.

FIG. 38 illustrates exemplary modules associated with a reading time module, according to one embodiment of the invention.

FIG. 39 illustrates exemplary modules associated with a content ordering and WTAF module, according to one embodiment of the invention.

FIG. 40 illustrates exemplary modules associated with a permissions module, according to one embodiment of the invention.

FIG. 41 illustrates exemplary modules associated with a keyword filter module, according to one embodiment of the invention.

FIG. 42 illustrates exemplary modules associated with a pacing module, according to one embodiment of the invention.

FIG. 43 illustrates exemplary modules associated with a keywords in title module, according to one embodiment of the invention.

FIG. 44 illustrates exemplary modules associated with a contextual content queue behavior module, according to one embodiment of the invention.

FIG. 45 illustrates exemplary modules associated with an external content pull module, according to one embodiment of the invention.

FIG. 46 illustrates exemplary modules associated with a message queue module, according to one embodiment of the invention.

FIGS. 46a-46e illustrate numerous process flows associated with the message queue module, according to one embodiment of the invention.

FIG. 47 illustrates a search provider (SP) logic module, according to one embodiment of the invention.

FIG. 48 illustrates exemplary modules associated with an SP logic module, according to one embodiment of the invention.

FIG. 49 illustrates exemplary modules associated with a real-time processing module, according to one embodiment of the invention.

FIG. 50 illustrates exemplary modules associated with an offline processing module, according to one embodiment of the invention.

FIG. 51 illustrates a process flow for processing a request for contextual information, according to one embodiment of the invention.

FIG. 52 illustrates a system for processing requests for contextual information.

FIG. 53 illustrates a process flow for processing a request for contextual information, according to one embodiment of the invention.

FIG. 54 illustrates a process flow for processing a request for contextual information, according to one embodiment of the invention.

FIG. 55 illustrates tables associated with a process flow for weighting parameters associated with processing a request for contextual information, according to one embodiment of the invention.

### DETAILED DESCRIPTION OF THE INVENTION

Reference will now be made to illustrative embodiments of the invention(s) described herein, examples of which are illustrated in the accompanying drawings in which like reference characters refer to corresponding elements.

The present invention(s) are described in relation to various systems and methods for enabling users to provide contextual information over a network, such as over the Internet, for example. Nonetheless, the characteristics and parameters pertaining to the various embodiments of the systems and methods described herein may be applicable to the provision of contextual information over any channel or platform.

While the exemplary embodiments illustrated herein may show various embodiments of the invention (or portions thereof) collocated, it is to be appreciated that the various components of the various embodiments may be located at distant portions of a distributed network, such as a local area network, a wide area network, a telecommunications network, an intranet and/or the Internet, or within a dedicated object handling system, for example. Thus, it should be appreciated that the components of the various embodiments may be combined into one or more devices (or modules) or collocated on a particular node of a distributed network, such as a telecommunications network, for example. As will be appreciated from the following description, and for reasons of computational efficiency, the components of the various embodiments may be arranged at any location within a distributed network without affecting the operation of the respective system(s).

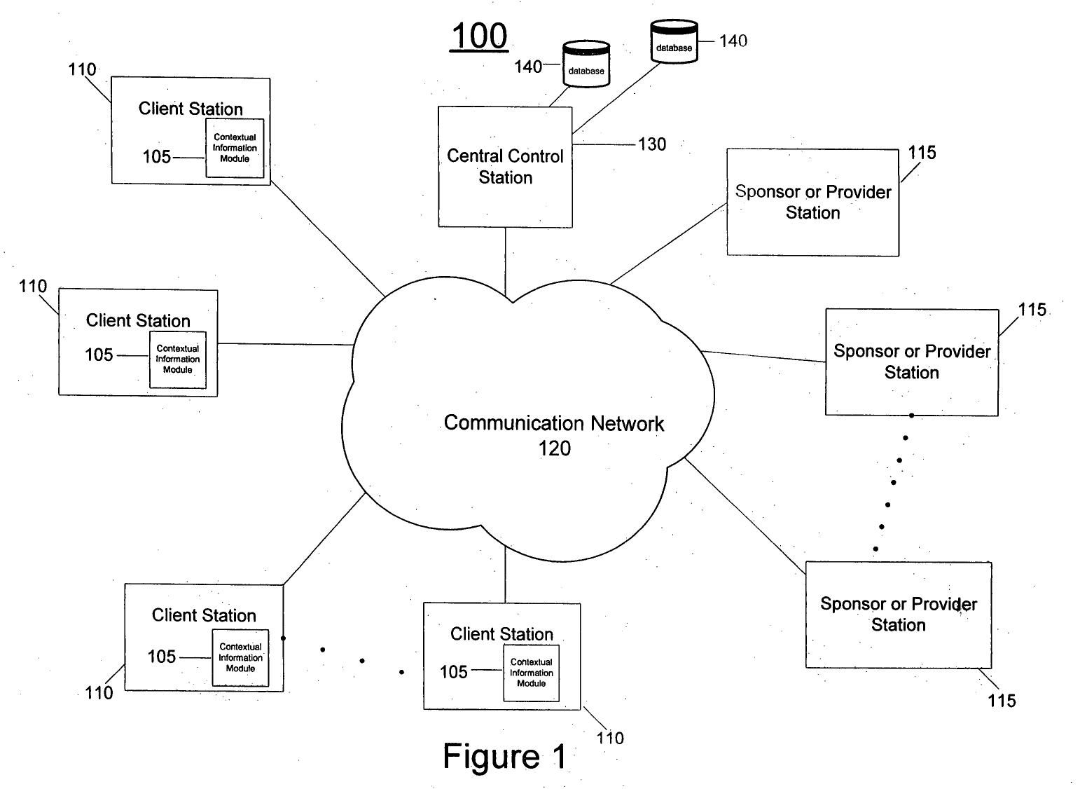

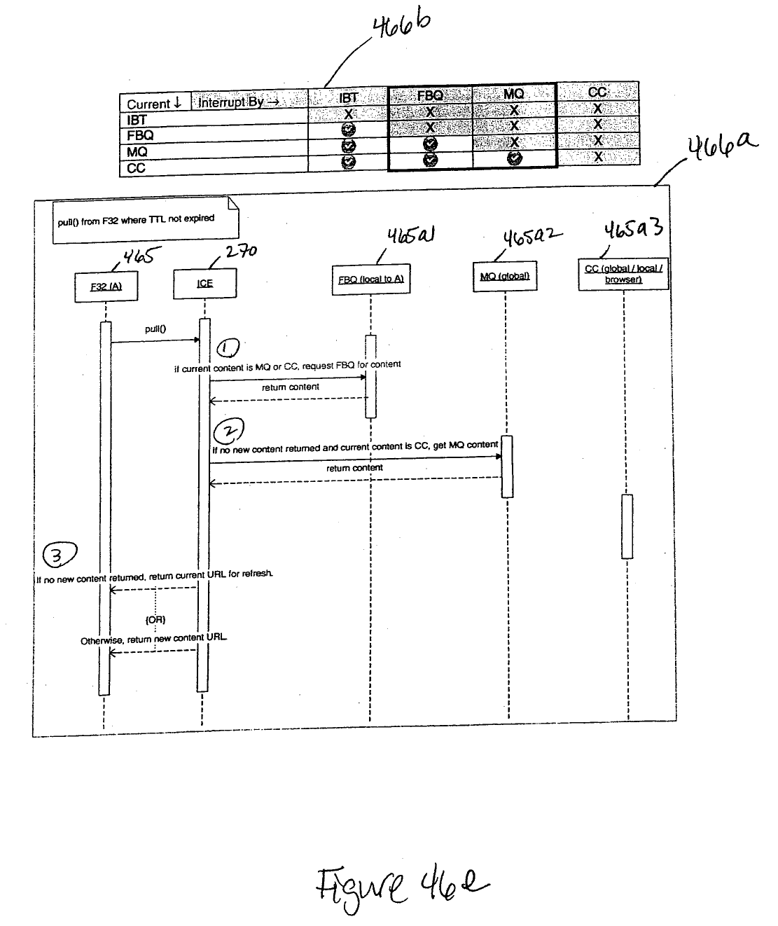

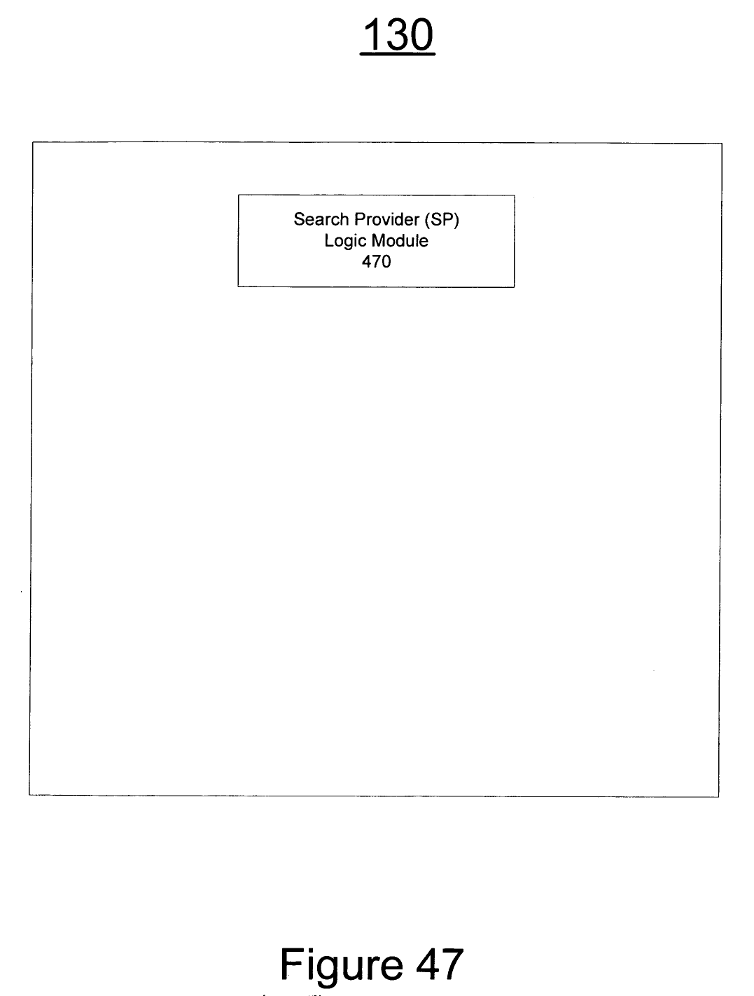

The various systems and methods described below in FIGS. 47-55 may, in some embodiments, be used in conjunction with the systems and methods disclosed and described below and in FIGS. 1-46. In various embodiments, the systems and methods of FIGS. 47-55 may be used with other systems and methods for providing contextual information to a user.

FIG. 47 illustrates an exemplary search provider (“SP”) logic module 470 that may be associated with central control station 130 to enhance the various functions and features of the embodiments described herein. In some embodiments, SP logic module 470 may reside within central control station 130 or within any of client stations 110, and may cooperate with any of the various features and described herein for providing contextual information. In some embodiments, SP logic module 470 may operate and perform its functions while protecting the personally identifiable information (PII) of users, without in any way uniquely identifying any user or deriving any behavior that specifically identifies a user.

In some embodiments, SP logic module 470 may comprise or operate server-side logic that enhances or augments client-side contextuality determinations or requests sent to the server for resolution or fulfillment. Client-side contextuality determinations or requests may comprise any request for contextual information relevant to a user's interaction with a network and/or application or program, such as those provided by the various systems and methods described below and in FIGS. 1-46e. In some embodiments, SP logic module 470 may parse and analyze incoming requests for contextual information and make supplemental decisions that enhance or refine the request to increase the probability that the contextual information ultimately provided in response to the request is of high value and relevancy. Such supplemental decisions may comprise: (1) enhancing, adding, or deleting select particulars of the request, (2) determining at least one appropriate sponsor or provider to fulfill the request, and (3) determining which of the appropriate contextual information (received from the appropriate sponsors or providers) to present to the client in response to the request.

For example, assume a user is browsing a network (e.g., Internet) and sending email to a friend from a particular client station 110. The user's interaction with the Internet and with the email application or program may result in a contextuality request being generated by the client station 110 that comprises particulars about the user's interaction with the Internet and the email application or program. Such particulars may comprise URLs, keywords, search terms, phrases, strings, tokens, concepts, or any other data or information related to a user's browsing history or, if the user permits, the content or context of the user's email correspondence. That is, the request may comprise contextuality determinations about the user's interaction with the network and/or the user's interaction with the application or program. Upon receiving the request from client station 110, SP logic module 470 may process and analyze the request's particulars to enhance the ability of the request to produce contextual information of high value and relevance.

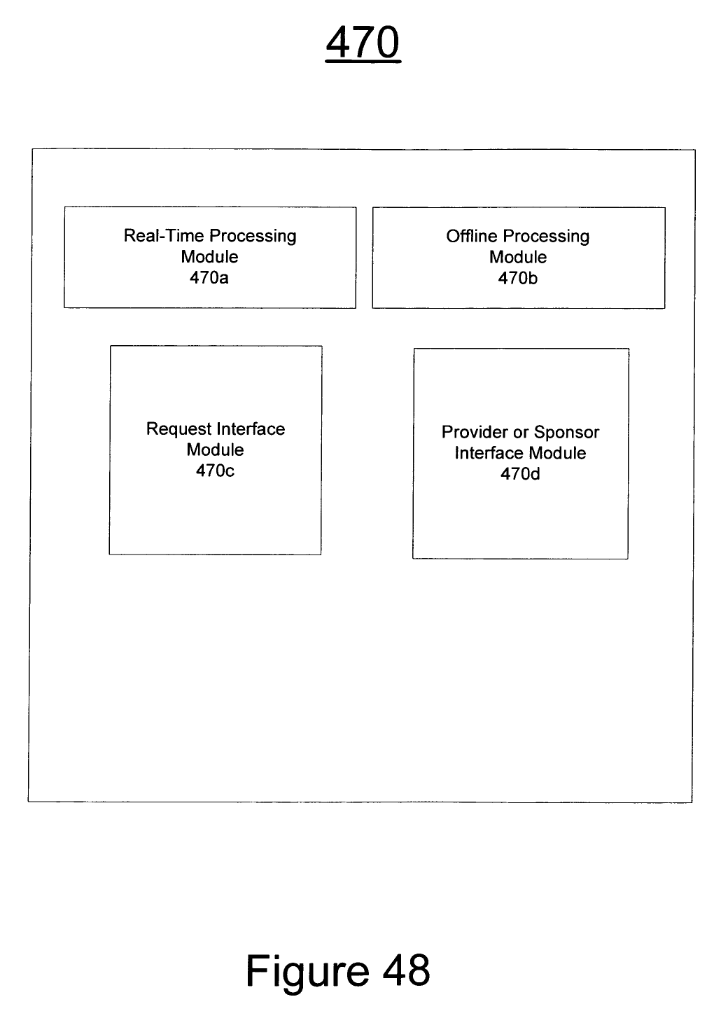

FIG. 48 illustrates additional exemplary modules that may be associated with central control station 130 or SP logic module 470 to perform or enhance the various features and functions of the systems and methods described herein. While the modules may not be used in all embodiments to perform some or all of the functions of the present invention, they are nonetheless presented as possible embodiments. As shown, the following modules may be provided: (1) real-time processing module 470a; (2) offline module 470b; (3) request interface module 470c; and (4) provider or sponsor interface module 470d. In some embodiments, each of these modules may reside on any of client stations 110 and may cooperate with any of the various features and described herein for providing contextual information. All of the modules operate and perform their respective functions while protecting the personally identifiable information (PII) of users, without in any way uniquely identifying any user or deriving any behavior that specifically identifies a user. Each is described below.

Real-time processing module 470a may, in some embodiments, process, analyze and enhance incoming requests for contextual information. For example, real-time processing module may receive requests for contextual information received from any of client stations 110. Such requests may comprise particulars about a user's interaction with a network or the user's interaction with an application or program. In some embodiments, real-time processing module 470a may parse the components of a request for contextual information (e.g., URLs, keywords, search terms or phrases, concepts, tokens, and other data or information related to a user's monitored interaction with a network or application) to enhance and increase the probability that contextual information of high value and relevance will be provided.

In some embodiments, real-time processing module 470a may also analyze any number of sponsors or providers to determine which sponsor(s) or provider(s) is/are better suited to fulfill a particular request for contextual information. Similarly, real-time processing module 470a may also analyze and compare the contextual information received from such select sponsors or providers and submit only those that is/are of great value and relevance to the request. In some embodiments, value determinations may be based on any number of indicators, such as weighted parameters that enable the dynamic processing and analyzing of incoming requests, sponsors or provider, or contextual information selected for display to a user.

Offline processing module 470b may, in some embodiments, conduct offline processing and maintenance of data and information relied upon by SP logic module to perform the various features and functions herein, such as weighted parameters and database tables used to process, analyze and enhance incoming requests, select appropriate sponsors or providers, or select contextual information of high value and relevance, for example. In some embodiments, offline processing 470b may also maintain and update weighted parameters, which may comprise weighted keywords, categories, sponsors or providers, or any other factor related to the processing of requests or the fulfillment of such requests in obtaining contextual information of high value and relevance.) In some embodiments, the weight associated with a parameter may be based on historical value indicators, such as click-through rate (CTR), associated with the parameter, the In some embodiments, offline processing module 470b may periodically update such data or information, such as on a nightly schedule, for example. In some embodiments, such updates may occur in real-time.

Request interface module 470c may, in some embodiments, receive incoming requests from client stations, for example, and provide contextual information to such clients in response to such requests. For example, when a user's interaction with a network or an application or program search triggers a request at any client station 110, the resulting request may be transmitted to central control station or SP logic module 470 for processing and enhancement. When such request is resolved and fulfilled by central control station 130 or a sponsor or provider 115, the contextual information may be transmitted back to the requesting client via request interface module 470c.

Provider or sponsor interface module 470d may, in some embodiments, transmit requests received from clients and enhanced requests to select sponsors or providers for resolution and fulfillment. Such requests may be transmitted via provider or sponsor interface module 470d. In some embodiments, contextuality requests that are responsive to the request may be returned by the sponsor or provider to SP logic module 470 via provider or sponsor interface module 470d. In some embodiments, the sponsor or provider may transmit responsive contextual information directly to the requesting client station.

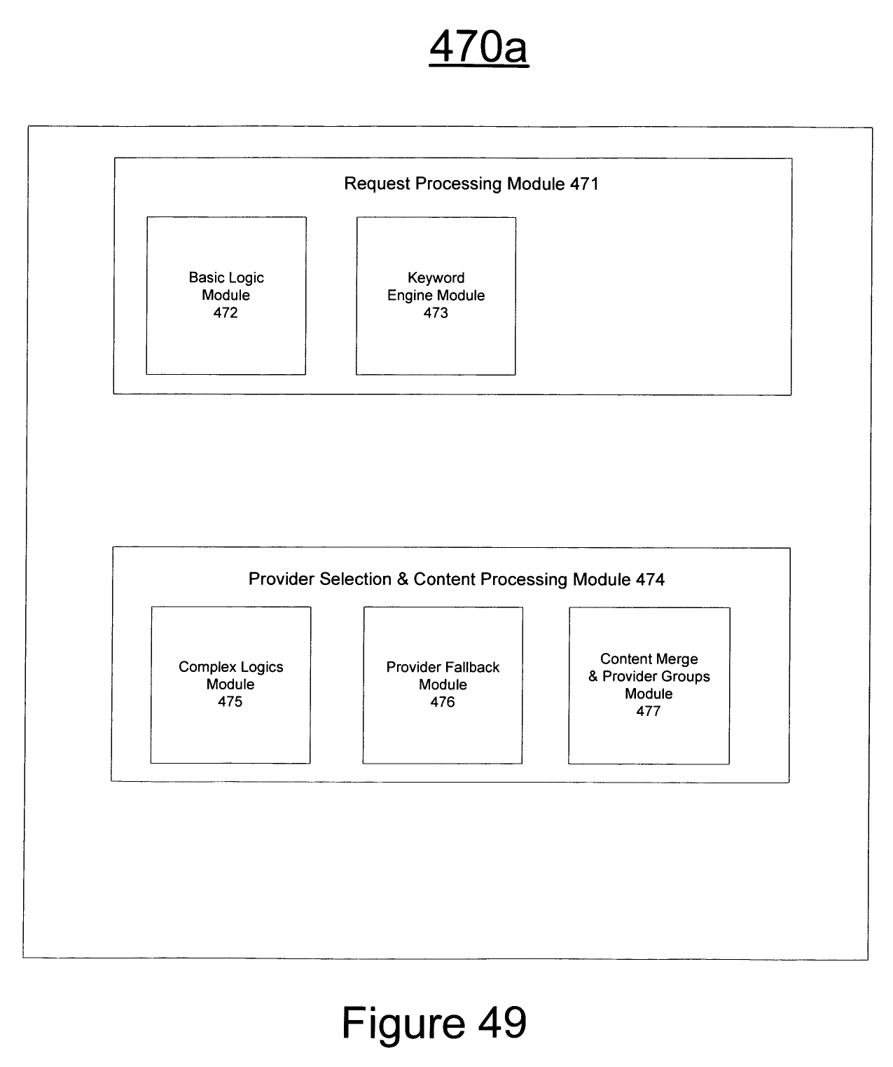

FIG. 49 illustrates one embodiment of a real-time processing module 470a. As shown, real-time processing module 470a may comprise: (1) a request processing module 471 which further comprises a basic logic module 472 and a keyword engine module 473; and (2) a provider and content selection and processing module 474 which further comprises a complex logics module 475, a provider fallback module, and a content merge and provider groups module 477.

Request processing module 471 may operate to process and analyze incoming requests by enhancing, revising, modifying, adding, or deleting select particulars of the request. For example, request processing module 471 may be able to refine a request which contains the keyword “travel” to also incorporate the phrase “Washington, D.C.,” if, for example, it is known that the user is interested in traveling to Washington, D.C. or if a particular event is taking place in Washington, D.C. that historically has been shown to produce a high amount of queries, either by the user, or other users with the, for example. Other determination schemes may be provided. Several techniques are available for processing and analyzing incoming requests, including the various modules set forth below.

In some embodiments, request processing module 471 may comprise a basic logic module 472 and a keyword engine module 473:

Basic logic module 472 may operate to parse, process and enhance incoming requests. For example, assume a request comprises a keyword indicating the user is interested in automobiles, such as kw=automobiles. In some embodiments, basic logic module 427 may resolve the “automobile” keyword against any number of logical rules to maximize or enhance the ability of the request—and more particularly the keywords and other information within the request—to solicit contextual information of high value and relevance. Such logical rules may consider additional information about the request, such as the geographic location of the client stations from where the request originated, or particulars about the network, application or program the user is interacting with. In some embodiments, if the user has given prior permission, particulars about the user's identity may be used to further enhance the request.

For example, assume a user performs a search on the network (e.g., through a search engine) or on an application or program residing on his or her client/computer. The search may trigger generation of a request for contextual information that comprises particulars about the user's search, such as, for example, URLs, keyword(s), search term(s)/phrase(s), tokens, concepts, etc. The request may also include information about the client terminal and/or user (if permission obtained), such as the geographic location of the client or user, the application or program with which the user is interacting, or any other information that may be of value in determining the contextuality of the user's interaction. The request may then be sent to central control station 130 or sponsor or provider station 115 for resolution and fulfillment. In some embodiments, an SP logic module 470 residing at either client control station 130 or sponsor or provider station 115, may process the keyword in the request

In some embodiments, a request may comprise more than one keyword, search term/phrase, token or concept. For example, an airline reservations pages may include more than one search box, such as origin city, destination, time of departure, etc. During formulation of the request on the client-side, the search terms provided by the user into each search box may be concatenated and restructured into a string. In such a situation, when the request/string arrives at the SP logic module 470, basic logic module 472 may parse and process the request/string into component keywords or search terms, for example, to better determine the nature of the user's interaction. For example, if the user provided New York, N.Y. and Boston, Mass. as the origin and destination cities, respectively, then basic logic module 472 parse the request/string into two separate terms, one for New York, N.Y. and the other for Boston, Mass. Each search term may now be processed individually, thus refining the original request's ability to solicit contextual information of high value, granularity and relevance. For example, contextual information relating to travel from New York, N.Y. may be provided to the user, as well as contextual information relating to travel to Boston, Mass. Other enhancements may be made to the particulars of the request.

In some embodiments, requests may be reformatted. For example, assume user interaction with an airline site may produce the following request:

http://bidtxt.whenu.com/SearchBar?stp=ext&kw=destination%3Dbos26origin%3Djfk&templ....

where %3D is “=” and %26 is “&” encoded.

As shown, the extended search terms may comprise: destination=bos and origin=jfk. In some embodiments, mapping may be arranged so that the output (e.g., enhanced) keyword sent to a sponsor or provider, for example, is in the following format:
<%origin%><%destination%> flight

where <%origin%> is replaced by value of origin (e.g., jfk) and <%destination%> is replaced by value of destination (e.g., boston). Thus, in some embodiments, the replacement keyword is: bos jfk flight.

Keyword engine module 473 may, in some embodiments, process, analyze and enhance the value of requests, and more particular the keywords, search terms/phrases, tokens and concepts or other data or information that comprise such requests. In some embodiments, keyword engine module 473 may determine whether a particular keyword, search term/phrase, token or concept is within a sponsor or provider's list of valid requests, in which case the sponsor or provider may be queried for contextual information, otherwise another sponsor or provider will need to be queried. In some embodiments,

In some embodiments, keyword engine module 473 may process and analyze requests relating to a user's interaction with an application or program requiring multiple search boxes or inputs. For example, if a user conducts a search on a search engine and a request for contextual information is triggered, little may be known beyond the actual search term(s) or phrase(s) entered by the user. In some embodiments, therefore, keyword engine module 473 may resolve such term(s) or phrase(s) against category tables to determine additional areas for possible query. For example, assume a user conducts a search for “weekend travel” on a search engine. The request search term may be resolved against a category table related to “weekend”, “travel,” or “weekend travel.” The table may then refer to additional terms that may provide additional insight into the user's interaction with a network or application or network as set forth in the request, for example.

In some embodiments, keyword engine module 473 may refer to hierarchical data structure in processing and enhancing requests. Table A shown below demonstrates one embodiment of a hierarchy structure of data values that relates category request fields (e.g., shopping.category.camera) to particular keywords. In some embodiments, such a hierarchy data structure may be used to fill in missing keyword fields in a request for contextual information. In some embodiments, such missing keyword fields may be resolved prior to submission of the request to a sponsor or provider for resolution and fulfillment. For example, assume a user's interaction with a network or application or program results in a request comprising the category “shopping.electronics.computer.” Using the hierarchy structure shown below, a determination may be made to replace or augment the category “shopping.electronics.computer” with the keyword “PC,” thus providing additional granularity and resolution to the request.

Table A works as follows. First, the corresponding category is located. If a corresponding keyword is shown to be associated with that category, then that keyword may be used to replace or augment the category. If not, then the next hierarchical level of the request is referred to, and so on. Thus, because the category request “shopping.electronics.computer” is not associated with a particular keyword, reference is made to the next root level of the category, namely “shopping.electronics,” which is associated with the keyword “PC.” If, however, the request would have been “shopping.electronics.camera,” then the keyword would have been “Camera Model #1.”

TABLE A

| | | |
|---|---|---|
| Shopping | shopping.electronics | shopping.electronics.camera |
| Shop | PC | Camera Model #1 |
| | | shopping.electronics.cellphone |
| | | Cell Phone Model #1 |
| | | shopping.electronics.computer |
| | | shopping.flowers.birthday |
| | | shopping.flowers.valentine |
| | | roses |
| | | shopping.flowers.mothersday |

In some embodiments, similar tables may be provided that co-relate keywords, categories, terms, concepts, tokens, or any other data or information indicative of a user's interaction with a network or an application or program. In some embodiments, tables may co-relate keywords, categories, terms, concepts, tokens, or any other data or information indicative of a user's interaction with a network or an application or program on a per partner, sponsor or provider, or contextual information basis. Thus, each of the various enhancement and processing techniques described herein may depend on the particular partner, sponsor or provider, or contextual information being considered, processor or analyzed.

For example, a sponsor or provider may desire to be queried only if the incoming request relates to certain predetermined categories, such as a particular product, service, keyword, term, phrase, concept or token. Assume an incoming request comprises a keyword indicating an interest in a particular digital camera. In processing the request, keyword engine module 473 may, in some embodiments, determine whether the particular digital camera is one of select products or categories that a particular sponsor or provider has listed for query. If so, then that particular sponsor is queried with that keyword. If not, then keyword engine module 473 may dismiss the request, submit as is, or modify or enhance the request as required by the sponsor or provider, for example. Other particular or customized requirements are possible.

In some embodiments, a database table against which a request may be resolved for enhancement purposes may comprise weighted parameters (e.g., keywords, terms, phrases, tokens, concepts, categories, or any other data or information indicative of a user's interaction with a network or application or program). Thus, referring to Table A above, instead of there being only one model under the category “shopping.electronics.camera,” a plurality of models may be placed. Each parameter (e.g., camera model) within the database may be weighted according to any number of metrics that measure the parameter's ability to produce contextual information of high value and relevance. Typical metrics may include the parameter's click-through rate (CTR)—the number of user's that ultimately initiate or click on the contextual information, cost per one-thousand impressions (CPM), cost-per-click (CPC), cost-per-acquisition or purchase of the user (CPA), and effective CPM (eCPM)—a normalization of all metrics. The relationship between measurable metrics and parameter weighting may be determined according to particular business needs, or according to particular formulas or algorithms that accurately relate to contextual information value or relevance.

Table B shown below illustrates the daily weight adjustments for particular keywords (e.g., camera models). As shown, on Day 1 each of the camera models has equal opportunity (e.g., 33.33% chance) as any other camera model of being selected if a request comprising the category “shopping.electronics.camera” is received. On Day 2, however, Camera Model #3 has a higher chance (e.g., 40%) of being selected over any other model. In some embodiments, such adjustments may be the result of Camera Model #2 outperforming the other models with regards to measurable metrics, such as CTR, CPM, CPC, CPA, or eCPM. On Day, Camera Model #3 is shown as increasing its lead over the other two models by 5% percentage points.

In some embodiments, a parameter's measurable metrics may be monitored on a periodic basis, according to a predetermined schedule, or on a real-time basis, for example. In some embodiments, after measurable metrics are processed and evaluated, the respective weighting of parameters is adjusted so that the parameter with the highest effective CPM, for example, is assigned a higher weight, giving it a greater likelihood of being selected in response to an incoming request.

TABLE B

| Camera | Day 1 | Day 2 | Day 3 |
|---|---|---|---|
| Camera Model #1 | 33.33% | 25% | 22.5% |
| Camera Model #2 | 33.33% | 35% | 32.5% |
| Camera Model #3 | 33.33% | 40% | 45% |

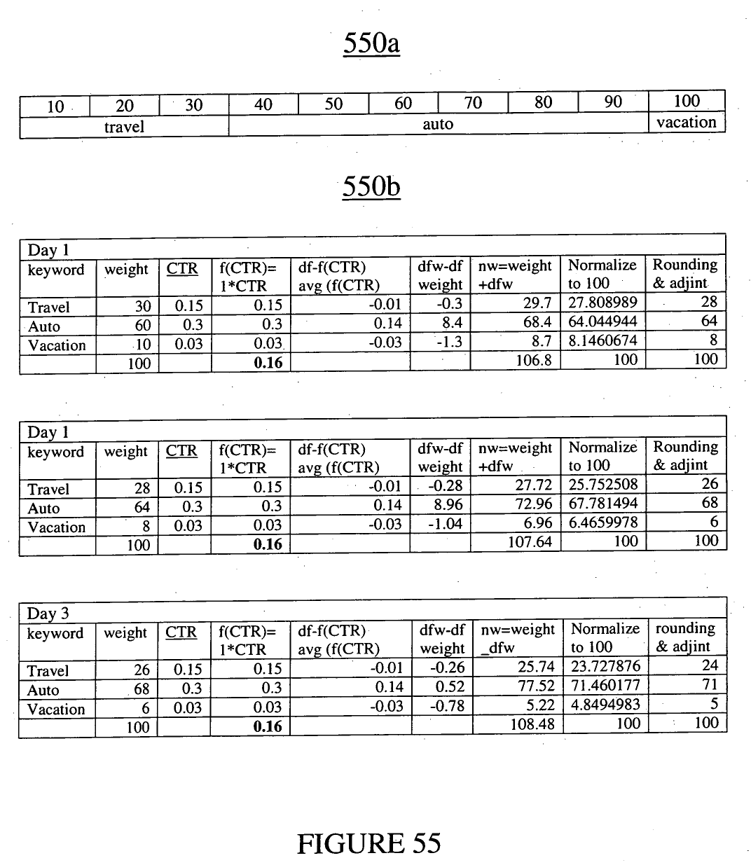

FIG. 55 illustrates one embodiment of a table showing 550a showing a particular weight distribution for select keywords. As shown, table 550a indicates respective weighting of 40, 60 and 10 percent for the keywords travel, auto, and vacation. Table 550b shows the corresponding parameters used to determine adjustments to keyword weights on a daily basis. For example, on Day 1 keywords “travel,” “auto,” and “vacation” have respective weights of 30, 60 and 10. The CTR for each is shown respectively as 0.15, 0.3, and 0.03. These values may then be inputted into a particular formulas that process the CTR and weight to arrive at a rounded and adjusted weight, as shown in the right-most column of Day 1. These rounded and adjusted weights are then carried over to the Weight column of Day 2 and similar processing is done While processing of weights and CTR is shown as being done on a daily or nightly basis, it may be done periodically, according to a predetermined schedule, or on a real-time basis.

The following exemplary definitions may apply to the headings of the table 550b:

| | |
|---|---|
| keyword | The keyword sent to search providers for search results. In some |
| | embodiments, a list of keywords may be maintained by an administrator of |
| | SP logic module 470. |
| weight | The chance (e.g., percentage) of sending this keyword to search providers on |
| | the previous day (call this day P). For existing keywords, this weight may be |
| | calculated by performance (CTR) of this keyword on the previous day. For |
| | new keywords added on that day, it may be given the average weight of |
| | existing keywords in the system. After existing and new keywords are |
| | assigned a weight, their sum might exceed 100. If this is the case, the |
| | respective weights may be normalized by and administrator of SP logic |
| | module 470, for example. |
| CTR | Click through rate of an existing keyword on the previous day (day P). |
| f(CTR) | Apply function f to CTR. For simplicity, we use f(x) = x by in example 1. |
| | We will see how different functions affect the calculation of the new weights |
| | in the example 2. |
| df | Calculate the difference between f(CTR) and average of the f(CTR) column. |
| | (this splits the list into 2 groups: +/− add weight and subtract weight |
| | respectively. This has the behavior that highest CTR will add most and |
| | lowest CTR will subtract most.) |
| dfw | Multiply df by weight |
| nw | Add weight to dfw (the weighted-ness from dfw guarantees that we won't be |
| | removing more weight than a keyword has. However this creates the problem |
| | that sum(dfw) is not necessarily 0, so that sum(nw) is not necessarily 100. we |
| | will fix this by normalizing it in the next step) |
| norm | nw * 100/sum(nw) |
| round | Round norm to the nearest integer. Because of the rounding, the sum might |
| | not be 100. |
| | If <100, we increment weights starting with highest weight to lowest. |
| | If >100, we decrement weights starting with lowest weight to highest. |
| | This is the weight for day P + 1. |

The following examples illustrate evolution of variables over the course of a day and how different functions “f” may affect weighting:

Example 1: How are the variables affected over the course of a day?

| | | | | | | | | |
|---|---|---|---|---|---|---|---|---|
| keyword | weight | CTR | f(CTR) | df | dfw | nw | norm | round |

Day 1 - 1:02 am: weight has been assigned. No keyword has been used yet (so no CTR).

| | |
|---|---|
| Travel | 30 |
| Auto | 60 |
| Vacation | 10 |
| | 100 |

Day 1 - 11 am: A few ads have been shown - some data on CTR is available.

| | | |
|---|---|---|
| Travel | 30 | 0.35 |
| Auto | 60 | 0.25 |
| Vacation | 10 | 0.05 |
| | 100 | |

Day 1 - 4 pm: Administrator looked at the data and decided to drop some poor performing
keywords and add some that they think might do well. (The poor CTR will make the weight
go to zero eventually. Administrators may have the option to speed up that process if they
want.Also, applying different functions to CTR could also accelerate the rate the weight that
a poor performing keyword goes to zero.)

| | | |
|---|---|---|
| Travel | 30 | 0.25 |
| Auto | 60 | 0.28 |
| −Vacation | 10 | 0.04 |
| +Shopping | | |
| | 100 | |

Day 2 - 1 am: All the CTR data has been collected/calculated. We can calculate f(CTR),
df, dfw and nw of existing keywords that were not dropped by adops. (Note: when a keyword
is dropped,it may continue to run for the rest of the day.It may means that the dropped
keyword will not be available on the next day.)

| | | | | | | | | |
|---|---|---|---|---|---|---|---|---|
| Travel | 30 | 0.15 | | 0.15 | −0.01 | −0.3 | | 29.7 |
| Auto | 60 | 0.3 | | 0.3 | 0.14 | 8.4 | | 68.4 |
| −Vacation | 10 | 0.03 | | | | | | |
| +Shopping | | | | | | | | |
| | 100 | | Avg = | 0.225 | | | Avg = | 49.05 |

Day 2 - 1:01 am: Now we assign the new keyword added with the average weight of 49.05
and normalize the sum to 100. At this point we have the new
weights for the next day!!

| | | | | | | | | | | | |
|---|---|---|---|---|---|---|---|---|---|---|---|
| Travel | 30 | 0.15 | | 0.15 | −0.01 | −0.3 | | 29.7 | | 20.18 | 20 |
| Auto | 60 | 0.3 | | 0.3 | 0.14 | 8.4 | | 68.4 | | 46.48 | 47 |
| Shopping | | | | | | | | 49.05 | | 33.33 | 33 |
| | 100 | | Avg = | 0.225 | | | Sum = | 147.15 | Sum = | 100 | 100 |

Day 2 - 1:02 am: weight has been assigned. No keyword has been used yet (so no CTR).

| | |
|---|---|
| Travel | 20 |
| Auto | 47 |
| Shopping | 33 |
| | 100 |

Example 2: How does different function f affected the weights?

Note the effects of the final weight (last column) on Day 4 for various functions.

| keyword | Weight | CTR | f(CTR) = CTR/4 | df | dfw | nw | norm | round |
|---|---|---|---|---|---|---|---|---|
| Day 1 | | | | | | | | |
| Travel | 30 | 0.15 | 0.0375 | −0.0025 | −0.075 | 29.93 | 29.42 | 29 |
| Auto | 60 | 0.3 | 0.075 | 0.035 | 2.1 | 62.10 | 61.06 | 61 |
| Vacation | 10 | 0.03 | 0.0075 | −0.0325 | −0.325 | 9.68 | 9.51 | 10 |
| Day 2 | | | | | | | | |
| Travel | 29 | 0.15 | 0.0375 | 0.00 | −0.0725 | 28.93 | 28.43 | 28 |
| Auto | 61 | 0.3 | 0.075 | 0.035 | 2.135 | 63.14 | 62.06 | 62 |
| Vacation | 10 | 0.03 | 0.0075 | −0.0325 | −0.325 | 9.68 | 9.51 | 10 |
| Day 3 | | | | | | | | |
| Travel | 28 | 0.15 | 0.0375 | −0.0025 | −0.07 | 27.93 | 27.44 | 27 |
| Auto | 62 | 0.3 | 0.075 | 0.035 | 2.17 | 64.17 | 63.05 | 63 |
| Vacation | 10 | 0.03 | 0.0075 | −0.0325 | −0.325 | 9.68 | 9.51 | 10 |
| Day 4 | | | | | | | | |
| Travel | 27 | 0.15 | 0.0375 | 0.00 | −0.07 | 26.93 | 26.45 | 26 |
| Auto | 63 | 0.3 | 0.075 | 0.04 | 2.21 | 65.21 | 64.04 | 64 |
| Vacation | 10 | 0.03 | 0.0075 | −0.03 | −0.33 | 9.68 | 9.50 | 10 |
| keyword | Weight | CTR | f(CTR) = CTR/2 | df | dfw | nw | norm | round |
| Day 1 | | | | | | | | |
| Travel | 30 | 0.15 | 0.075 | −0.005 | −0.15 | 29.85 | 28.87 | 29 |
| Auto | 60 | 0.3 | 0.15 | 0.07 | 4.2 | 64.20 | 62.09 | 62 |
| Vacation | 10 | 0.03 | 0.015 | −0.065 | −0.65 | 9.35 | 9.04 | 9 |
| Day 2 | | | | | | | | |
| Travel | 29 | 0.15 | 0.075 | −0.01 | −0.145 | 28.86 | 27.85 | 28 |
| Auto | 62 | 0.3 | 0.15 | 0.07 | 4.34 | 66.34 | 64.03 | 64 |
| Vacation | 9 | 0.03 | 0.015 | −0.065 | −0.585 | 8.42 | 8.12 | 8 |
| Day 3 | | | | | | | | |
| Travel | 28 | 0.15 | 0.075 | −0.005 | −0.14 | 27.86 | 26.83 | 27 |
| Auto | 64 | 0.3 | 0.15 | 0.07 | 4.48 | 68.48 | 65.96 | 66 |
| Vacation | 8 | 0.03 | 0.015 | −0.065 | −0.52 | 7.48 | 7.20 | 7 |
| Day 4 | | | | | | | | |
| Travel | 27 | 0.15 | 0.60 | −0.04 | −1.08 | 25.92 | 19.60 | 20 |
| Auto | 66 | 0.3 | 1.20 | 0.56 | 36.96 | 102.96 | 77.86 | 78 |
| Vacation | 7 | 0.03 | 0.12 | −0.52 | −3.64 | 3.36 | 2.54 | 3 |
| keyword | Weight | CTR | f(CTR) = 1 * CTR | df | dfw | nw | norm | round |
| Day 1 | | | | | | | | |
| Travel | 30 | 0.15 | 0.15 | −0.01 | −0.3 | 29.70 | 27.81 | 28 |
| Auto | 60 | 0.3 | 0.3 | 0.14 | 8.4 | 68.40 | 64.04 | 64 |
| Vacation | 10 | 0.03 | 0.03 | −0.13 | −1.3 | 8.70 | 8.15 | 8 |
| Day 2 | | | | | | | | |
| Travel | 28 | 0.15 | 0.15 | −0.01 | −0.28 | 27.72 | 25.75 | 26 |
| Auto | 64 | 0.3 | 0.3 | 0.14 | 8.96 | 72.96 | 67.78 | 68 |
| Vacation | 8 | 0.03 | 0.03 | −0.13 | −1.04 | 6.96 | 6.47 | 6 |
| Day 3 | | | | | | | | |
| Travel | 26 | 0.15 | 0.15 | −0.01 | −0.26 | 25.74 | 23.73 | 24 |
| Auto | 68 | 0.3 | 0.3 | 0.14 | 9.52 | 77.52 | 71.46 | 71 |
| Vacation | 6 | 0.03 | 0.03 | −0.13 | −0.78 | 5.22 | 4.81 | 5 |
| Day 4 | | | | | | | | |
| Travel | 24 | 0.15 | 0.60 | −0.04 | −0.96 | 23.04 | 16.92 | 17 |
| Auto | 71 | 0.3 | 1.20 | 0.56 | 39.76 | 110.76 | 81.32 | 81 |
| Vacation | 5 | 0.03 | 0.12 | −0.52 | −2.60 | 2.40 | 1.76 | 2 |
| keyword | Weight | CTR | f(CTR) = 2 * CTR | df | dfw | nw | norm | round |
| Day 1 | | | | | | | | |
| Travel | 30 | 0.15 | 0.30 | −0.02 | −0.60 | 29.40 | 25.88 | 26 |
| Auto | 60 | 0.3 | 0.60 | 0.28 | 16.80 | 76.80 | 67.61 | 68 |
| Vacation | 10 | 0.03 | 0.06 | −0.26 | −2.60 | 7.40 | 6.51 | 7 |
| Day 2 | | | | | | | | |
| Travel | 26 | 0.15 | 0.30 | −0.02 | −0.52 | 25.48 | 21.65 | 22 |
| Auto | 68 | 0.3 | 0.60 | 0.28 | 19.04 | 87.04 | 73.95 | 74 |
| Vacation | 7 | 0.03 | 0.06 | −0.26 | −1.82 | 5.18 | 4.40 | 4 |
| Day 3 | | | | | | | | |
| Travel | 22 | 0.15 | 0.30 | −0.02 | −0.44 | 21.56 | 18.08 | 18 |
| Auto | 74 | 0.3 | 0.60 | 0.28 | 20.72 | 94.72 | 79.44 | 79 |
| Vacation | 4 | 0.03 | 0.06 | −0.26 | −1.04 | 2.96 | 2.48 | 2 |
| Day 4 | | | | | | | | |
| Travel | 18 | 0.15 | 0.60 | −0.04 | −0.72 | 17.28 | 12.21 | 12 |
| Auto | 79 | 0.3 | 1.20 | 0.56 | 44.24 | 123.24 | 87.11 | 87 |
| Vacation | 2 | 0.03 | 0.12 | −0.52 | −1.04 | 0.96 | 0.68 | 1 |
| keyword | Weight | CTR | f(CTR) = 4 * CTR | df | dfw | nw | norm | round |
| Day 1 | | | | | | | | |
| Travel | 30 | 0.15 | 0.60 | −0.04 | −1.20 | 28.80 | 22.64 | 23 |
| Auto | 60 | 0.3 | 1.20 | 0.56 | 33.60 | 93.60 | 73.58 | 74 |
| Vacation | 10 | 0.03 | 0.12 | −0.52 | −5.20 | 4.80 | 3.77 | 4 |
| Day 2 | | | | | | | | |
| Travel | 23 | 0.15 | 0.60 | −0.04 | −0.92 | 22.08 | 15.83 | 16 |
| Auto | 74 | 0.3 | 1.20 | 0.56 | 41.44 | 115.44 | 82.79 | 83 |
| Vacation | 4 | 0.03 | 0.12 | −0.52 | −2.08 | 1.92 | 1.38 | 1 |
| Day 3 | | | | | | | | |
| Travel | 16 | 0.15 | 0.60 | −0.04 | −0.64 | 15.36 | 10.57 | 11 |
| Auto | 83 | 0.3 | 1.20 | 0.56 | 46.48 | 129.48 | 89.10 | 89 |
| Vacation | 1 | 0.03 | 0.12 | −0.52 | −0.52 | 0.48 | 0.33 | 0 |
| Day 4 | | | | | | | | |
| Travel | 11 | 0.15 | 0.60 | −0.04 | −0.44 | 10.56 | 7.07 | 7 |
| Auto | 89 | 0.3 | 1.20 | 0.56 | 49.84 | 138.84 | 92.93 | 93 |
| Vacation | 0 | 0.03 | 0.12 | −0.52 | 0.00 | 0.00 | 0.00 | 0 |

In some embodiments, selection of a particular weighted parameter may comprise generating a random number between 1 and 100. The range within which the number falls may determine the parameter chosen. Thus, referring to table 550a in FIG. 55, if the number is between 1 and 30, “travel” is chosen. If between 31 and 90, then “auto” is chosen. If between 91 and 100, then “vacation” is chosen. Other parameter selection schemes are possible.

In some embodiments, partners, sponsors or providers, and contextual information may be weighted in a similar manner. Thus, upon receiving a request from a particular partner, (e.g., request relating to interaction with a particular network, application or program), particular tables of weighted relevant parameters may be relied upon to further particularize enhancement of the request, sponsor or provider determination, or selection of contextual information for delivery to a user.

FIG. 49 also illustrates a provider and content selection and processing module 474. Provider and content selection and processing module 474 may, in some embodiments, process and analyze particulars about which sponsor(s) or provider(s) to select, or which contextual information to present to a user. For example, upon request processing module 471's enhancement of a request, provider and content selection processing module 474 may determine which particular sponsor or provider to select to resolve and fulfill the enhanced request. In some embodiments, upon receiving responsive contextual information from selected sponsors or providers, provider and content selection processing module 474 may also determine which particular contextual information to present to the client station or user for display.

In some embodiments, provider and content selection and processing module 474 may comprise a complex logic module 475, a provider fallback module 476, and a content merge and provider groups module 477:

Provider fallback module 476 may, in some embodiments, determine fallback sponsors or providers may serve as substitutes to primary sponsors or providers. In some embodiments, substitution of select primary sponsors or providers may be desired if the preferred provider is not available for some reason (e.g., server times out, provider group metrics are inadequate, etc.), or if the ultimate measurable metrics associated with the primary sponsor or provider or its available contextual information is not desirable (e.g., the CPC of the page is 1 penny per click, so better to serve another).

In some embodiments, provider fallback module 476 may process logical rules that specify which sponsors or providers would be appropriate to serve as fallback sponsors or providers to particular primary sponsors or providers. Such determinations may be made depending particulars about a sponsor or provider, such as the types of goods or services provided, location, and other like parameters. In some embodiments, provider fallback module 476 may access tables that associate particular primary sponsor or providers or primary groups of sponsors or provider with individual or groups of fallback sponsors or providers. In some embodiments, several layers of fallback sponsors or providers may be provided.

Complex logics module 475 may, in some embodiments, determine which particular primary sponsor(s) or provider(s) or fallback sponsor(s) or provider(s) to use (e.g., query for contextual information). In some embodiments, logical relationships between sponsors or providers and corresponding fallback sponsors or providers may be provided to enable more robust and dynamic fallback determination protocols. In some embodiments, complex logic module 475 may select primary or fallback sponsors or providers using simple branching techniques (e.g., true/false logic rules), perpendicular hierarchies (e.g., Table A above), input swaps (e.g. replacement or augmentation of parameters), and complex branching protocols (e.g., complex logic rules).

In some embodiments, complex logic module 475 may also specify a particular format or template to be used for presenting contextual information to a client station. Such format or template may be designated by a partner, for example, as the preferred format for displaying contextual information to a client. Formats or templates may also be determined according to sponsor or provider, user, contextual information, client station, geographic location, or any other factor or variable that may relate to presentation of contextual information to a user.

For example, the following is exemplary of a typical logical rule used by complex logic module 475 to select primary or fallback sponsors or providers:
If (Noon AND Num Items Requests> 10 && Perpendicular.Category is at least Finance AND Mode (Keyword in DB.Table1 is similar (by stemming) and yesterdays CTR>3%
   THEN got to Row A
   ELSE if Category.NotExist
      THEN Category=DB.BucketSearch(kwd)
         Return appropriate weighted keyword from available pool (weights adjusted by performance)
      ELSE if Num Items Requested<4
         THEN return provider (IS4)
         ELSE return provider (FW12)
Row A:
If Category Range (1-10) and Keyword in Bucket Range (W-Z)
   Use template 4 and return default provider
If Category Range (45-82)
   Use template 9 and return default provider
Else
   Use template 14 and return default provider.

Content merge and provider groups module 477 may, in some embodiments, process and assess how select primary and fallback sponsors or providers are queried for contextual information. For example, when a request is received from a client and enhanced, logic rules may accessed by content merge and provider groups module 477 that define how sponsors or providers (primary and fallback) are queried, such as simultaneously or in a particular order, for example. For example, it may be desirable to simultaneously query a primary sponsor or provider A and its fallback, sponsor or provider B, so that, if A times out or is unavailable, then the contextual information of B is available for return to the user or client station.

In some embodiments, a request may be enhanced and subsequently submitted to one or number sponsors or providers for resolution and fulfillment. For example, an incoming request comprising keyword A) may get split into three new requests: keywords A0, A1, A2, and A3, where A1-A3 represent words related or relevant to A0. The requests or parameters are then submitted to select sponsors or providers. Once contextual information is obtained from each sponsor or provider, the results are compared and analyzed according to the respective metrics. In some embodiments, selection of particular sponsors or providers, or contextual information may be based on the particular formatting requirements of the user, client station, or display/screen on which it will be displayed.

In some embodiments, contextual information from more than one sponsor or provider (e.g., primary and fallback) may be merged and combined for simultaneous presentation to the user. For example, in formatting the contextual information for delivery to a client station, contextual information from sponsor or provider A may occupy the left side of a formatted screen or display, while contextual information from sponsor or provider B occupies the right side of the formatted screen or display. In some embodiments, a decision to merge contextual information of multiple sponsors or providers may be based on the respective metrics for each contextual information or sponsor or provider. Thus, if two forms of contextual information have the same CTR, for example, it may be desirable to present them both simultaneously.

In some embodiments, content merge and provider groups module 477 may also select particular contextual information from those offered by any number of sponsors or providers with the objective of returning select contextual information of optimal value and relevance to the user's interaction. In some embodiments, such determination may be made using logical rules and appropriate measurable metrics, for example. Simiarly, content merge and provider groups module 477 may also use one or more secondary sponsors or providers (fallback or otherwise) to optimally fill deficient contextual information from a primary sponsor or provider. For example, if a request required 10 results of contextual information, but the primary sponsor or provider only delivered 6, secondary sponsor(s) or provider(s) may be selected to provide the missing 4. Determinations of appropriate secondary sponsor(s) or provider(s) may depend on logical rules and appropriate measurable metrics, for example.

Provider and content selection and processing module 474 may perform the following functionality:

a) Content compare (e.g., selection of contextual information to transmit to a client station in response to a request)—In some embodiments, provider and content selection and processing module 474 may select contextual information based on any measurable metric. For example, if provider A's contextual information has a CPC> than provider B's contextual, then provider A is used. IF provider group A, B, and C were requested and A has the highest CPC, but B and C have more results within 20% difference of A, then combine B and C and return the combined results. Other calculations and variable processing is possible.

b) Provider or provider group selection—In some embodiments, provider and content selection and processing module 474 may use statistical weighting probabilities as described herein to select sponsor or providers to resolve or fulfill a request or to select contextual information to present to a user or client station, for example. In some embodiments, selection of a sponsor or provider or contextual information may depend on the format or template to be used, or the types or quantity of sponsors or providers required to properly populate a response.

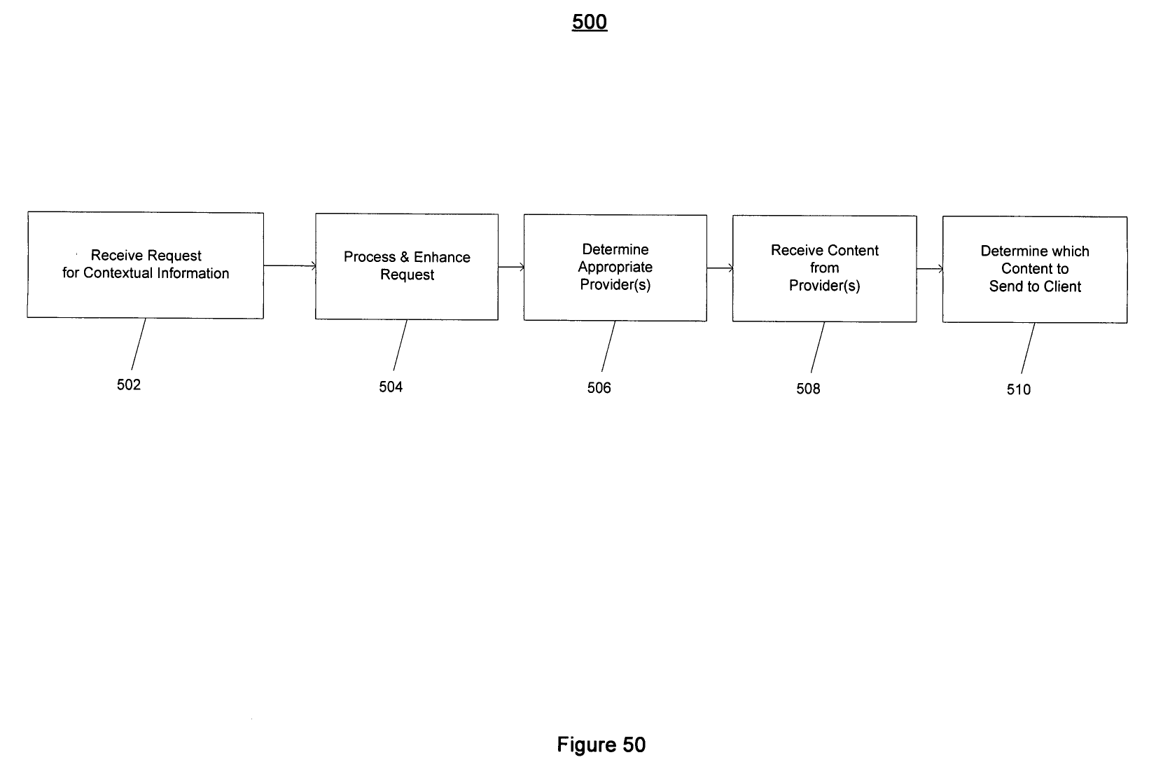

FIG. 50 illustrates one embodiment of an offline processing module 478 that may, in some embodiments, perform that various parameter weight adjustments described herein. In some embodiments, offline processing module 478 may operate to periodically, accordingly to a predetermined schedule, or in real-time update the weights associated with the various parameters described herein to enhance and refine the selection and ultimate presentation of high value and relevance contextual information. In some embodiments, parameters may also be set up as weighted pools of parameters so that groups of parameters are collectively weighted, rather than merely weighting an individual parameter.

In some embodiments, offline processing module 478 may comprise a optimization of client-side triggering logic module 479, a content provider group optimization module 480, and a fallback provider optimization module 481:

Optimization of client-side triggering logic module 479 may, in some embodiments, update and maintain the weights associated with request parameters, such as keywords, terms, phrases, concepts, tokens, categories, or any other data or information related to a user's interaction with a network or an application or program, for example. In some embodiments, optimization of client-side triggering logic module 479 may monitor and update the weighting of: keywords per category, formats/templates per table or logic row utilized; sponsors or providers; individuals, groups or pools of contextual information, and individual parameters (e.g., keyword augmentation—if it is observed that 90% of the time when a trigger occurs and a request composed of the keyword “car” results, the CTR is a mere 3%; however, if the keyword “red” is augmented to the request, creating “red car,” the CTR increases to a more respectable 20%).

Content provider group optimization module 480 may, in some embodiments, update and maintain the weights associated with sponsors or providers. Fallback provider optimization module 481 may, in some embodiments, update and maintain weights associated with fallback sponsors or providers.

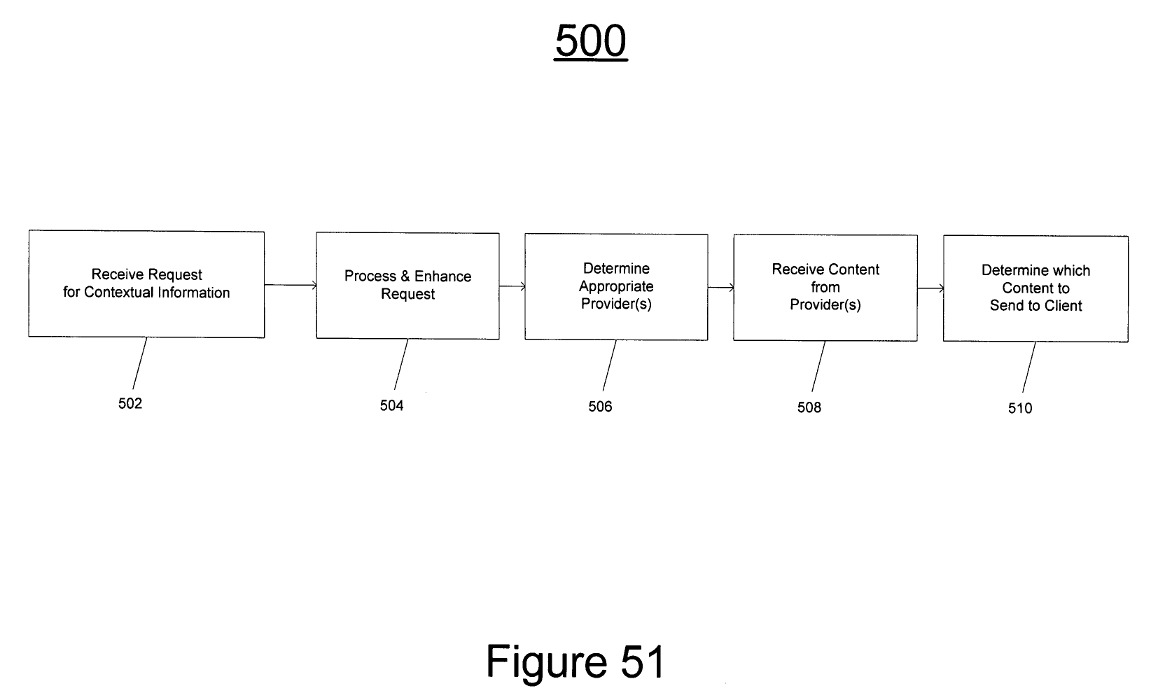

FIG. 51 illustrates one embodiment of a process flow 500 for processing incoming requests for contextual information. In some embodiments, process flow 500 may be performed by any of the systems and methods described herein, including but not limited to central control station 130, SP logic module 470. At step 502, a request for contextual information may be received at central control station 130 (e.g., SP logic module 470). In some embodiments, the request may have been composed by a client station or any of the various systems and methods described herein. In some embodiments, the request may relate to a user's interaction over a network or an application or program.

At step 504, SP logic module 470 may process and enhance the request for contextual information. For example, parameters in the request may be parsed and processed to enhance the ability of the request to produce contextual information of high relevance and value. In some embodiments, incoming parameters may be revised, augmented, deleted, replaced, etc. so that the enhanced request better captures the essence of the user's interaction with a network vis-à-vis the particular sponsors or providers to be queried.

At step 506, SP logic module 470 may also determine appropriate sponsors or providers to query for contextual information. In some embodiments, the request or enhanced request is submitted to select sponsors or providers for resolution and fulfillment. SP logic may select particular sponsors or providers according to any measurable metric that indicate the ability of the sponsor or provider to properly resolve and fulfill the request. Upon selecting sponsor(s) or provider(s), SP logic may forward the request(s) to them for processing.

At step 508, SP logic may receive contextual information from each of the select sponsor(s) or provider(s) in response to the request(s). At step 510, SP logic may determine which, if any, of the contextual information to present to the requesting client station. Such determination may be based on measurable metrics of the contextual information that indicate which best relates to the user's interaction with a network or application or program.

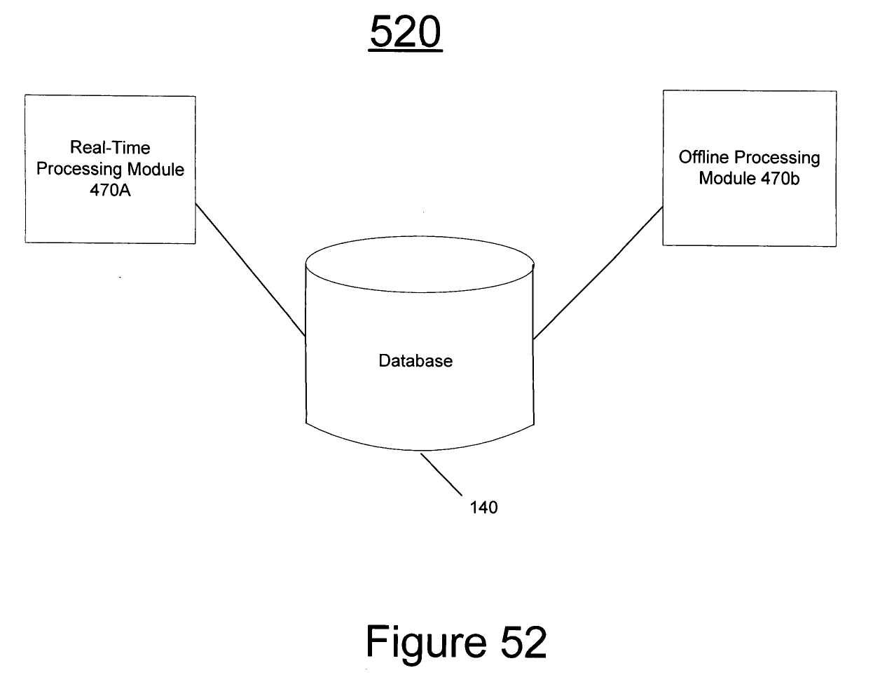

FIG. 52 illustrates one embodiment of a high-level system 520 showing interaction between real-time processing module 470a and offline processing module 470b. In some embodiments, real-time processing module relies upon data and information (e.g., weighted parameters, such as keywords, terms, phrases, tokens, concepts, categories, or any other data or information indicative of a user's interaction with a network or an application or program) stored in database 140 to process and enhance incoming requests, select sponsors or providers, or select contextual information to the user. Offline processing module 470b dynamically updates and maintains such weighted parameters according to various metrics that indicate value as determined by certain predefined empirical measurements. For example, weighted parameters may me adjusted periodically or in real-time according to demonstrated CTR, CPM, and eCPM, for example. Other empirical measurements are possible.

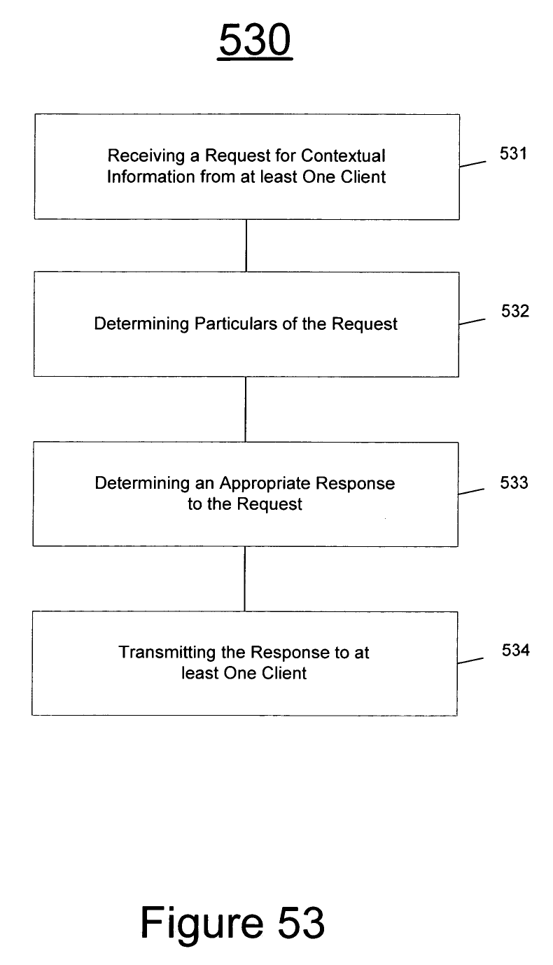

FIG. 53 illustrates one embodiment of a method 530 for processing a request for contextual information. At step 531, a request for contextual information is received from at least one client. At step 532, particulars of the request are determined. At step 533, an appropriate response to the request may be determined. In some embodiments, determining an appropriate response may comprise: (1) enhancing, adding, or deleting select particulars of the request, (2) determining at least one appropriate sponsor or provider to fulfill the request, and/or (3) determining appropriate contextual information to present to the client in response to the request.

At step 534, contextual information based on the appropriate response is sent to the requesting client station.

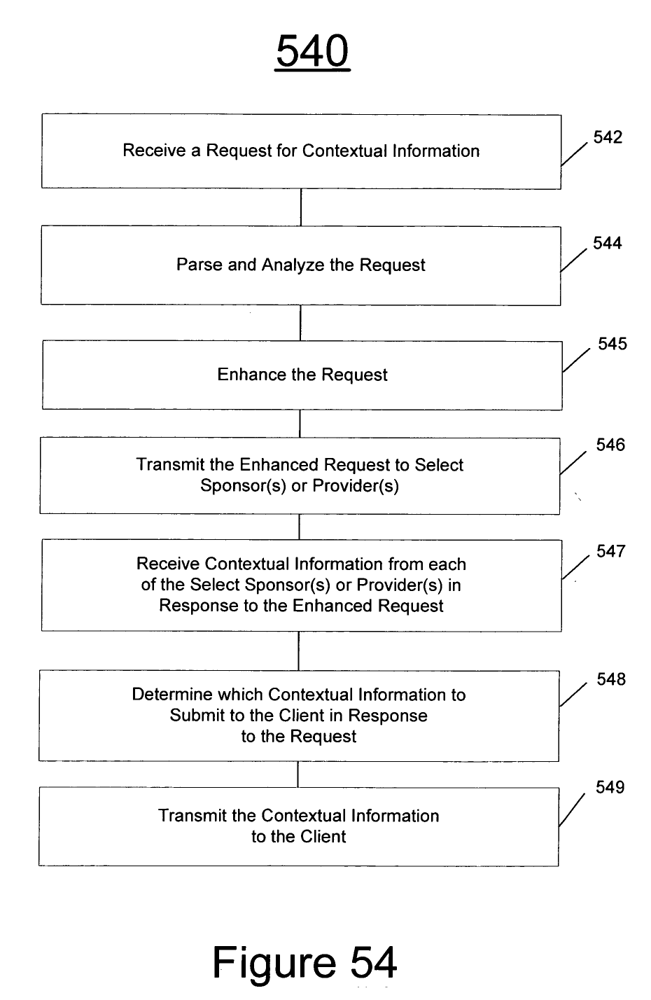

FIG. 54 illustrates one embodiment of a method 540 for processing a request for contextual information. At step 542, a request for contextual information is received. At step 544, the request is parsed and analyzed. At step 545, the request is enhanced. At step 546, the enhanced request is submitted to select sponsor(s) or provider(s). At step 547, contextual information from the select sponsors or providers is received in response to the enhanced request. At step 548, contextual information to send to the client in response to the request is determined. At step 549, the contextual information is transmitted to the client.

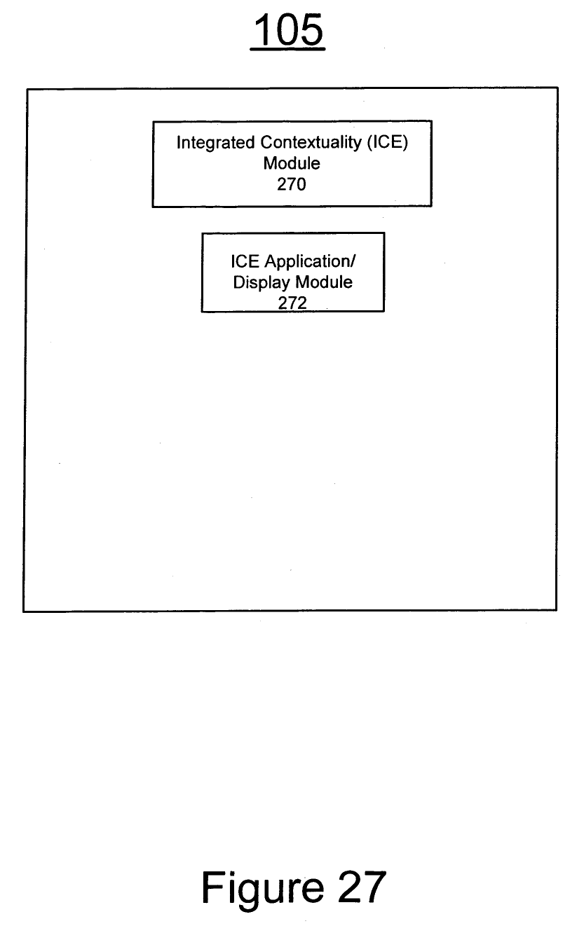

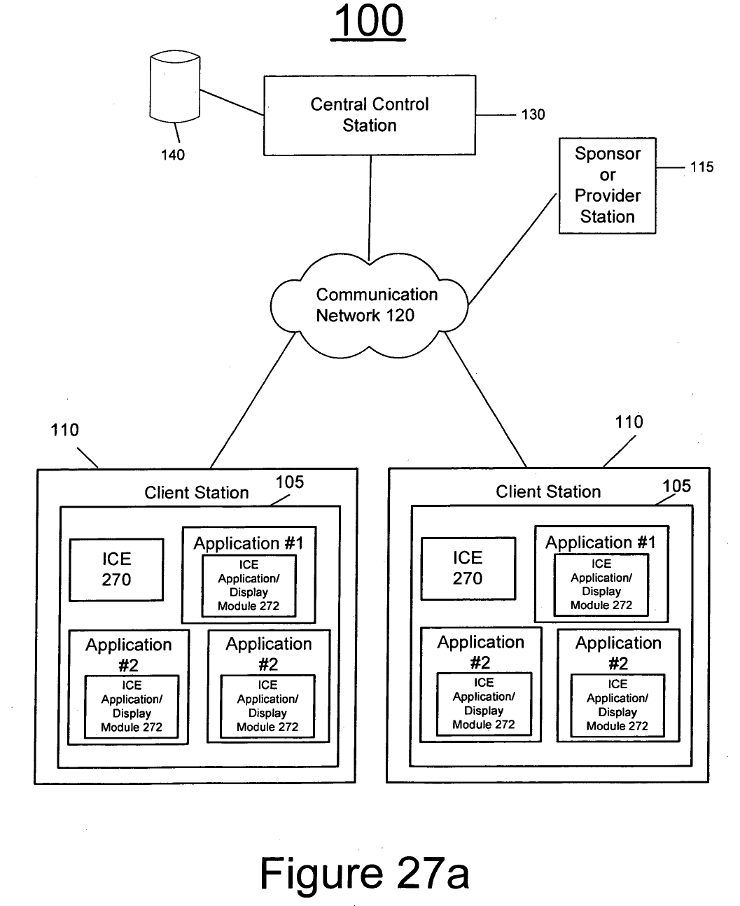

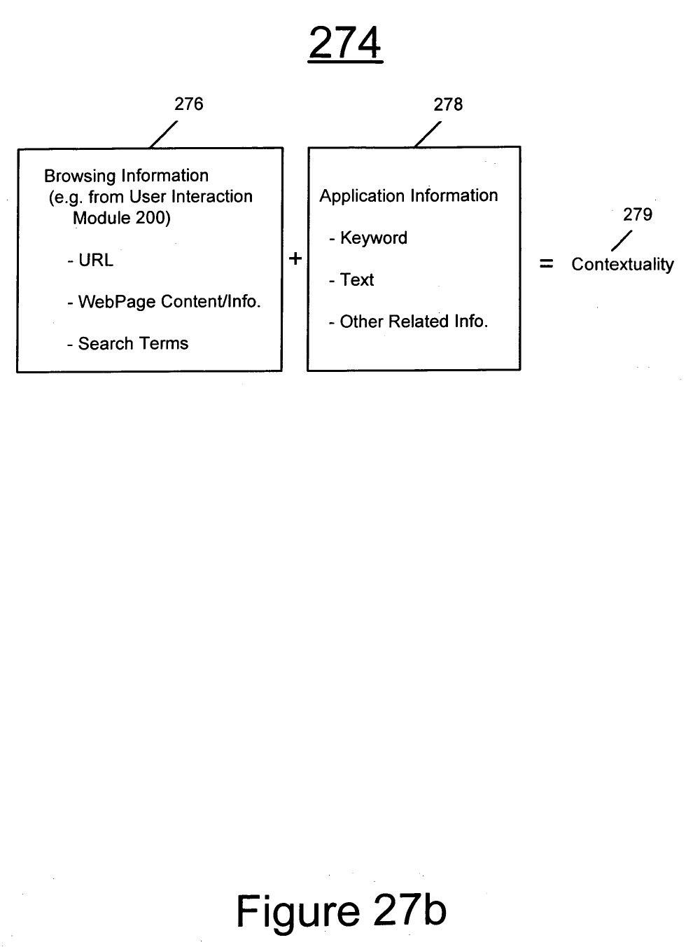

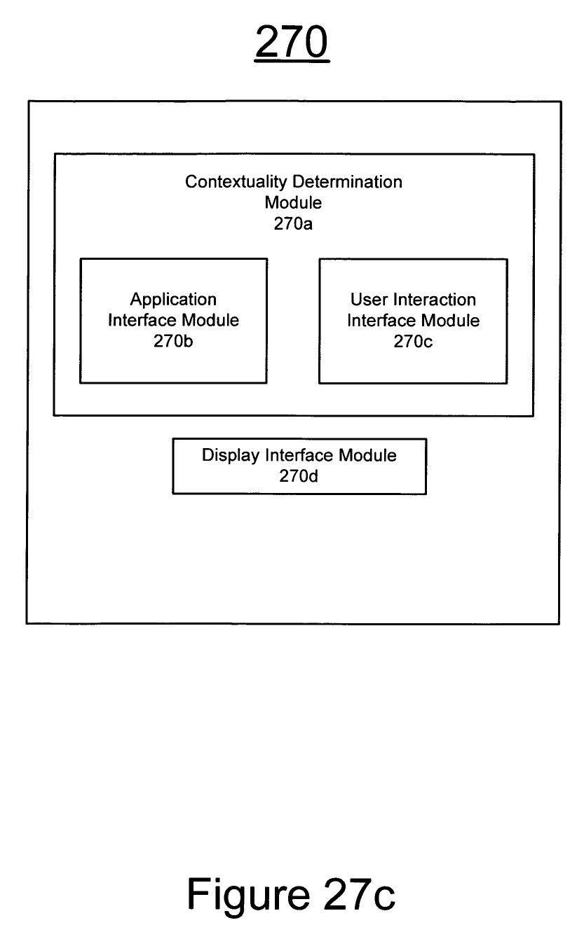

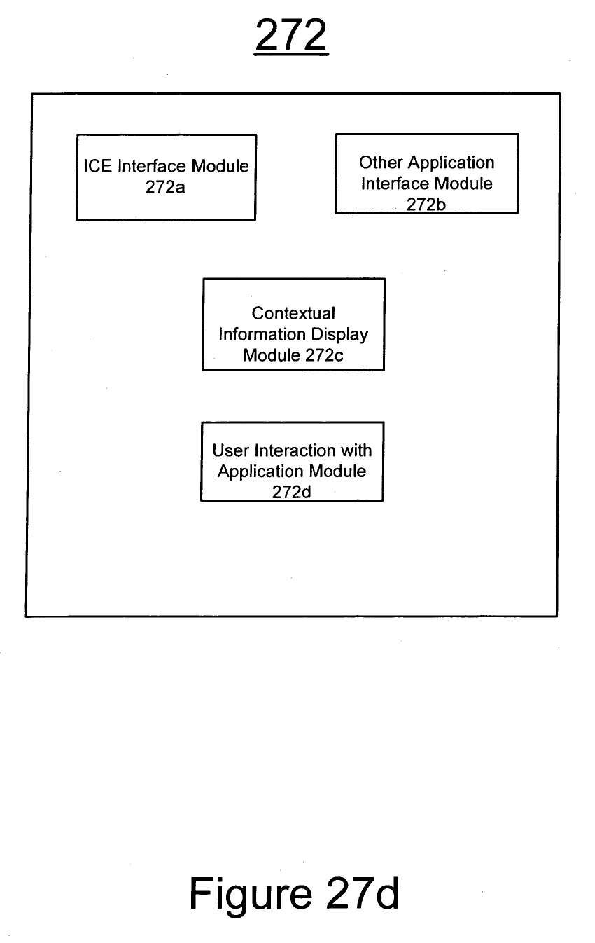

The various systems and methods described below in FIGS. 27-46 may, in some embodiments, be used in conjunction with the systems and methods disclosed and described below and in FIGS. 1-26. In various embodiments, the systems and methods of FIGS. 27-46 may be used with other systems and methods for providing contextual information to a user.

FIG. 27 illustrates an exemplary integrated contextual engine (“ICE”) module 270 that may be associated with contextual information module 105 to enhance the various functions and features of the embodiments described herein. In some embodiments, ICE module 270 may reside on any of client stations 110 and may cooperate with any of the systems and methods described herein for providing contextual information. In some embodiments, ICE module 270 may operate and perform its functions while protecting the personally identifiable information (PII) of users, without in any way uniquely identifying any user or deriving any behavior that specifically identifies a user.

In some embodiments, client station 110 may include an ICE module 270 and ICE application/display module 272 that enhance contextuality determinations by supplementing the various contextuality determination techniques described herein, for example, with contextuality determination(s) made at the application or program level. That is, contextuality determinations based on a user's interaction with a network may be enhanced by incorporating or augmenting particulars of the user's interaction with an application or program. Particulars of the two interactions may then be combined into a request for contextual information that may be used to determine or ascertain relevant contextual information to present to the user, such as by transmitting such request for contextual information to central control station 130 or sponsor or provider station 115.

For example, a user's interaction with a network (e.g. browsing behavior) may, with the user's permission, be enhanced or supplemented by particulars of the user's conversation over the messaging feature of a particular email or messaging application or program. In such an example, the email or messaging application or program may have an associated ICE application/display module 272 that may monitor the user's conversation with another user, for example, and therefrom identify particular keyword(s) terms, phases, strings, concepts, tokens or other particulars that capture the conversation's context. These keywords, terms, phases, strings, concepts, tokens or other particulars may then be added to a request for relevant contextual information composed according to the various techniques described herein. Thus, a user browsing the Internet and viewing web sites of car manufacturers may subsequently engage in a conversation with another user wherein the user expresses frustration at not finding the right sports car. Using the various systems and methods described herein, contextuality based on the user's browsing history may be enhanced by the contextuality of the user's conversation. In some embodiments, the ICE module 270 may aggregate the user's interaction with the network (e.g., “network contextuality”) with the user's interaction with the application or program (e.g., “application contextuality”) to determine or compose a request for particular or relevant contextual information. In some embodiments, such request may be transmitted to central control station 130 or sponsor or provider stations 115, for resolution and fulfillment, as described herein.

In some embodiments, user interaction with an application or program may be monitored or tracked by ICE application/display module 272. In some embodiments, the ICE application/display module 272 may be embedded within the application or program with which it is associated. The ICE application/display module 272 may, in some embodiments cooperate with ICE module 270 display relevant contextual information to the user based on the user's interaction with the application/program and/or network for example. The contextual information may be displayed to the user through the particular application or program. For example, in the messaging example described above, the user may be presented with contextual information on the messaging window, or any designated portion or section of the user interface associated with the application or program. As used herein, application or program may comprise any executable algorithm or code that resides or accessed from a client station, as well any web page or site that a user may actively or passively interact with.

FIG. 27a illustrates a more detailed version of system 100 shown in FIG. 1. As shown, each client station 110 may include an ICE module 270 and any number of applications. The ICE module 270 may, in some embodiments, integrate or augment contextuality determinations based on the user's interaction with the network and the application(s) or program(s) to determine overall contextuality of the user's behavior. In some embodiments, each application may include its own ICE application/display module 272 so that user interaction with the application or program may be particularly monitored and tracked. That way, if a user is running several applications at once, the user's interaction with each may be independently and simultaneously monitored and tracked. Likewise, each application or program may present the user with the appropriate relevant contextual information.

FIG. 27b illustrates one embodiment of a process flow 274 for for integrating or augmenting contextuality determinations. At step 276, the user's interaction with a network may be monitored or tracked. As described herein, such interaction may result in the identification or composition of a request comprising: (1) particular uniform resource locator(s) (“URLs”), (2) web page content or information, (3) and/or particular search term(s) that relate to the user's interaction with the network. Such URLs, web page content or information, or search term(s) may be used to determine contextuality of the user's interaction with the network and to determine identify contextual information related thereto. In some embodiments, user interaction with the network may be monitored or tracked according to any of the various systems and methods described herein, such as by user interaction module 200, for example. In some embodiments, ICE module 270 may monitor or track user interaction with the network.

At step 278, the user's interaction with an application or program on the user's client station may also be monitored or tracked. Such interaction may result in the identification of or composition of a request comprising particular keyword(s), text, web pages or sites, or other information (e.g., URLs) that relate to the user's interaction with the application or program. Such keyword(s), text, web pages or sites, or other related information may be used to determine contextuality of the user's interaction with application or program. In some embodiments, user interaction with the application or program may be monitored or tracked by ICE module 270 or ICE application/display module 272, for example.

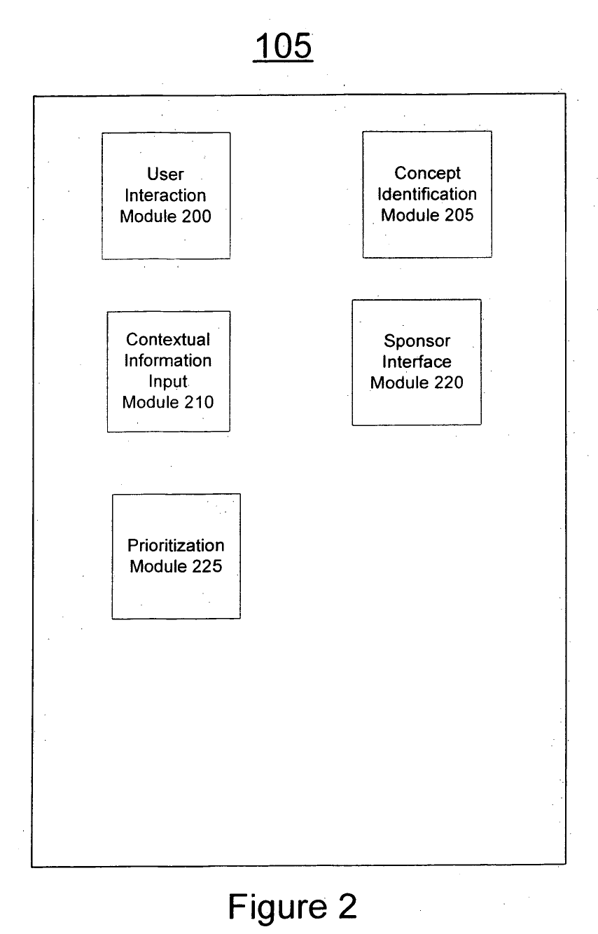

At step 279, overall contextuality (e.g., contextuality based on the user's interaction with the network and any number of applications or programs) may be determined or ascertained. In some embodiments, such determination may be made by ICE module 270 and/or ICE application/display module 272 by taking into account the user's interaction with the network and/or the user's interaction with an application or program (e.g., forming a comprehensive or aggregate request for contextual information). Contextuality may be based on a combination of the user's interaction with the network and any number of applications or programs, or may be based on the interaction with the network, or all or select applications programs, exclusively. In some embodiments, overall contextuality determination may comprise augmenting URLs, web page content or information, and/or search term(s) obtained from the user's interaction with the network, with keyword(s), text, web pages or sites, or other related information (e.g., URLs) obtained from the user's interaction with any number of applications or programs. In some embodiment, the combined information/request(s) may then be transmitted to central control station 130 or sponsor or provider station(s) to determine or identify relevant contextual information to present to the user. In some embodiments, selecteds contextual information may then be transmitted back to ICE module 270 or ICE application/display module 272 for display to the user. In some embodiments, such contextual information may be determined by ICE module 270, ICE application/display module 272, or any of the other systems and methods described herein for determining and identifying contextual information to present to the user, such as those described in FIG. 2, for example.

FIG. 27c illustrates one embodiment of an ICE module 270. As shown ICE module 270 may comprise a contextuality determination module 270a, which itself comprises an application interface module 270b and a user interaction interface module 270c. Contextuality determination module 270a may aggregate contextuality determinations relating to the user's interaction with an application or program and the user's interaction with the network. In some embodiments, contextuality determinations of the user's interaction with an application or program and the user's interaction with a network may be received via application interface module 270b (which may interface with the appropriate ICE application/display modules 272) and the user interaction interface module 270c (which interfaces with the appropriate modules that determine user interaction with a network, such as those disclosed in FIG. 2, for example), respectively. In some embodiments, the aggregated contextuality determinations may be transmitted to central control station 130 or sponsor or provider stations 115 for determination and identification of appropriate contextual information to present to the user. Contextual information so identified may then be transmitted back to the ICE module 270 or ICE application/display module 272 for presentation to the user. In some embodiments, ICE module 270 may also include a display interface module 270d for delivery of contextual information to ICE application/display modules 272 for ultimate presentation to the user via the appropriate application(s) or program(s).

FIG. 27d illustrates one embodiment of an ICE application/display module 272. As shown, ICE application/display module 272 may include: (1) an ICE interface module 272a for enabling interaction and communication between ICE application/display module 272 and ICE module 270, (2) an other application interface module 272 for enabling interaction and communication between various ICE application/display modules 272, (3) a contextual information display module for receiving and presenting to the user contextual information related to the user's interaction with the network or an application(s) or program(s), and (4) a user interaction with application module 272d for monitoring and tracking user interaction with an application or program. In some embodiments, ICE application/display module 272 (or contextual information display module 272c) may be embedded within an application or program to enable proper monitoring and tracking of a user's interaction therewith. In some embodiments, ICE application/display module 272 may display contextual information to a user via an application or program. For example, an ICE application display module 272 associated with an email reader may display contextual information to the user within the email reader or within individual messages or mail, for example. In some embodiments, ICE application/display module, 272 is an Active X control so that it may be embedded within any application, program, web page or site, text, or any other interface.

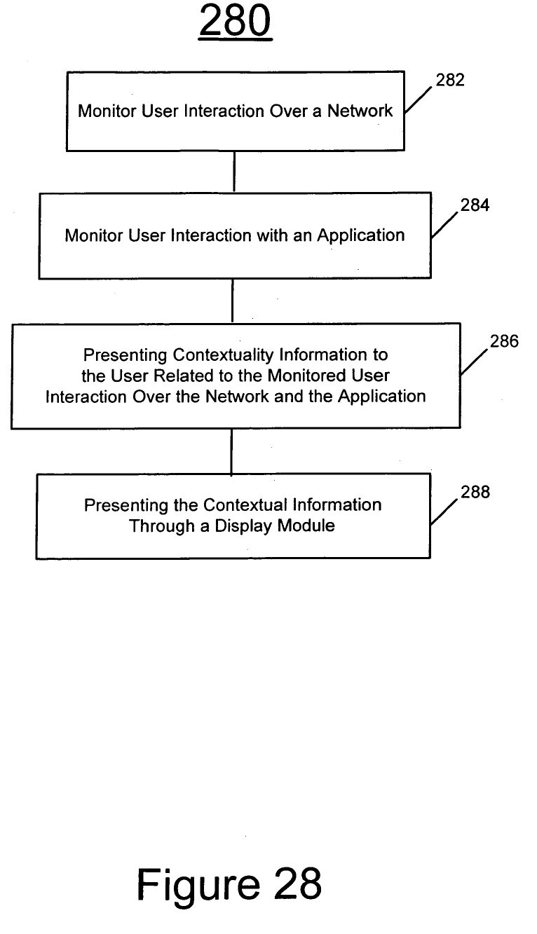

FIG. 28 illustrates one embodiment of a process flow 280 for providing a network user with contextual information. In some embodiments, process flow 280 may be performed by any of the systems and methods described herein, including ICE module 270 and ICE application/display module 272. At step 280, user interaction over a network may be monitored or tracked. As described herein, user interaction over a network may involve: (1) tracking the URLs of web sites or pages viewed by the user, (2) extracting information about the content of web sites or pages viewed by the user, and/or (3) by tracking the search terms or phrases used by the user to conduct online searches and/or provide or request information. User interaction over a network may be performed by any of the systems and methods described herein, such as the modules described in FIG. 2 or the ICE module 270, for example.

At step 284, user interaction with an application may be monitored or tracked. In some embodiments, user interaction over a network may involve: (1) tracking the URLs of web sites or pages viewed by the user with the application or mentioned by the user through interaction with the application, (2) extracting, determining or identifying content information about the user's interaction with the application, such as keywords or blocks of text or other information or data used by the user in providing information or data to, or obtaining information or data from, the application, for example, and/or (3) any other information or data that may be extracted, determined or identified based on the user's interaction with the application. In some embodiments, information about User interaction with the application may be performed by ICE module 270 or ICE application/display module 272, for example.

In some embodiments, ICE application/display module 272 may transmit information about the user's interaction with the application or program (e.g. keyword(s), text, web pages or sites, or other related information of the user's interaction with the application or program) to the ICE module 170 for aggregation with information about the user's interaction with the network. At step 286, ICE module 270 may aggregate the user's network and application interaction information into a request for contextual information, and, in some embodiments, transmit such request to central control station 130 or sponsor or provider station(s) 115 for determination or identification of relevant contextual information to present to the user contextual information determined to be relevant to request may be transmitted to ICE module 270 or ICE application/display module 272 for presentation to the user. In some embodiments, ICE module 270 or ICE application/display module 272) may determine or identify relevant contextual information to present to the user.

At step 286, contextual information determined to be relevant to the user's interaction with the network or application may be presented to the user via the appropriate application(s) or any other appropriate interface such as a pop-up or pop-behind window, for example. For example, the particular application or program with which the user is interacting may include a display screen, section or portion on or through which such contextual information may be presented to the user. Where in the application such screen, section or portion resides may be determined by the administrator of the application.

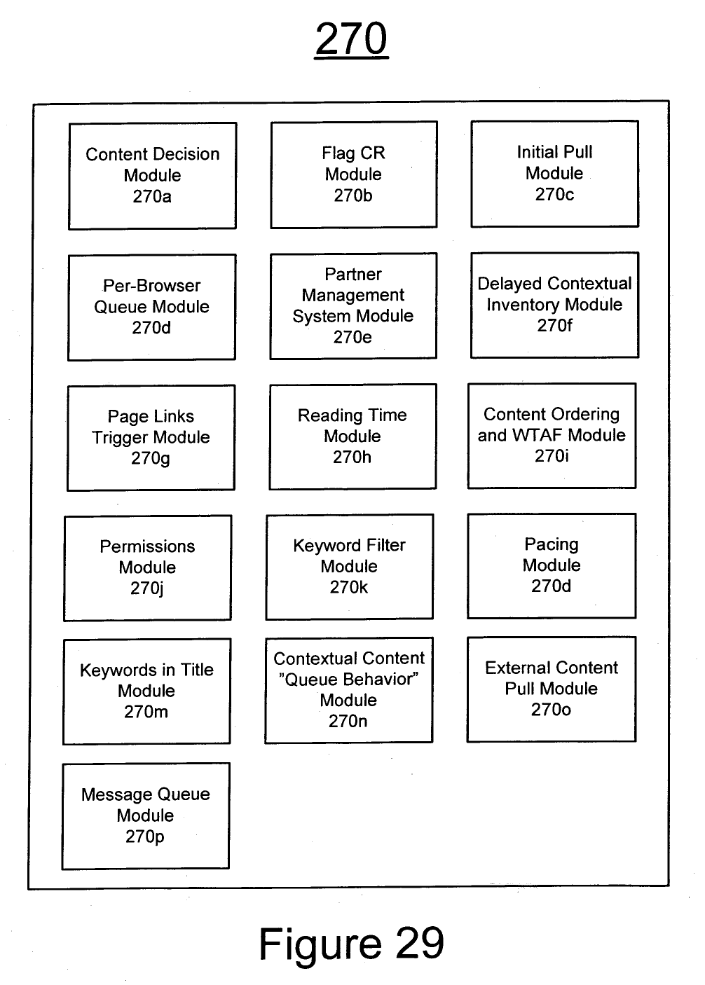

FIG. 29 illustrates additional exemplary modules that may be associated with contextual information module 105, ICE module 270, or ICE application/display module 272 to perform or enhance the various features and functions of the systems and methods described herein. While the modules may not be used in all embodiments to perform some or all of the functions of the present invention, they are nonetheless presented as possible embodiments. As shown, the following modules may be provided: (1) content decision module 270a; (2) flag CR module 270b; (3) initial pull module 270c; (4) per-browser queue module 270d; (5) partner management module 270e; (6) delayed contextual inventory (“DCI”) module 270f; (7) page links trigger module 270g; (8) reading time module 270h; (9) content ordering and WTAF module 270i; (10) permissions module 270j; (11) keyword filter module 270k; (12) pacing module 270l; (13) keywords in title module 270m; (14) contextual content queue behavior module 270n; (15) external pull module 270o; and (16) message queue module 270p. In some embodiments, each of these modules may reside on any of client stations 110 or central command station 130 and may cooperate with any of the various features and functions described herein for providing contextual information. All of the modules operate and perform their respective functions while protecting the personally identifiable information (PII) of users, without in any way uniquely identifying any user or deriving any behavior that specifically identifies a user. Each is described below.

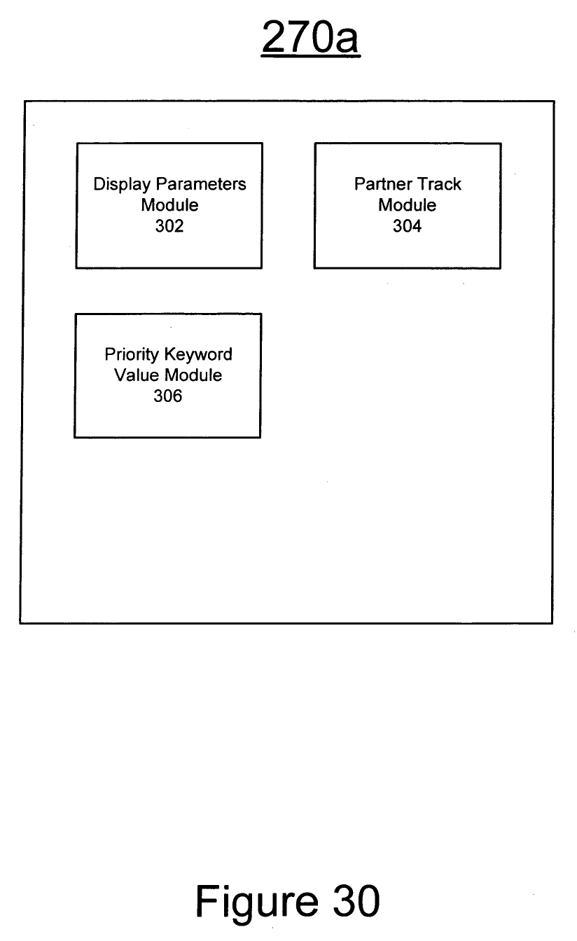

FIG. 30 depicts one embodiment of a content decision module 270a comprising a display parameters module 302, a partner track module 304, and a priority keyword value module 306. In some embodiments, ICE module 270 may send to central control station 130 or sponsor or provider stations 115—in addition to information about a user's interaction with a network and an application(s) used to determine or identify relevant contextual information—additional information about the partner (e.g. the owner, operator, or administrator of an application program, or the sponsor or provider of contextual information), application or program, to be taken into account in formatting or customizing the contextual information to be delivered and presented to the user. In some embodiments, information about the partner's display (e.g., height and width of the display) may be sent to ensure proper sizing and presentation of the contextual information. Requirements information may also be sent to ensure that appropriate contextual information is delivered to the partner. For example, the partner may have requirements regarding the types of contextual information the partner would like to present (or not present), as well as the source of such contextual information.

In some embodiments, additional information sent to central control station 130 or sponsor or provider stations 115 may include priority keywords, phrases, strings, value, numbers, data, or other information that allow for the prioritizing of contextual information. For example, certain contextual may have higher value than other contextual information (e.g. an advertisement that has a high click through date (CTR)). Keyword tables may be utilized to ensure that preferred partners have priority to or receive the more valuable contextual information. For example, tables may be constructed that arrange associate contextual information by value; (e.g. 0, 1, 2, . . . n). Requests for information sent from a client may also have a designated priority keyword, item, phrase, string, value, number, data or other information that specifies partner status or priority. The priority keyword or other payments may then be matched with the appropriate contextual information by central control station 130 or sponsor or provider station 115, or other system which resolves or fulfills the request for centralized information.

Parameters module 302 may, in some embodiments, process particulars of an application's display screen, portion or section (e.g., width and height of display) to ensure proper sizing and presentation of the contextual information to the user. Partner track module 304 may, in some embodiments, process information about the partner useful to customize or personalize contextual information to the user. Priority keyword value module 306 may, in some embodiments, process keywords, terms, phrases, strings, data or other information to ensure that priority partners receive high value contextual information. For example, priority keyword value module 306 may populate a request for contextual information with the appropriate priority keyword, term, phrase, string, value, number, data or other information. Such request may then be resolved or fulfilled by central control station 130, sponsor, or provider 115, or other like system.

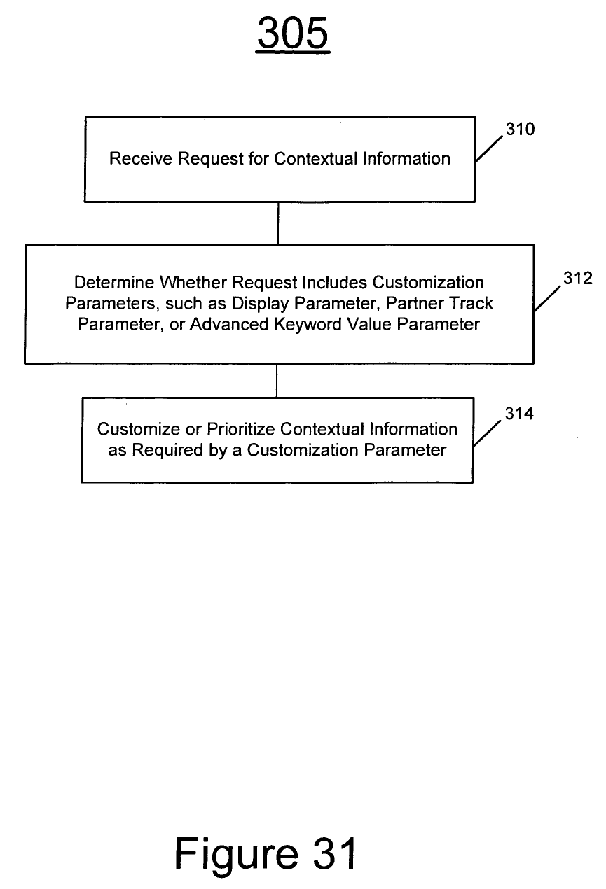

FIG. 31 illustrates one embodiment of a process flow 308 for processing information or data received from content decision module 270a. At step 310, a request for contextual information may be received. In some embodiments, the request is received by the central control station 130 or sponsor or provider stations 115. In some embodiments, the request may be transmitted by ICE module 270 or ICE application/display module 272 or any of the systems and methods described herein. In some embodiments the request comprises information about the user's interaction with the network or the user's interaction with an application or program. At step 312, the central control station 130 or the sponsor or provider station 115 may determine whether the request includes customization parameters, such as a display parameter, a partner track parameter, or priority keyword value parameter. At step 314, the central control station 130 or sponsor or provider station 115 may customize or prioritize contextual information as required by the particular customization parameter.

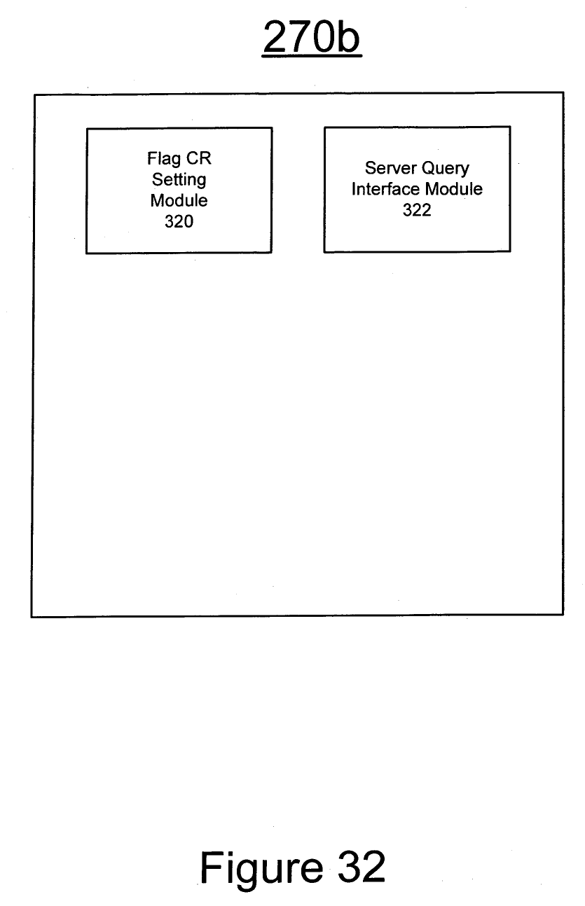

FIG. 32 depicts one embodiment of a flag CR module 270b comprising a flag CR setting module 320 and a server query interface module 322. Situations may occur where two identical or substantially similar requests for contextual information are sent by one or many clients in quick succession. For example, a user may conduct a search on a search engine in the main browser, then quickly perform the same or similar search in an application or program. Or, the user conducts a search in the browser, and advanced keywords picked from the results produce the same exact search term.

In each of the situations described above, it may be desirable to have some level of control over when and whether content gets reloaded with two identical or substantially similar requests (e.g. the contextual information in the first request gets replaced with the contextual information of the second request). In some embodiments, flag CR module 270b may control the frequency with which similar or identical queries or requests occur within the ICE Module 270, the ICE application\display module 272, or any of the systems and methods described herein. In some embodiments, an administrator of the ICE module 270, for example, may interact or interface with FLAG CR setting module 320 to set particular values that specify how identical or substantially similar requests should be handled. The following rules may apply: Flag CR values may be designated for contextual information, users, sponsors or providers, or partners. In some embodiments, fLAG CR may take the value of zero, one, or two for example. In some embodiments, if a flag CR is not specified, it may be defaulted to a value of one.

If flag CR is equal to “Ø”, no two requests are considered identical. Thus, whenever new content is recognized in response to the second request, and other restrictions allow (most notably ordering restrictions), the second request is sent and the content is reloaded.

If flag CR equal to “1”, two requests are considered identical if they have the same composition (e.g. kw equals (search term)) and the same STP equals (indicating the content kind, for example sen for search, add for AKWD, bid for BIDPXP). If there is active content currently displayed by an ICE product, and a new content needs to be displayed (and it has passed all other possible restrictions such as ordering for example), the new content is ignored and the request is not made.

If Flag CR is equal to “2”, two requests are considered identical if they have the same kw equals (search term). Otherwise, the behavior is the same as for Flag CR equals one. The difference is that STP equals is not taken into account.

In some embodiments, if the new content is determined to be “the same” (within the meaning of current flag CR settings) as the currently displayed content, it is not loaded even if the reading time has already elapsed.

The functionality associated with flag CR module 270b is described by the following example. If a user searches for car, and then searches again for car two minutes later, the flag CR Value can determine whether a server (e.g. Central Control Stations 130 or sponsor or provider station 115) should be queried with car. In some embodiments, flag CR module 270b allows an administrator of ICE Module 270, for example, to arrange for contextual information to be reloaded only if there is a material change in a key word or the triggering logic (e.g. advance key word or user search), for example. Thus, flag CR module 270a, and its three set levels, may enable an administrator of ICE Module 270 to determine and specify when effective resubmissions to a server can be made.

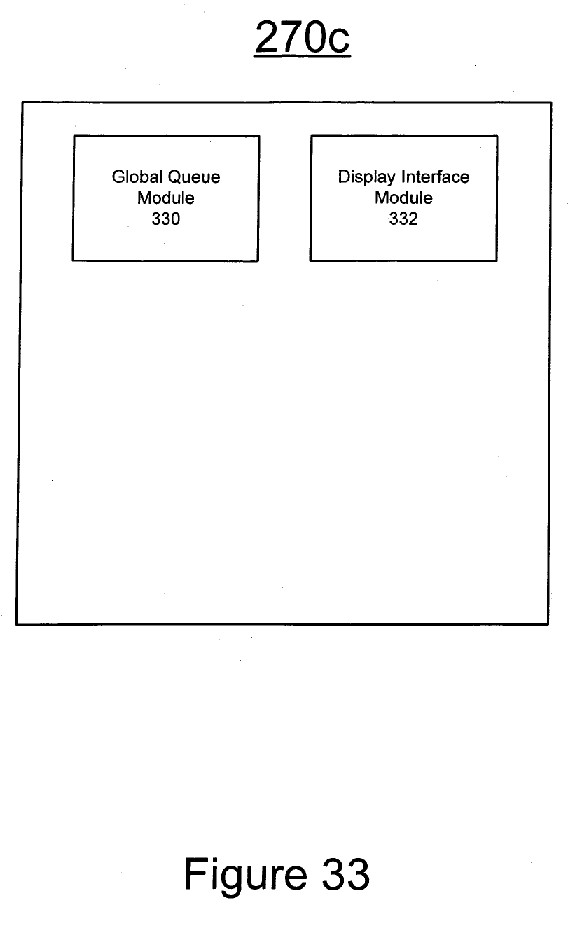

FIG. 33 depicts one embodiment of an initial pull module 270c comprising a global queue module 330 and a display interface module 332. In some embodiments, contextual information that cannot be displayed to the user for some reason or another may be placed in the global queue. In some embodiments, contextual information in the global queue may displayed when properly triggered by an ICE application/display module 272. In some embodiments, when an ICE application/display module 272 registers for the first time (e.g. a new application or program on the user's computer gets associated with an ICE application/display module 272 with the ICE module 270), contextual information from the global queue may be sent to the ICE application/display module 272 for presentation to the user. This way, each registering application or program may have contextual information available for immediate display to the user.

In some embodiments, the global queue may comprise contextual information that cannot be displayed for one reason or another. Thus, if contextual information is sent to an ICE application/display module 272, but for some reason it cannot be displayed, the contextual may be placed in the global queue. In some embodiments, all ICE application/display, modules 272 on a user's computer have access to the global queues.

Global queue module 330 may, in some embodiments, interface and interact with the global queue to receive or transmit from or to the global queue. Display interface module 332 may, in some embodiment, interact and interface with the display module of ICE application/display module 272 to provide content received from the global queue to be presented to the user via the application.

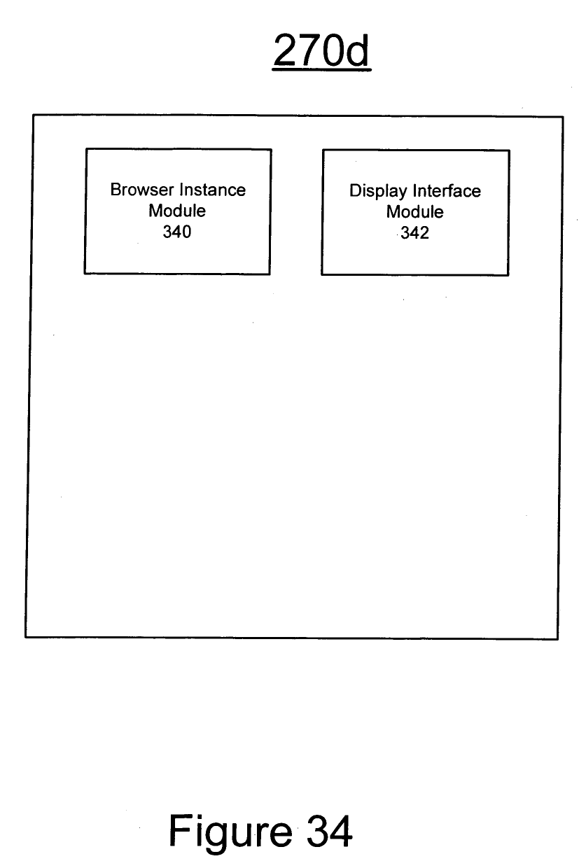

FIG. 34 depicts one embodiment of a per-browser queue module 270d comprising a browser instance module 340 and a Display Interface Module 342. In some embodiments, each particular application or program (e.g. ICE application/display module 272) may have its own corresponding browser queue, as well as its own application queue. Typically, the browser queue may comprise contextual information that was to be presented to the particular browser in application, but for one reason or another was not able to be displayed. In such situation, the contextual information is placed in the corresponding browser queue. Once the application or program is able to receive contextual information, it may refer first to the corresponding browser queue for the next available contextual information. If such browser queue is empty, and if the particular ICE Application/Display Module 272 is not tied to a particular browser, then the application or program may refer to the global queue. If, however, the application or program is tied to a particular browser, then only the browser queue corresponding to is referred to for the next available contextual information. This way, an application tied to a browser can never receive content that did not originate in that browser.

Browser instance module 340 may, in some embodiments, interface and communicate with various applications to identify corresponding browsers. Display interface module 342 may, in some embodiments, receive contextual information obtained from the browser queue for presentation to the user.

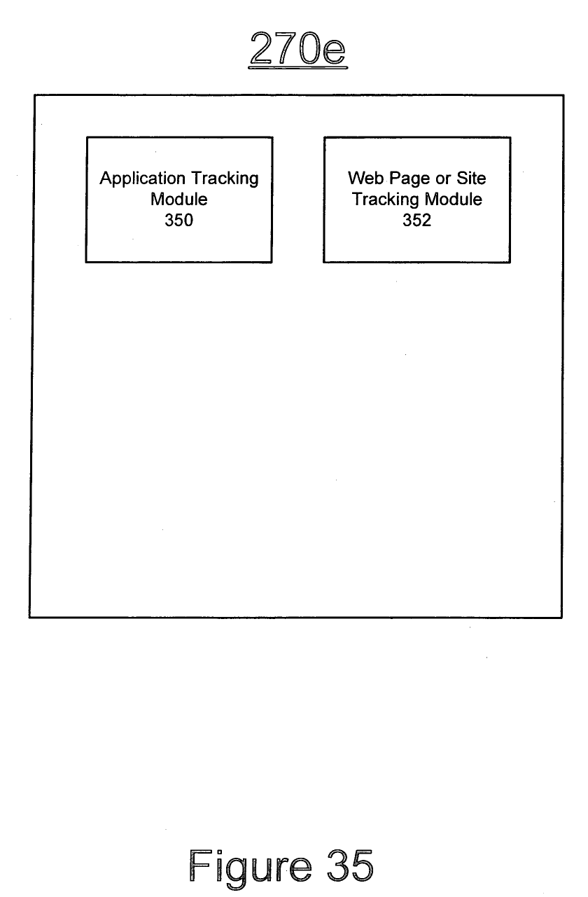

FIG. 35 depicts one embodiment of the partner management module 270e comprising an application tracking module 350 and a web page or site tracking module 352. In some embodiments, an ICE module 270 residing on a user's computer may support any number of applications or programs on the user's computer that are associated with an ICE application/display module 272 (e.g. applications or programs that track or monitor a user's interaction therewith). In some embodiments, partner management module 270e may keep track of how many applications or programs are on the computer at any given time. In particular, application tracking module 350 may operate to maintain an accurate list of applications residing on the user's computer that include an ICE application/display module 272. Similarly, web page or site tracking module 352 may, in some embodiments, keep track web pages or sites associated with an ICE application/display module 272, and which the user periodically or frequently accesses or visits. In some embodiments, partner management module 270b may periodically scan user's computer to determine the current number of active applications and/or web pages or sites. Such periodic scanning may be determined by the administrator of the ICE module 270 or the user.

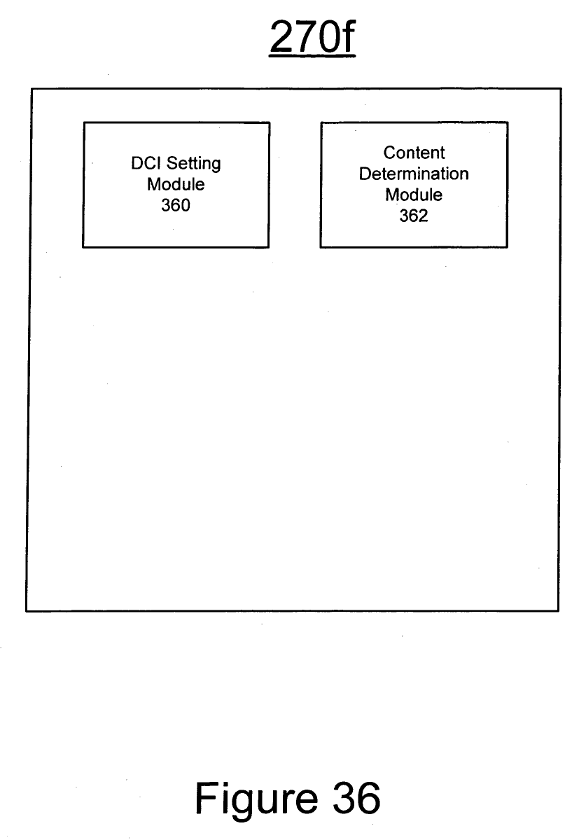

FIG. 36 depicts one embodiment of a delayed contextual inventory (DCI) module 270s comprising a DCI setting module 360 and a content determination module 362. In some embodiments, if a contextual information request triggers, it can result in contextual information being displayed to the user immediately (e.g. such as through a toolbar or the ICE application/display module 272), or it can be flagged for delayed prosecution. In some embodiments, a DCI-flagged contextual information may be shown if the user subsequently visits a general content site, or performs any predetermined activity. In some embodiments, a general content site may comprise any web page or site designated by an administrator of ICE module 270E, for example, to trigger the presentation of DCI-flagged contextual information.

For example, assume a user visits a mortgage web page or site triggering a request that calls up advertisement of a particular bank that is designated as DCI content. Because the advertisement is designated DCI, it will not be displayed to the user at that moment. Rather, the advertisement is designated to be displayed once to the user visits a general content site, such as a predetermined search engine web page or site, for example. That way, the user now being at a search engine web page or site, the advertisement may induce the user to query or enter a search term related to the particular bank or lender being advertised, or the user may click or initiate the advertisement for additional information thereon.

DCI setting module 360 may, in some embodiments, enable an administrator of ICE module 270, for example, to set and flag contextual information for delayed presentation. Content termination module 362 may, in some embodiments, determine whether contextual information is flagged for delayed presentation. If so, the particular ad is then queued for delayed presentation, such as once the user visits a predetermined web page or site, for example.

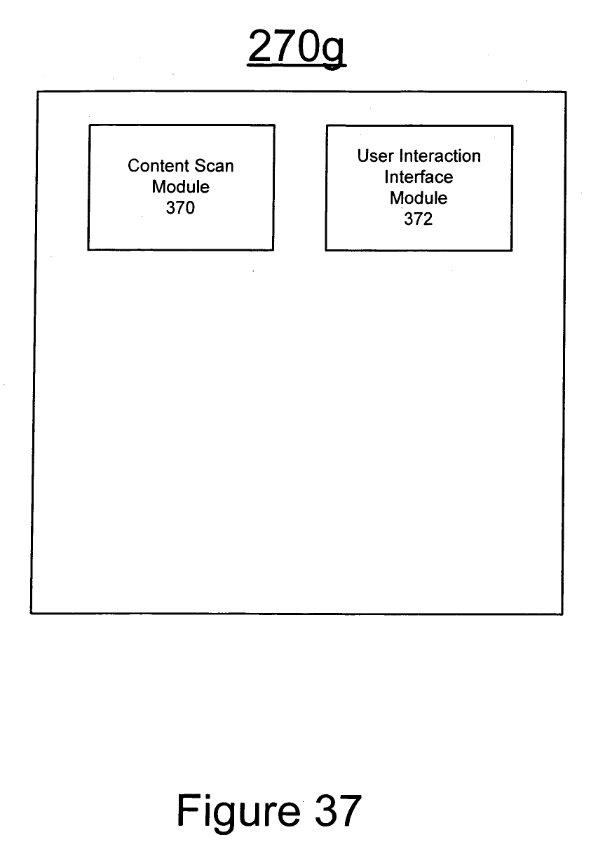

FIG. 37 depicts one embodiment of a page link trigger module 270g comprising a content scan module 370 and a user interaction interface module 372. In some embodiments, the contents of a web page or site may be determined by looking for key words in the text of the web page or site. Another source of contextual information is the URLs or hyperlinks on page or site. For example, a page that links to many travel sites is itself is probably dedicated to travel. In some embodiments, page links trigger module 270g may scan and process the content of a web page or site to capture URLs and hyperlinks on the page. In some embodiments, captured URLs and hyperlinks may be resolved against category tables to determine patterns. For example, URLs and hyperlinks referring to the same web page or site need only be counted once. However, if a link matches a pattern that also matches the URL of the current page, this link is ignored. This way, only external links may be counted, since a web page or site is likely to have a lot of links to the same site which does not provide more contextuality than URL of the page itself (which is presumably captured by the regular pattern trigger).

Content scan module 370 may, in some embodiments, scan web pages or sites visited by the user to determine possible URLs or hyperlinks that link to external content. Content scan module 370 may also process the above functionality relating to or excluding internal URL links that add little, if any, additional information regarding the contextuality of a user's interaction with a particular web page or site.

User interaction interface module 372 may, in some embodiments, interact or interface with any system or method described herein which operates to determine the contextuality of user's interaction with a network and/or the user's interaction with an application or program. In some embodiments, user interaction interface module 372 may transmit external URLs and hyperlinks identified by content scan module 370 to such systems and methods which determine contextuality of user interaction. This way, contextuality determinations made by the various systems and methods described herein can take into account the external URLs and hyperlinks identified by content scan module 370.

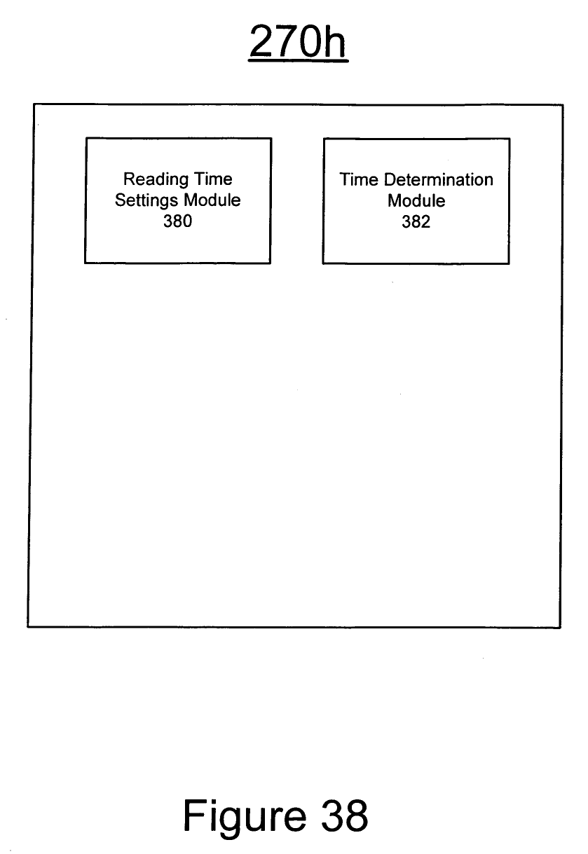

FIG. 38 depicts one embodiment of a reading time module 278 comprising a reading time settings module 380 and a time determination module 382. In some embodiments, it may be desirable to maintain a default amount of time before new contextual information is presented to a user. For example, such a default reading time may specify that once some contextual information is presented to the user, it can only be replaced by new contextual information if: (a) the new content has a higher priority, or (b) a predetermined time period has elapsed. In some embodiments, the new contextual information to be displayed is placed in queue (e.g. global queue or browser queue) for subsequent or future presentation.

Reading time settings module 380 may, in some embodiments, operate to enable an administrator of ICE module 270, for example, to set particular reading time values for contextual information to be displayed. Thus, a particular advertisement may have a corresponding reading time of two minutes. Therefore that particular advertisement must be displayed to the user for at least two minutes before it is capable of being replaced by another or subsequent contextual information. In some embodiments, exceptions may be included such that, for example, a user-initiated search would trump any established reading time for a particular contextual information. Therefore, if the particular advertisement is being displayed has a reading time of two minutes, it may nonetheless be replaced by triggered contextual information that results from a user-initiated search. Other forms of exceptions may be established or set, depending on the particular business needs or requirements.

Time determination module 382 may, in some embodiments, track and maintain the elapsed time for contextual information that is being displayed or presented to a user. In some embodiments, time determination module 382 may indicate whether a particular contextual information is eligible to be replaced, or whether it is still within its reading time and not able to be replaced unless, of course, an exception applies.

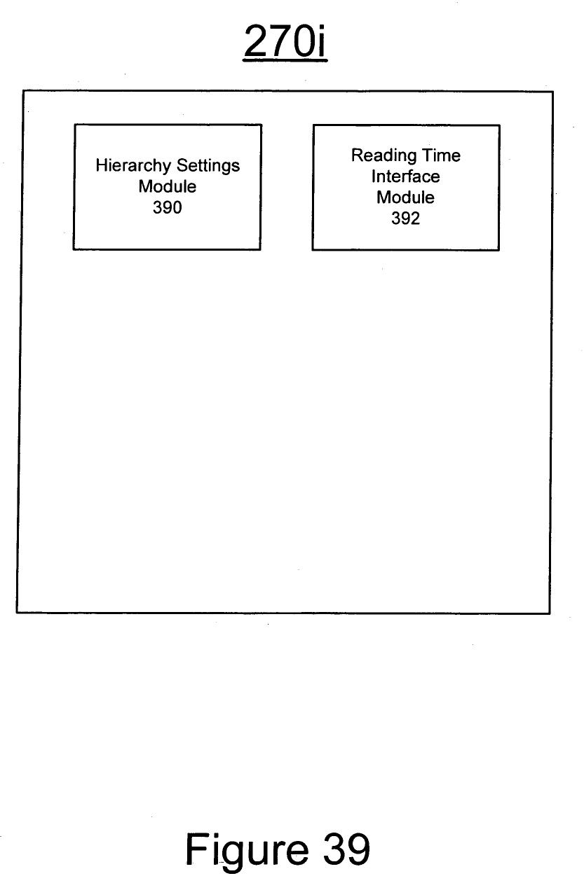

FIG. 39 depicts one embodiment of a content ordering and WTAF module 270i comprising a higher key settings module 390 and a reading time interface module 392. In some embodiments, contextual information to be shown to a user may be prioritized in a particular order. The content ordering is important in two situations. First, when user enter requires triggering of new contextual information, but there is already some contextual information being displayed and the reading time for that contextual information has not yet elapsed, the new content may nonetheless override the current contextual information if it has a priority. Second, when an event triggers several kinds of contextual information may be called up for display. In such a situation, the displayed content with highest priority may be displayed.

Hierarchy settings module 390 may, in some embodiments, enable the administrator of ICE module 270, for example, to set content ordering and priorities for a particular contextual information. Such settings may be made on an individual or category basis. For example, advertisements corresponding to a particular sponsor or provider may be given the highest level of priority over the advertisements of a competitor, for example. Similarly, any contextual information relating to a particular category, such as mortgages, for example, may be given a general high level ordering or priority. This way, any contextual information relating to mortgages, for example, may be displayed to the user over other forms of contextual information. Similarly, contextual information may be given priority according to the requirements of a partner. For example, a partner running an application relating to travel may wish to give priority to travel-related contextual information.

Reading time interface module 392 may operate to interface with reading time module 278 to take into account whether contextual information currently being displayed is within its reading time, or whether such time has expired. Reading time interface module may also make priority determinations for presenting contextual information to the user.

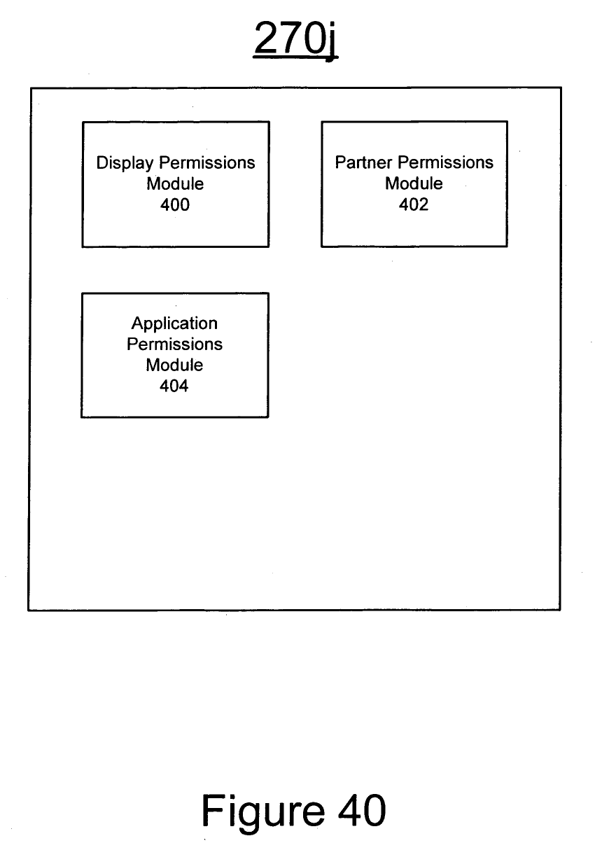

FIG. 40 depicts one embodiment of a permissions module 270J comprising a display permissions module 400, a partner permissions module 402 and an application permissions module 404. In some embodiments, it may be desirable to control permissions on a per application partner or ICE module 270 basis. For example, a misbehaving partner can be disabled altogether, or its priorities overridden. Similarly, other variables, such as reading time queue size, and content ordering, for example, may be modified or adjusted through permissions module 270.

Display permissions module 400 may, in some embodiments, enable an administrator of ICE module 270, for example, to modify or adjust permissions related to a particular ICE application/display module 272 display settings. Partner permissions module 402 may, in some embodiments, enable an administrator of ICE module 270 to modify or adjust permission settings on a per partner basis. Application permissions module 404 may, in some embodiments, operate to enable an administrator of ICE module 270, for example, to adjust permission settings on a per application basis.

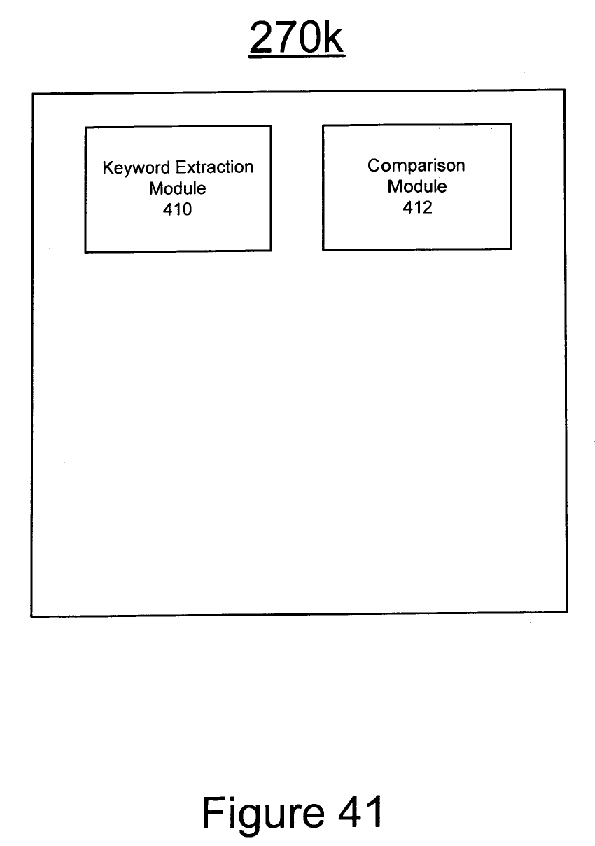

FIG. 41 depicts one embodiment of a keyword filter module 270k comprising a keyword extraction module 410 and a comparison module 412. In some embodiments, it may be desirable to filter out select keywords, terms, phrases, tokens, concepts and categories, have no value or have been shown historically to result in contextual information having low click through rate. In some embodiments, therefore, a filter may be used to compare a keyword, term, phrase, token, concept and category that is being extracted from particular user interaction or behavior with a set of predetermined keywords, terms, phrases, tokens, concepts, and categories that have been shown to have significant value or which historically result in a high click-through rate. Other reasons for including keywords, terms, phrases, token, concept, and categories in such a filter may, of course, be available.

Keyword extraction module 410 may, in some embodiments, extract select keywords, terms, phrases, tokens, concepts, and categories from a request for contextual information that has been triggered by any of the systems and methods described herein. For example, if ICE module 270 composes a request for contextual information comprising keywords related to the user's interaction with the network and/or the user's interaction with the application, keyword extraction module 410 may identify those keywords are and queue them for comparison to a filter of predetermined high value keywords.

Comparison module 412 may, in some embodiments, operate to compare the keywords extracted by keyword extraction module 410 to keywords of high value that may populate a given keyword filter. This comparison may result in the keyword being located in the filter, thus enabling the request/keyword to pass through to the server for resolution and fulfillment. However, if the keyword is not found in the filter, the request may be dismissed outright or placed in queue for subsequent or future transmission. In some embodiments, if the keyword is found, additional keywords related to the keyword may populate the request to further enhance the ability of the request to pull relevant contextual information. Likewise, if the keyword is not found in the keyword filter, then high-value keywords may populate the request and replace the original keyword to therefore increase the likelihood that the request will produce relevant contextual information. Increase in some embodiments, the keyword filter may comprise a list of most popular search terms that historically have produced good relevant results (e.g. high click-through rate). In some embodiments, a request may delete or ignore any search term that is not on the list.

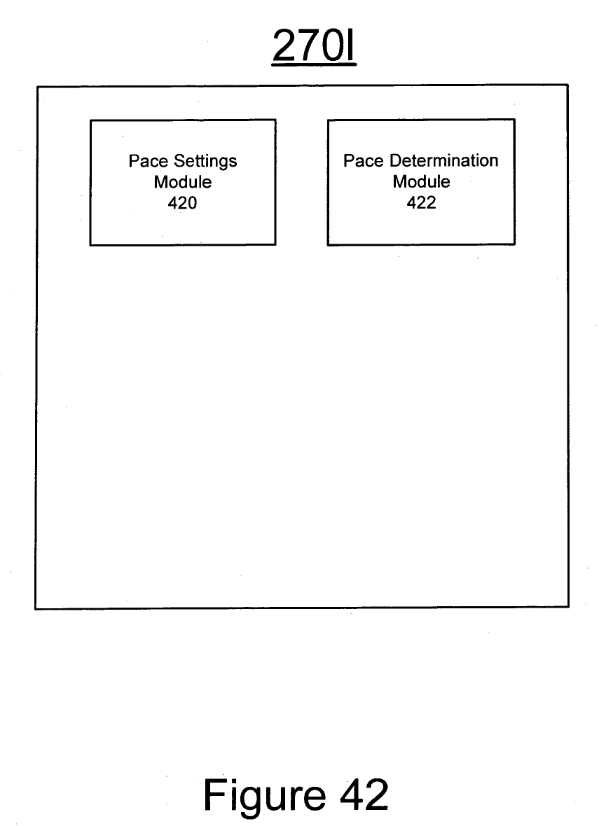

FIG. 42 depicts one embodiment of a pacing module 270l comprising a pace settings module 420 and a pace termination module 422. In some embodiments, it may be desirable to slow down the requesting of contextual information to enable a slow, manageable rate of fulfilled triggers or requests by the various systems and methods described herein. In some embodiments, a partner, sponsor or provider, user, application or program, or particular contextual information fulfillment may be associated with a request fulfillment rate parameter. Such request rate parameter may comprise a numeric value anywhere between “0” and “100”, for example. A request fulfillment rate of “0”, for example, may designate that the contextual information has zero chance of being dismissed from presentation to the user. In some embodiments, a setting of 100 may designate that the particular pace contextual information may never be shown or presented to the user. Thus, in one embodiment, by weighting contextual information, the ultimate rate of request fulfillment may be reduced. In some embodiment, particulars of a request may be weighted in order to dismiss the request before it is submitted for fulfillment.

Pace settings module 310 may enable an administrator of ICE module 270, for example, to specify pace settings for requests or contextual information, or other particulars as set for above.

Pace determination module 422 may operate to determine whether a particular request or contextual information, for example, that has been selected for presentation to the user is eligible for presentation or display. In some embodiments, pace determination module 422 may randomly determine whether the particular table or contextual information will be displayed to the user. In some embodiments, if a request or contextual information has a pace setting value of zero, case determination module 422 will never dismiss the request or contextual information from being displayed. If, however, the request or contextual information has a value of 50, for example, then the pace determination module 422 may dismiss such request or contextual information approximately 50 percent of the time. Thus, in some embodiments, the pace setting value for a particular table or contextual information may designate the probability that it will ultimately be displayed, or not be displayed, to the user. Other scales or methods of determining whether a table or contextual information will be displayed to the user are, of course, possible.

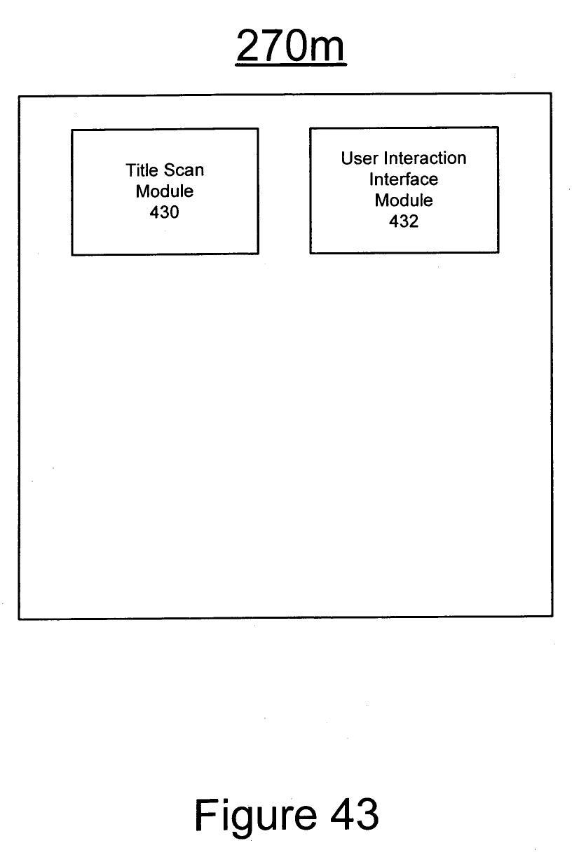

FIG. 43 depicts one embodiment of a keyword and title module 270n comprising a title scan module 430 and a user interaction interface module 442. In some embodiments, the various systems and methods described herein may compose requests for contextual information based on a user's interaction over the network or the user interaction over an application or program. In some embodiments, it may be desirable to base or compose such requests according to keywords, terms, phrases embedded in the title of a web page or site visited or viewed by the user. Such keywords, terms or phrases may then be added to the request in order to enhance or refine the contextual information that gets pulled in response thereto.

Title scan module 430 may, in some embodiments, scan the titles of web pages or sites visited or viewed by the user in order to identify and extract key words, terms or phrases used therein.

User interaction interface module 432 may, in some embodiments, receive keywords, terms or phrases extracted from the title of web pages or sites viewed by the user and transmit them or embed them into the request for contextual information being sent to Central Station 130 or sponsor or provider Station 115 for resolution and fulfillment.

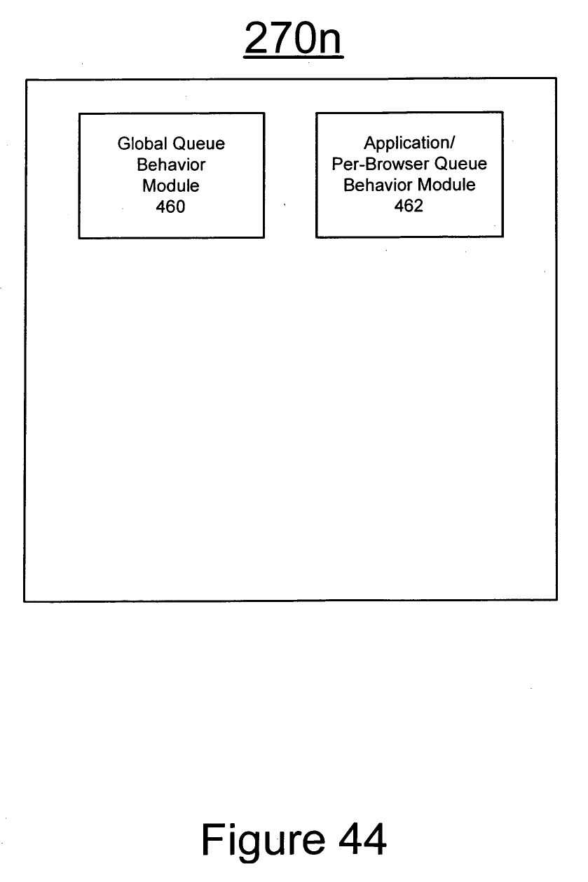

FIG. 44 depicts one embodiment of a contextual content queue behavior module 270n comprising a global queue behavior module 460 and a browser queue behavior module 462. In some embodiments, it may be desirable to manage or administer how contextual information that is in queue gets presented or queued up for display. In some embodiments, contextual information in queue may be presented first-in first-out. In some embodiments, contextual information that is in queue may be presented in a more robust way, such as by taking trigger type and time in queue into account, for example.

For example, each trigger (e.g., user initiated search, pattern, token, concept keyword, etc.) may have a value or parameter assigned to it. Higher value triggers may have higher priority. Time in queue may also influence priority. In some embodiments, for example, a deadline (e.g. 24 hours by default) may also be applied, so that any pages or contextuality that are in queue for 24 hours or more would move to the top of the queue. In some embodiments, any trigger in the queue longer than the deadline may be discarded (popped off the queue without being served to any ICE application/display module 272). In some embodiments, instead of a simple linear deterioration, the curve may decrease slowly at first and decrease more quickly near its deadline.

In some embodiments, the following formula may be used to determine queue behavior:

$$Rating = TriggerValue * ( 1 + \frac{Factor}{TimeInQuee - ( Deadline + Factor )} )$$

where
   Factor (default: 0)—this is a number adops (e.g., Administrator of SP logic module 470) can tweak to get the desired concavity on the curve.
   Deadline—in minutes (default: 1440)—the curve will decrease to zero (in rating) as time-in queue approaches deadline.
   TriggerValue (default: 1 for all triggers)—higher value implies higher rating

Global queue behavior module 460, in some embodiments, may operate to administer and control the behavior of the global queue. In some embodiments, contextual information residing in the global queue may be presented for display at a user application or terminal as set forth above. Application/per browser queue behavior module 462 may, in some embodiments, operate to control and/or administer the behavior of contextual information that is in the application queue or the per browser queue as set forth above.

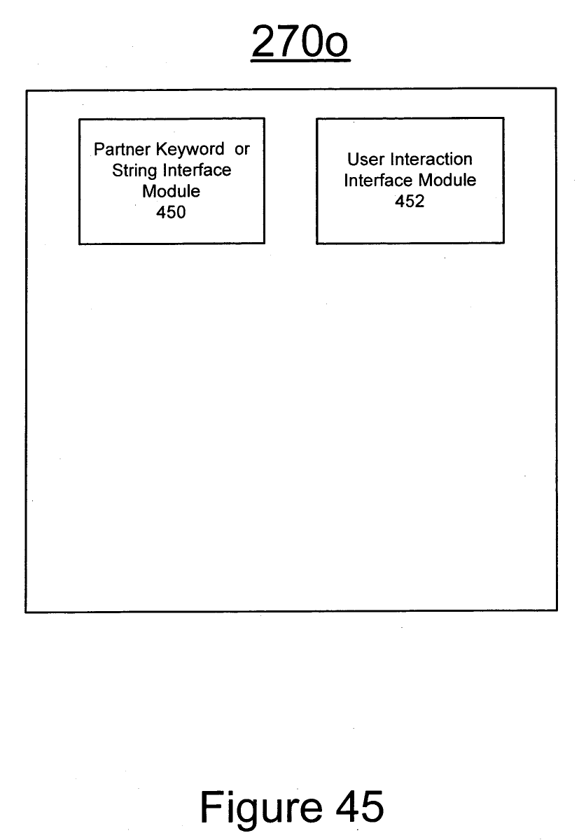

FIG. 45 depicts one embodiment of an external pull module 270o comprising a partner interface module 450 and a user interaction interface module 452. In some embodiments, it may be desirable to incorporate keywords or strings supplied by an application or program partner into a request for relevant contextual information. In some embodiments, such a keyword or string may be applied in all contextual analysis. That is, regardless of the user interaction with the network and the user interaction with an application, a particular keyword, term, phrase, string, token or concept may always be included in a request for contextual information sent to central control station 130 or sponsor or provider station 115.

For example, a partner operating an email reader may desire to display email related content any time a user interacts or interfaces with the email reader. In some embodiments, the partner may request that any interaction of the user with the application and/or network necessarily includes a key word equal “email”. This way, the keyword email may be considered every time a request is sent to central control station 130 or sponsor or provider station 115.

Partner keyword or string interface module 450 may, in some embodiments, operate to enable ICE module 270 to interact or interface with individual ICE application/display module 272, and more particularly to receive specific keywords or strings therefrom.

User interaction interface module 452 may, in some embodiments, incorporate keywords, terms, phrases, strings, tokens, or concepts received from partner keyword or string interface module 450 into a request to be submitted to a central control station 130 or sponsor or provider station 115 for relevant contextual information.

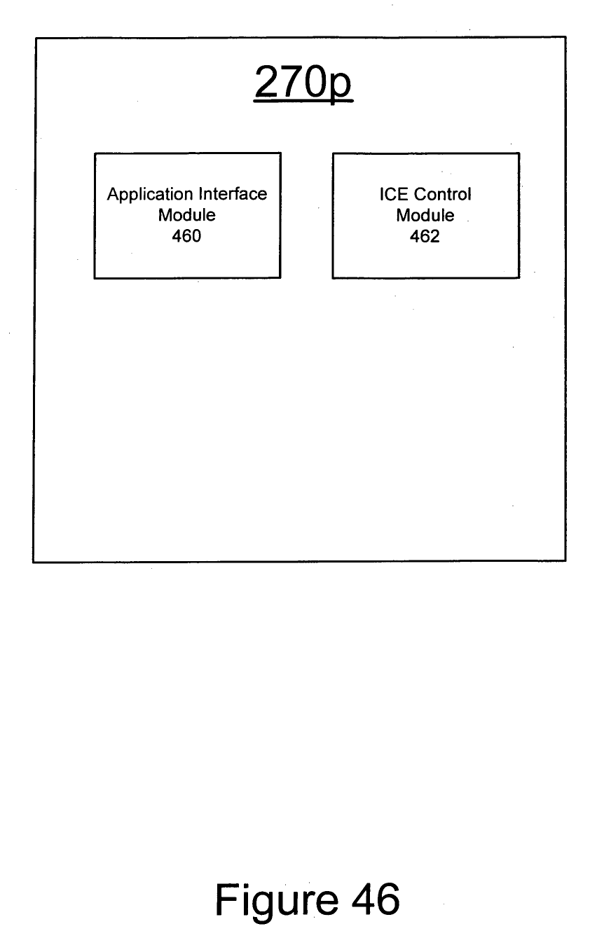

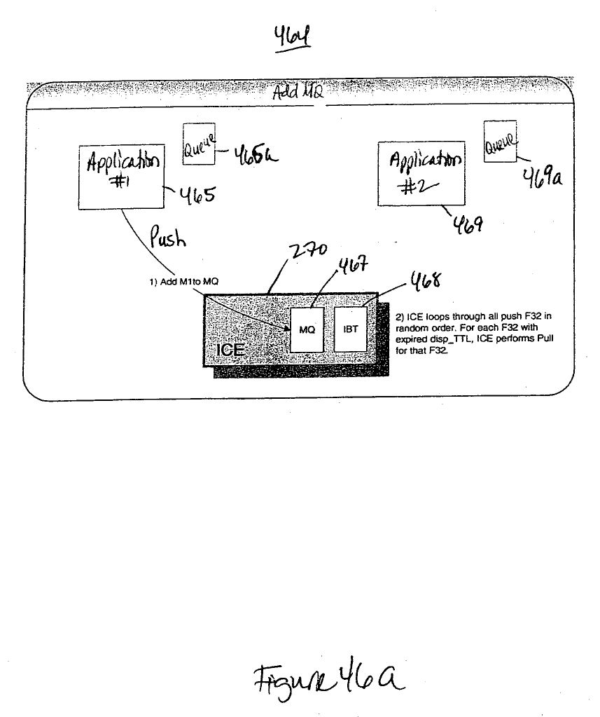

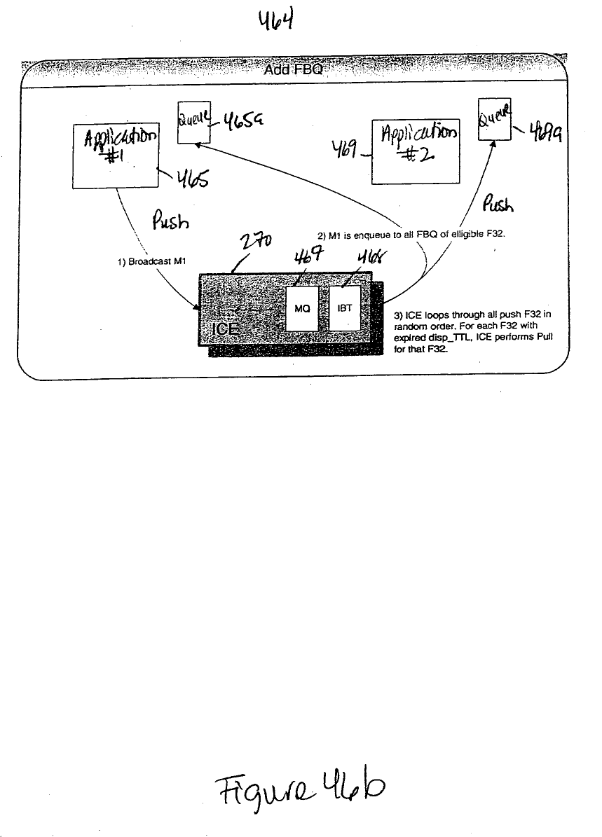

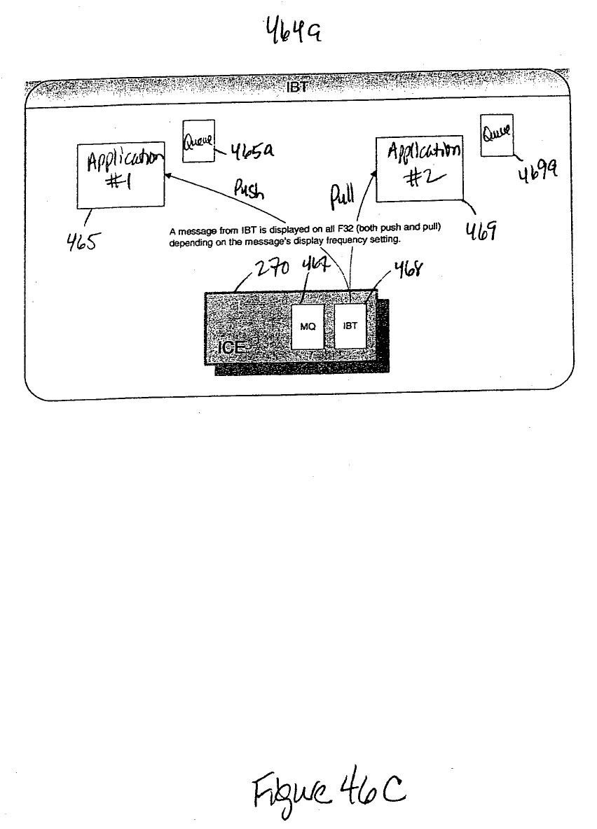

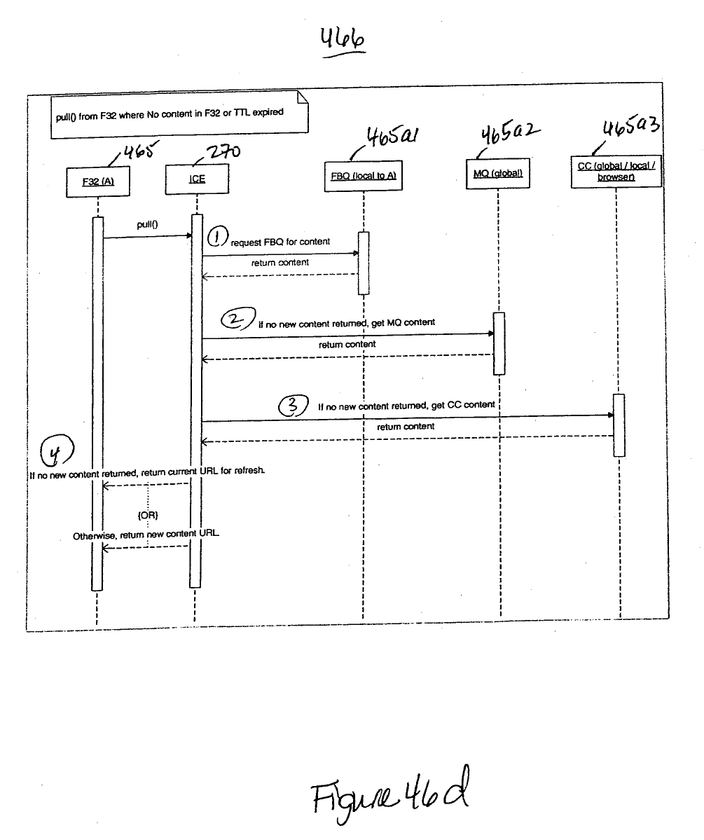

FIG. 46 depicts one embodiment of a message queue module 270p comprising an application interface module 460 and an ICE control module 462. In some embodiments, it may be desirable to enable an application or program that includes or is running an ICE application/display module 272 to communicate or broadcast messages to other applications or programs that are also running an ICE application/display module 272. For example, a weather-related web page or site currently running on the user's computer (an associated with an ICE application/display module 272) may communicate with or broadcast a message to another web page or site or application or program currently running on the user's computer or being viewed or used by the user. For example, the weather-related web page or site may broadcast a weather alert to the email reader that the user is currently interacting or interfacing with. Messages may be broadcast to all application, such as those that are currently running on the user's computer (whether opened or not), for example, or to select applications or programs only.

In some embodiments, an application or program associated with an ICE application/display module 272 may broadcast or receive several types of messages, which may include text or URL messages. In some embodiments, the following types of messages queues may be used to maintain corresponding messages:

Message queue (MQ)—a global message queue containing messages sent between applications or programs.

Application broadcast queue (FBQ)—a local message queue containing messages broadcasted to all applications or programs.

ICE broadcast queue (IBT)—a message queue containing messages originating from ICE module 270.

Contextuality content (CC)—contextual information which has been identified in response to a request for contextual information composed by any of the systems and methods described herein. CC information may be queued in either the global or browser queues, as discussed above, and in an application or program-specific queue that operates like the global queue, but only contains contextual information for display at the corresponding application or program. In some embodiments, the global, browser and application queues may have priorities as to which gets referred to first when an application is ready to pull content for display. For example, in some embodiments, an application or program may first reference the browser queue, if relevant, then the application queue, and finally the global queue. Other arrangements are possible. Similarly, the manner in which such queues are populated may also be priority based.

FIGS. 46a and 46b illustrate a process flow 464 of a first application 464 broadcasting a message MQ 467 to a second application 469. In some embodiments, the particular message (which may comprise of text or at least one URL) may be transmitted to the MQ of ICE module 270, as shown. ICE module 270 may then transfer the message to application 469, as shown in FIG. 46b. In some embodiments, the MQ messages within ICE module 270 may be sequentially or randomly distributed to the appropriate recipient application(s). In some embodiments, once received by the recipient application(s), a message may be queued in the appropriate queue (e.g., MQ, FBQ, IBT, or CC), as shown. For example, in some embodiments if the message was intended for a particular or select recipients, then it may be stored in the MQ of the select application(s). If the message is broadcast to all recipients, then it may be stored in FBQ of each applications. If the message comprises contextual information provided in response to a request, the message may be stored in CC. Other queue arrangements are possible.

FIG. 46c illustrates a process flow 464a of a first application 464 broadcasting a message IBT 468 from ICE module 270 to applications 465 and 469. In some embodiments, the particular message (which may comprise of text or at least one URL) may be transmitted directly to the appropriate, trumping any displayed information, as shown. In some embodiments, the message may be placed in queue at the applications.

FIG. 46d illustrates one embodiment of a process flow 466 indicating how an application or program 465, ICE module 270, and FBQ 465a1, MQ 465a2, and CC queue 465a3 may cooperate to determine which information to display to a user. As shown, the application or program 465 has either no content being displayed or the time for display of content being displayed (e.g., reading time) has expired. In some embodiments, the application or program 465 may request from ICE particular content for display (e.g., submit a pull( ) command). ICE module 270 may first check for content within the FBQ 465a1, a queue which is local to application or program 465. If content is found, it is delivered to application or program 465 for display. If not, ICE module 270 may refer to MQ content, as shown in 2. If content is found, it is delivered to application or program 465 for display. If not, ICE module 270 may refer to CC content (e.g., contextual information in the global, application, or browser queues). If content is found, it is delivered to application or program 465 for display. If not, then ICE may return/refresh the current information (e.g., URL) being displayed at the application or program 465, as shown at 4.

FIG. 46e illustrates a table 466a that shows a hierarchical ordering of messages IBT, FBQ, MQ and CC. As shown, IBT messages may have priority over all messages. That is, even if a message being displayed is still within its reading time, and regardless of whether the current message is IBT, FBQ, MQ or CC, an IBT message may nonetheless trump the message and be immediately displayed to the user. FBQ messages may have priority over all messages, except for IBT messages. MQ messages may have priority over MQ and CC messages, and CC messages have priority only over CC messages. Other priority arrangements are possible.

FIG. 46e also illustrates one embodiment of a process flow 466b indicating how an application or program 465, ICE module 270, and FBQ 465a1, MQ 465a2, and CC queue 465a3 may cooperate to determine which information to display to a user. As shown, the content being displayed at the application or program 465 has not expired. In some embodiments, the application or program 465 may request from ICE particular content for display (e.g., submit a pull( ) command). If the content currently being displayed at the application or program is MQ or CC, then ICE module 270 may check within the FBQ 465a1, a queue which is local to application or program 465. If content is found, it is delivered to application or program 465 to replace the current content being displayed, as shown in 1. If not, and the current content is CC, ICE module 270 may refer to MQ content, as shown in 2. If content is found, it is delivered to application or program 465 to replace the current content being displayed. If not, then ICE may return/refresh the current information (e.g., URL) being displayed at the application or program 465, as shown at 3.

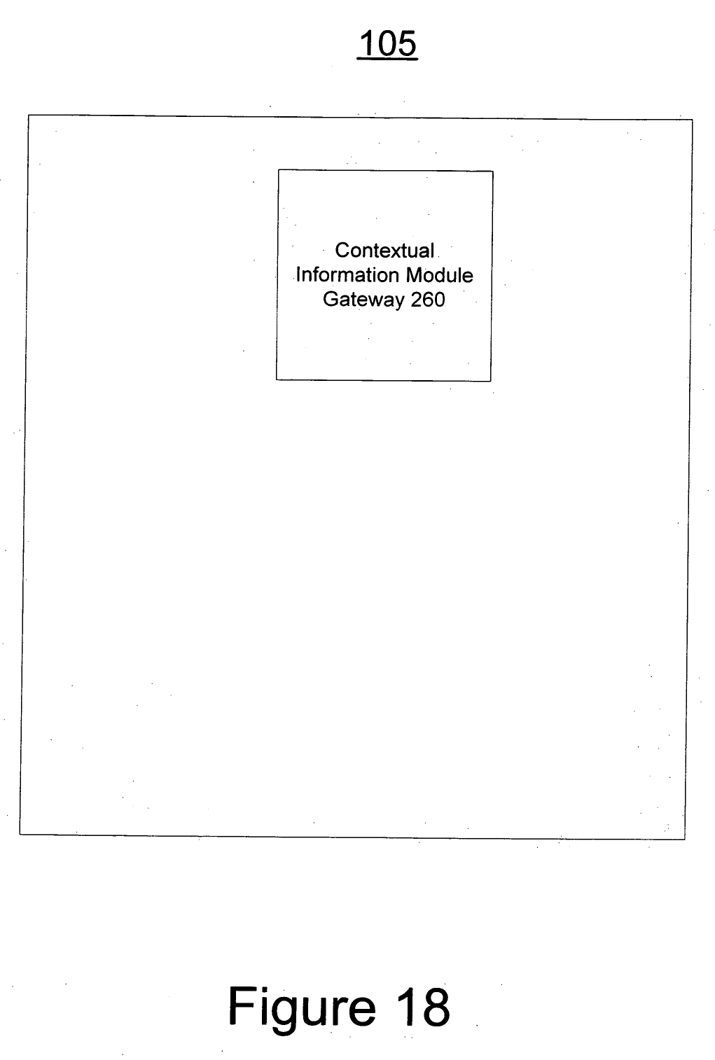

The various systems and methods described below in FIGS. 18-26 may, in some embodiments, be used in conjunction with the systems and methods disclosed and described below and in FIGS. 1-17c. In various embodiments, the systems and methods of FIGS. 18-26 may be used with other systems and methods for providing contextual information to a user.

FIG. 18 illustrates an exemplary contextual information gateway module 260 that may be associated with contextual information module 105 to enhance the various functions and features of the embodiments described herein. In some embodiments, contextual information gateway module 260 may reside on any of client stations 110 and may cooperate with any of the various features and described herein for providing contextual information. Contextual information gateway module 260 operates and performs its functions while protecting the personally identifiable information (PIT) of users, without in any way uniquely identifying any user or deriving any behavior that specifically identifies a user.

In some embodiments, contextual information gateway module 260 may enable a user—such as an administrator of system 100 shown in FIG. 1, for example—to enhance and refine the delivery of contextual information to a user/client station by determining whether the contextual information should be presented to the user/client station. In some embodiments, such a determination may be made based on the user's demonstrated interest, past online behavior, sessions particulars, and/or any other factors that may bear on whether a contextual information should be delivered or presented to the user. For example, the administrator may want to permit particular contextual information to be presented to the user based on the user's demonstrated interest, such as the number of times the user has visited a web site or page associated with the contextual information, the number of impressions the user has received, and/or the number of times the user has initiated (e.g., clicked) the particular contextual information, for example. In some embodiments, contextual information gateway module 260 may determine whether to deliver or present contextual information to the user while maintaining the user/client station's privacy and without using, accessing, obtaining, transmitting, deriving, or recording any personally identifiable information (PII).

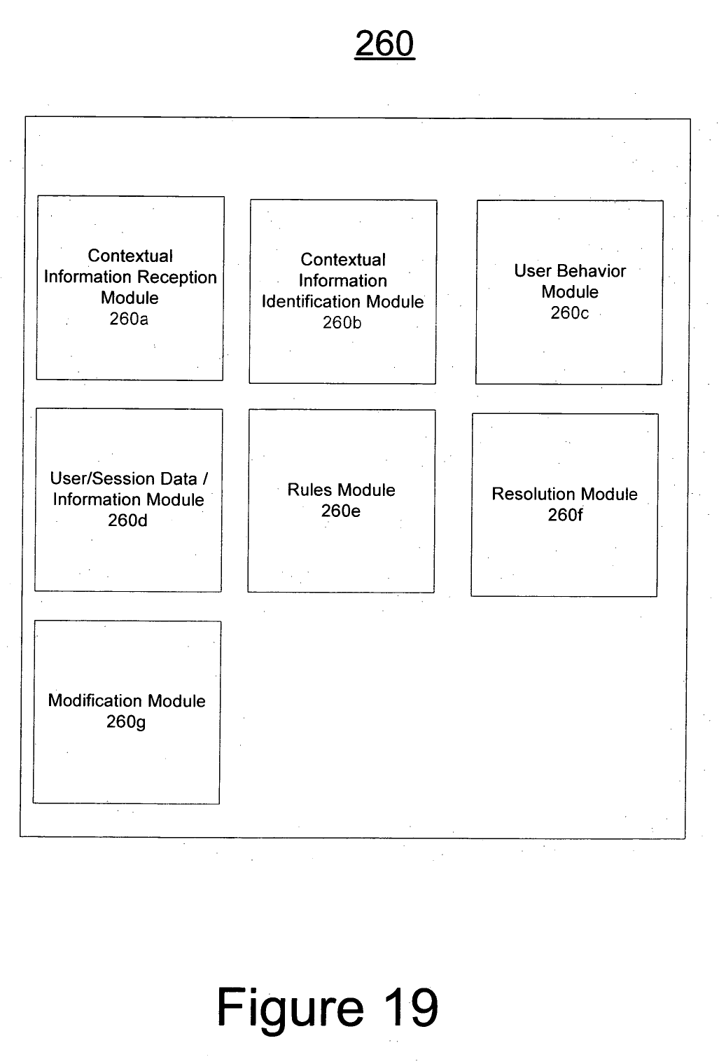

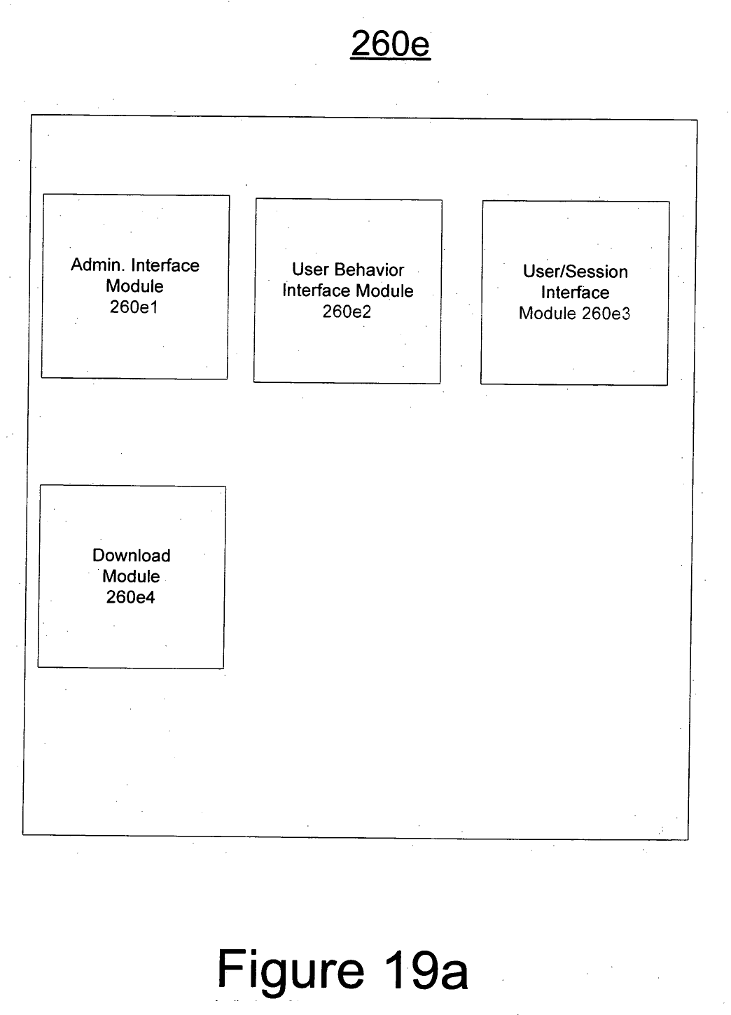

FIG. 19 depicts one embodiment of a contextual information gateway module 260 comprising a contextual information reception module 260a, a contextual information identification module 260b, a user behavior module 260c, a user/session data/information module 260d, a rules module 260e, a resolution module 260f, and a modification module 260g. Each is described below.

Contextual information reception module 260a may, in some embodiments, receive, locate and/or designate contextual information that is eligible to be presented to a user or client station. In some embodiments, eligible contextual information may comprise contextual information that may be presented to a user based on the user's demonstrated interest, behavior or activity, for example. In some embodiments, the eligibility of contextual information may be determined by the various systems and methods described below and in FIGS. 1-17c, for example. In some embodiments, eligibility may be based on or determined by the web sites or pages visited by the user, the uniform resource locators (URLs) visited or viewed by the user, search terms/phrases provided by the user, communications with third party(ies), and/or any other method or technique for selecting contextual information to present to a user.

In some embodiments, upon determining that particular contextual information is eligible for presentation, the contextual information may be made available to, presented to, or accessed by contextual information reception module 260a. In some embodiments, contextual information reception module 260a may initiate the process for determining whether to present the eligible contextual information to the user. For example, a user browsing the Internet may visit the web site for a particular retail store. In some embodiments, contextual information (one or various) that is relevant or related to the retail store may be identified as being eligible for presentation to the user, such as, for example, an advertisement for a particular product or service sold by the retail store, or a promotional incentive redeemable by the store (e.g., either online or in-store). Any number of contextual information may be eligible for presentation to the user, each of which may be determined, selected or identified according to any process, method or technique for identifying eligible contextual information, including but not limited to the systems and methods described herein.

Contextual information identification module 260b may, in some embodiments, identify particulars about the eligible contextual information. In some embodiments, contextual information identification module 260b may identify the name and/or or category of the eligible contextual information, such as, for example, that a particular advertisement relates to a particular product or service, or that a category of contextual information comprises advertisement, for example. In some embodiments, contextual information identification module 260b may also identify at least one rule associated with the eligible contextual information. For example, upon identifying the eligible contextual information as comprising an advertisement for a particular car, contextual information identification module 260b may determine that such ad is associated with a particular rule(s) that must be validated in order for the ad to be presented to the user.

User behavior module 260c may, in some embodiments, track, monitor, and/or store data and information regarding user online behavior and activity. Such data and information may comprise, for example, the user's online browsing history, the web site or pages the user has visited or viewed, the number of times a user has seen a particular contextual information, and the number of times a user has initiated a particular contextual information, for example. Other data and information may be tracked, monitored and stored. In some embodiments, data and information obtained by User behavior module 260c may be stored and maintained at client station 110, such as on a database associated with client station 110, for example.

User/session data/information module 260d may, in some embodiments, track, monitor, and/or store data and information related to the session and/or client station may also be tracked, such as, for example, the time the session was initiated and the location of the client station. Other session or client station data or information may be tracked, monitored and/or stored. In some embodiments, data and information obtained by user/session data/information module 260d may be stored and maintained at client station 110, such as on a database associated with client station 110, for example.

Rules module 260e may, in some embodiments, enable the creation, development, maintenance, and editing of rules used to determine whether contextual information may be presented to a user. In some embodiments, a rule may be composed, developed and/or revised by a system/network administrator. The administrator may, for example, interface with rules module 260e to construct the rules and modify them as necessary, such as by determining which factors or parameters to include, determining how such factors or parameters may be correlated, and determining associated or related contextual information. For example, a rule may specify that a particular advertisement may be shown only if the user has visited an associated web site or page at least twice within the past month, has seen the advertisement no more than once within the past week, and has not yet initiated (e.g., clicked) the advertisement. In some embodiments, a rule(s) may be stored at any number of client stations associated with the system/network so that data or information regarding a user's online behavior, session and/or station particulars, for example, may be resolved locally. While rules module 260e is shown in FIGS. 18 and 19 as residing in client station 110, it may, in some embodiments, reside at central control station 130. In such embodiments, rules may then be uploaded to individual client stations using a download/upload module (see FIG. 19a).

Resolution module 260f may, in some embodiments, resolve rule(s) associated with contextual information against data or information relating to a particular user(s), session(s), and/or client station(s). For example, resolution module 260f may determine and/or access data or information from user behavior module 260c and/or

Modification module 260g may, in some embodiments, modify contextual information before presentation to the user. In some embodiments, the various systems and methods described herein may determine that contextual information should be shown to the user, but in a modified format. For example, assume a particular promotional incentive (e.g., 10% rebate on a particular product) is queued-up to be presented to a user but a determination is made that the user has seen the incentive twice in the past month and has yet to initiate the incentive (e.g., click on the incentive). In some embodiments, the systems and methods of the invention may modify the promotional incentive to relate to a 20% rebate, for example. Modifications may comprise adding, deleing, and/or revising text and/or graphics on the contextual information and/or replacing or supplanting the contextual information with other contextual information. Other modifications are possible.

FIG. 19a illustrates one embodiment of a rules module 260e. As shown, rules module 260e may comprise an administration interface module 260e1, a user behavior interface module 260e2, a user/session interface module 260e3, and a download/update module 260e4. Each is described below.

Administration interface module 260e1 may, in some embodiments, enable a user, such as a system/network administrator (e.g., an administrator of system 100 who has access to central control station 130), for example, to perform the various features and functionality of rules module 260e. In those embodiments, where rules module 260e resides at client stations 110, administration interface module 260e1 may permit the user or administrator to locally or remotely create, develop, maintain, and/or edit rules. In those embodiments, where rules module 260e resides in central control station 130, administration interface module 260e1 may permit the administrator to locally create, develop, maintain, and/or edit rules.

User behavior interface module 260e2 may, in some embodiments, permit a user or administrator to interface with data and information that is tracked, monitored, and/or stored by user behavior module 260c. Similarly, user/session interface module 260e3 may, in some embodiments, permit a user or administrator to interface with data and information that is tracked, monitored, and/or stored by user/session data/information module 260d. In some embodiments, personally identifiable information (PII) of the user and or client station is protected so that unauthorized access (including improper access by the administrator) is prohibited.

Download/upload module 260e4 may, in some embodiments, enable the downloading to and/or uploading from client station 110 of data and information used by gateway module 260 to determine whether contextual information may be presented to a user. In some embodiments, download/upload module 260e4 may provide downloads/uploads of particular rules used in determining whether contextual information should be delivered to a user. For example, such rules may be updated periodically, according to a predetermined schedule, or upon the request of either a user of client station 110 or an administrator of system 100 described below, for example.

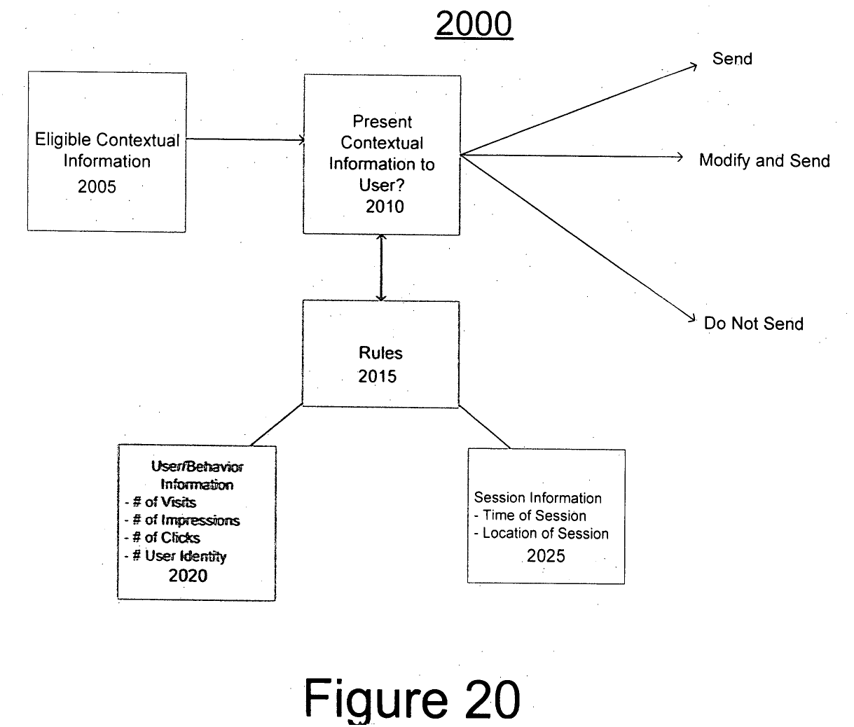

FIG. 20 illustrates one embodiment of a process flow for determining whether contextual information should be presented to the user (e.g, send as is; modify and send; or do not send). As shown in 2005, particular contextual information (e.g. online advertisement) may be eligible for presentment to a user of client station 110 that is browsing a network, such as the Internet, for example. At 2010, a determination is made as to whether to present the contextual information to a user. In some embodiments, such a determination is made in several steps. First, as shown in 2015, rules associated with the online advertisement may be identified in order to determine scenarios where presentation may occur. In some embodiments, such rules may be stored at client station, and may be accessed as needed. As shown in 2020 and 2025, the rules for determining presentation may, in some embodiments, comprise or correlate various user behavior information (2020) and session and station information (2025). In some embodiments, user behavior information may comprise, for example, the user's online browsing history, the web site or pages the user has visited or viewed, the number of times a user has seen a particular contextual information, and/or the number of times a user has initiated a particular contextual information, for example. Other user behavior data and information may be used. Session and station information may comprise the time the session was initiated and the location of the client station, for example. Other session or station data or information may be used.

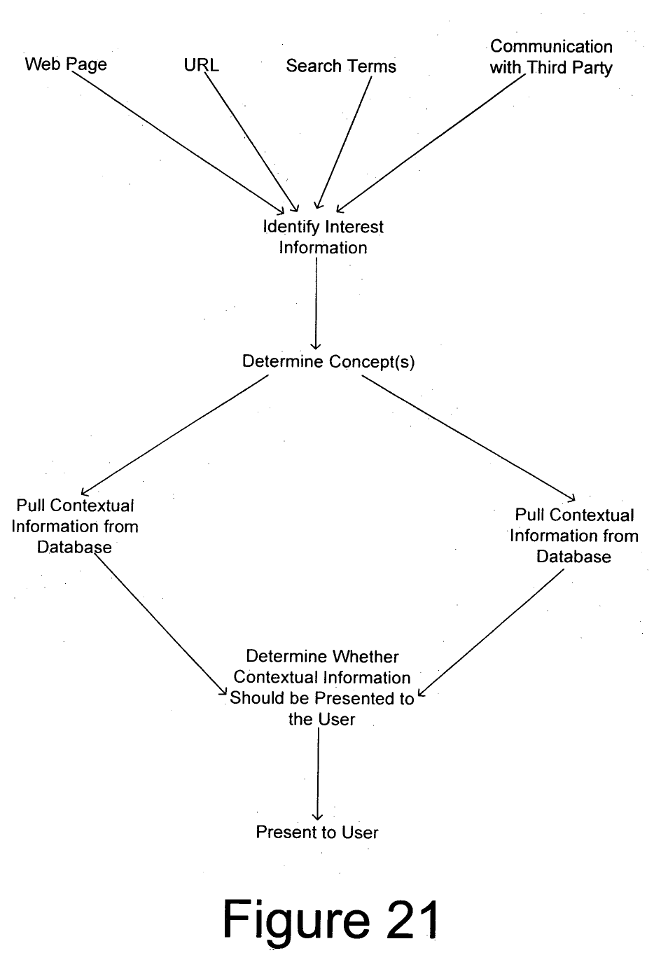

FIG. 21 illustrates the overall process flow 2100 of another embodiment of the invention using the methods described above and in FIGS. 1-17c. As shown, the monitoring of a user's interaction with a network comprises monitoring URLs visited by the user, the content of web sites or pages visited by the user, and/or the search terms or phrases used by the user to conduct online searches, and/or communications with third party(ies). By monitoring the user's interaction, interest information may be extracted which indicates the user's interest, focus or purpose for browsing the network or Internet, for example. In the case of URLs, the URLs may comprise the interest information. In the case of search terms or phrases, the terms or phrases may comprise the interest information. In the case of web site or page content, the interest information may comprise the identity of various keywords that appear throughout the site or page.

Once the interest information is extracted, at least one concept may be determined. Identified URLs and search terms or phrases, for example, may have corresponding concepts that may be used to identify contextual information related to the URLs and search terms or phrases. Regarding the content of a web site or page content, the concept(s) may be determined according to satisfied or validated rules, as discussed above.

Once the concept(s) is/are determined, contextual information may be provided from a database, or from a third party sponsor or provider. In some embodiments, retrieving contextual information from a sponsor or partner or designated site may comprise transmitting information to the third party sponsor or provider to enable the provision of the contextual information. Such information may comprise, for example, select concept(s) or other token(s) that enable particular identification of contextual information. Once obtained, a determination may be made as to whether the contextual information may be presented to the user (such determination may be made as set forth above). If so, the contextual information may be presented to the user.

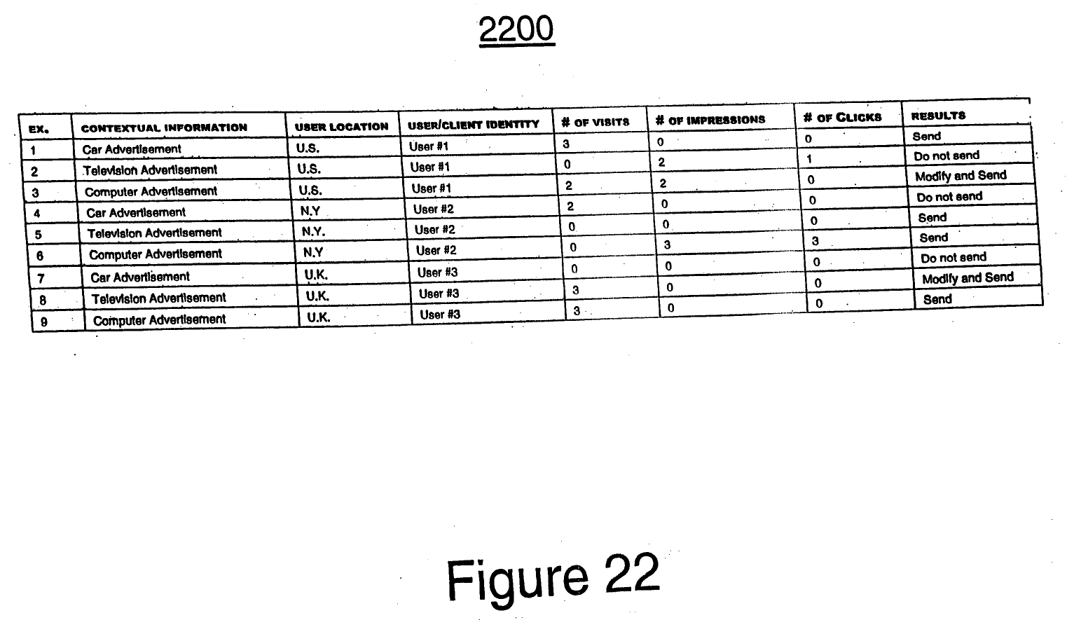

FIG. 22 illustrates a table 2200 which sets forth various examples of hypothetical parameter sets that comprise an embodiment of the data and information used by the various systems and methods described herein. As shown, table 2200 includes the following columns/parameters: contextual information; user location; user/client identity; number of visits; number of impressions; number of clicks; and results. In some embodiments, the for contextual information, user location, user/client identity, number of visits, number of impressions, and number of clicks parameters may be tracked, monitored, and/or stored as set forth above. The data comprises the online history of three user's: user # 1, user #2, and user #3, with regarding to three advertisements: a car ad, a television ad, and a computer ad.

Shown below is Table A which shows the particular correlation between the three ads (e.g., the car, television and computer ads) and associated rules for determining whether the ad may be presented:

TABLE A

| Advertisement | Presentation Rules |
|---|---|
| Car Ad | Only if visits greater than 2 and no |
| | impressions and/or clicks. |
| | Only to users/stations in the United States. |
| Television Ad | Do not send if user has already seen the |
| | ad. |
| | In U.S., only to users in the northeastern |
| | region (e.g., ME, VT, CT, MA, NJ, NY). |
| | Foreign countries O.K. to send with |
| | appropriate modification(s). |
| Computer Ad | O.K. to send to users that have seen the ad, |
| | but with appropriate modification(s), unless |
| | N.Y, where modification not required. |
| | O.K. to send to foreign users without |
| | modification. |

The data in table 2200 of FIG. 22 may be resolved against the above rules to demonstrate the various features and functionality of the invention. Each example will be described below:

User #1

Example 1—The car ad is presented to the user #1 because there have been more than two (2) visits and the user/station is located in the U.S.

Example 2—The television ad is not sent because user #1 has already seen the ad.

Example 3—The computer ad is sent to in modified form because user #1 has already seen the ad. For example, if the computer ad offers a rebate of 10% on purchases by a certain date, the modified ad might offer a 15% rebate. Other modifications are of course possible.

User #2

Example 4—The car is not presented because user #2 has not visited an associated web site or page more than twice.

Example 5—The television ad is sent because user #2/station is located in the northeastern region of the U.S.

Example 6—The computer ad is sent to user #2 because no restrictions are in place. No need to modify because the user has not previously seen the ad.

User #3

Example 7—The car ad is not presented because user #3/station is not located in the U.S.

Example 8—The television ad is sent in modified form because user #3/station is located in a foreign country. In some embodiments, the modification may comprise, for example, changing the currency to correspond with the foreign country (e.g., dollars to pounds). Other modifications are of course possible.

Example 9—The computer ad is presented without modification because user #3/station is located in a foreign country.

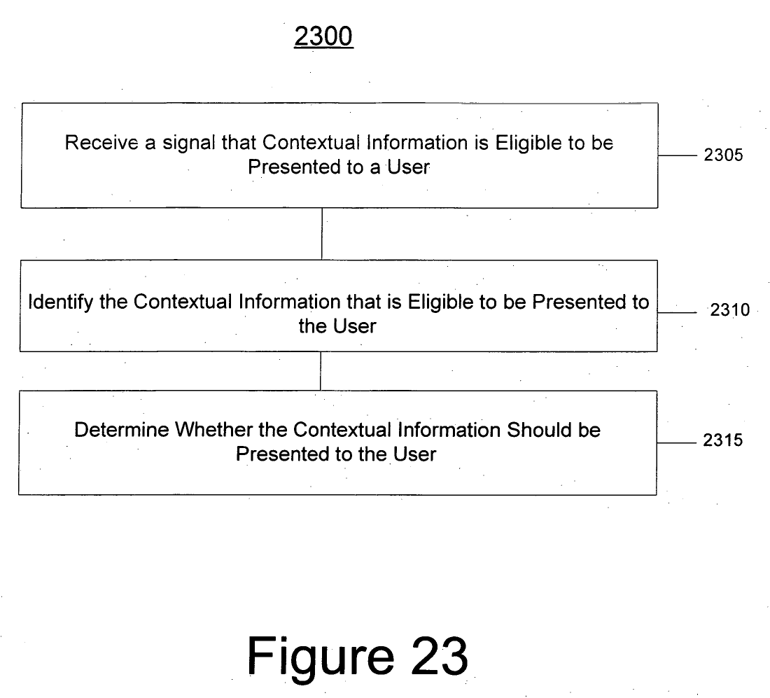

FIG. 23 illustrates a method 2300 for determining whether contextual information may be presented to a user, according to one embodiment of the invention. At step 2305, contextual information module 105 (or contextual information gateway module 260) may receive a signal that contextual information is eligible to be presented to the user. For example, the user may visit a web site or page of a popular car manufacture. This activity/behavior may result in a particular advertisement being designated as eligible for presentation to the user. At step 2310, contextual information module 105 (or contextual information identification module 260) may identify particulars of the ad, such as it's identity and/or rules associated with the ad for determining whether the ad should be presented to a user. At step 2315, a determination is made as to whether the ad should be presented to the user. In some embodiments, such a determination may be made by resolving rules associated with the ad against data and information about the user's online activities or behavior, and/or particulars about a session and/or station. Other data and information may be used.

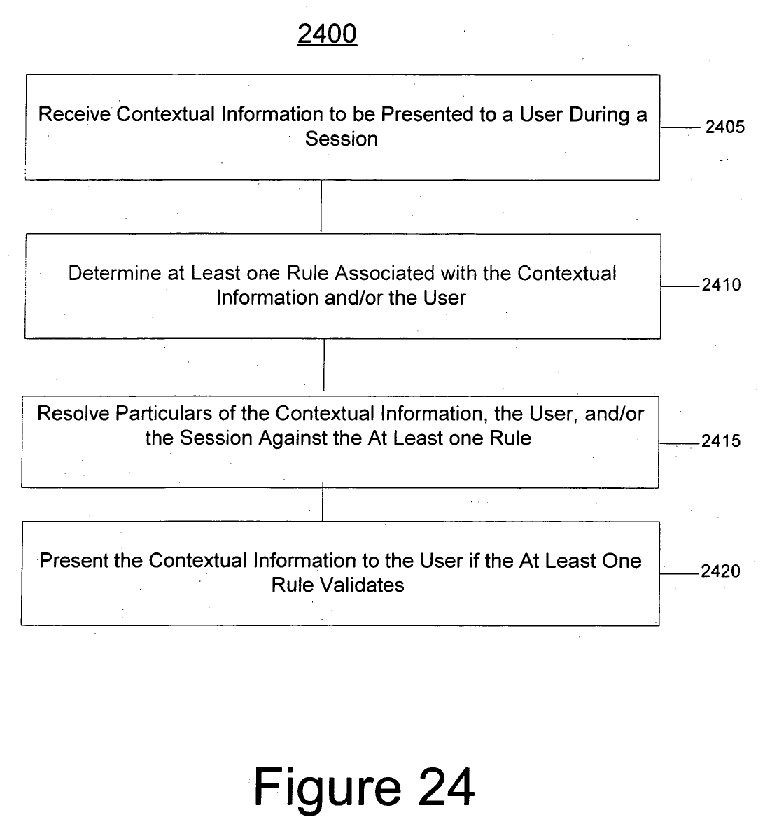

FIG. 24 illustrates a method 2400 for determining whether contextual information may be presented to a user, according to one embodiment of the invention. At step 2405, contextual information that is eligible to be presented to a user may be retrieved or received. At step 2410, at least one rule associated with the eligible contextual information and/or the user is determined. In some embodiments, rules are associated with particular contextual information, while in some embodiments they are associated with users and/or stations. At step 2415, particulars of the contextual information, user and/or station, and/or the session are resolved against the at least one rule. At step 2420, the contextual information is presented to the user if at least one rule validates. In some embodiments, the contextual information may be presented in modified form.

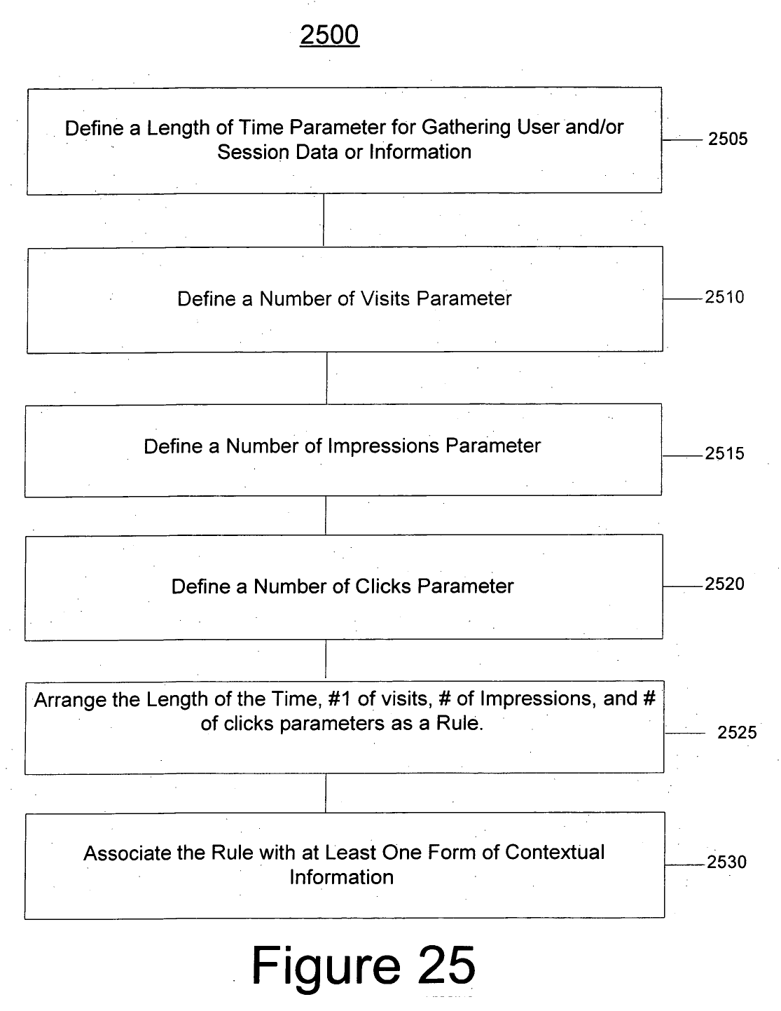

FIG. 25 illustrates a method 2500 for constructing or defining at least one rule for determining whether contextual information may be presented to a user. In some embodiments, method 2500 may be performed by a system administrator, while in some embodiments it may be performed by any user, such as a user of client station 110, for example. At step 2505, a length of time parameter for gathering user, session, station data, or any other type of data or information used to determine whether contextual information may be presented. For example, a user may wish to track, monitor and/or store data and information for a predetermined period of time, such as over a one week period, for example. In such a situation only data that a week old or less is used to determine whether contextual information should be presented. At step 2510, a number of visits parameters may be defined. For example, a user or administrator may want to show contextual information only if the user has visited an associated web site or page a predetermined number of times.

At step 2515, a number of impressions may be defined. For example, a user or administrator may not want to present contextual information that has already been seen by the user a predetermined period of time. At step 2520, a user or administrator may define a number of clicks parameters, which may be used to prevent the presentation of contextual information that a user has previously initiated a predetermined number of times, for example. At step 2525, the time, number of visits, number of impressions, and number of click parameters are arranged as a rule. In some embodiments, the time, number of visits, number of impressions, and number of click parameters may be correlated as necessary to ensure presentation at desired times or under specific circumstances. At step 2530, the rule may be associated with particular contextual information, user(s), and/or station(s).

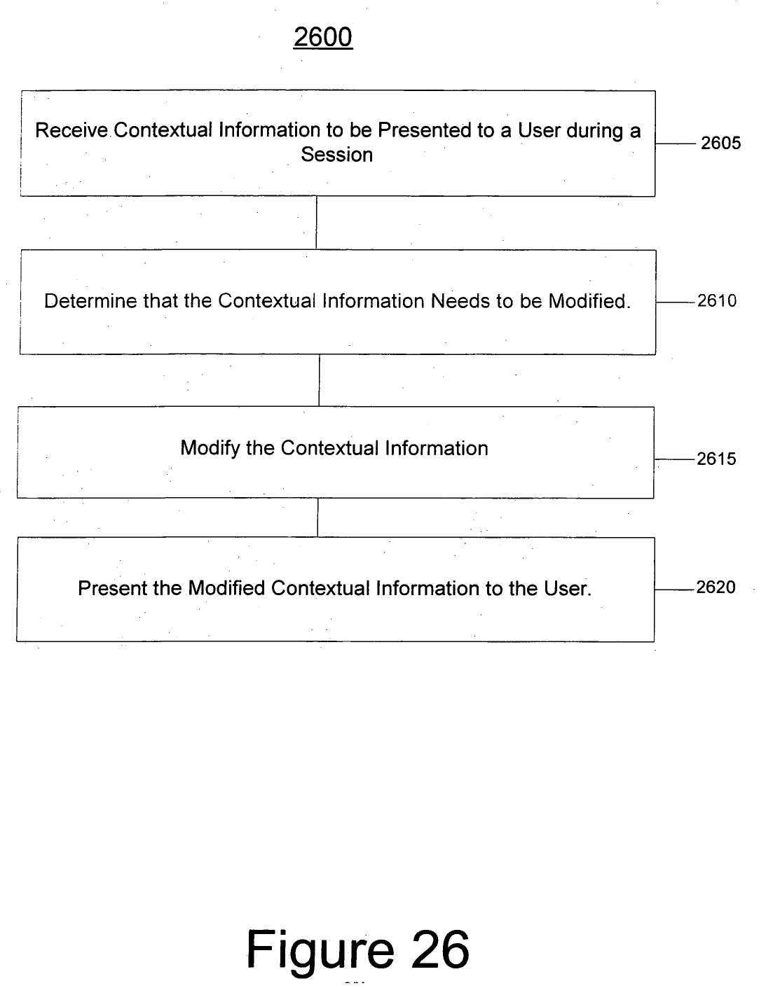

FIG. 26 illustrates one embodiment of a method 2600 for determining whether contextual information should be presented to a user, according to one embodiment of the invention. At step 2605, contextual information eligible to be presented to a user is received or retrieved. At step 2610, a determination is made as to whether the contextual information needs to be modified. In some embodiments, modification is determined by resolving a rule against data and information about a user, station, and/or session. If the rule validates, then contextual information may be modified as necessary to permit presentation. At step 2615, the contextual information may be modified. At step 2620, the modified contextual information is presented to the user.

The following discloses and describes the systems and methods shown in FIGS. 1-17c, which in some embodiments may be used in conjunction with the systems and methods disclosed and described above and in FIGS. 18-26.

The various embodiments disclosed herein comprise systems and methods that enable the provision of contextual information in a responsive and efficient manner. According to some embodiments of the invention, a software module programmed to operate according to a predetermined algorithm may monitor user interaction with the Internet, or other network, for example, to ascertain information of interest to the user. In some embodiments, such monitoring comprises monitoring user input to determine particular areas of interest or focus. For example, the software module might identify or extract information from the particular uniform resource locater (or URL) of the web page or site a user is visiting or has visited, or extract certain keywords or concepts from the web site(s) or page(s) (e.g., HTML layout or metatags) the user is viewing or has viewed. Information may also be extracted from the keyword(s) or phrases the user uses to conduct an online search, such as through an online search engine, for example, or to provide or request information from a sponsor or provider, for example. In some embodiments, the URL (or information obtained therefrom), information extracted from the web site or page, or information extracted from a user search may be applied against at least one rule that may determine or identify a specific form of contextual information (e.g., advertisement), a specific category of contextual information, and/or at least one concept representative of at least one form of contextual information complying with various parameters.

In some embodiments, at least one concept scheme may be applied to the user interest information. Each concept scheme may comprise at least one rule resolved against one or more parameter sets from a plurality of parameter sets associated with the at least one rule. Each concept scheme may be associated with or correspond to a particular concept that targets particular contextual information to be delivered (either by a category or by a specific item of information). A rule may have a predetermined number of variables that correspond to particular parameter values (e.g., arranged in a table). For example, the rule “3 times Model, and 4 times Make” may correspond to the following parameter table:

| 27 | Make | Token |
|---|---|---|
| Lexus | RX300 | SUV |
| Volkswagen | Touareg | SUV |
| Acura | MDX | SUV |

In this example, there are three (3) different combinations of parameter values within the same concept scheme: (1) 3 times Lexus, 4 times RX300, (2) 3 times Volkswagen, 4 times Touareg, and (3) 3 times Acura, 4 times MDX. In various embodiments of the invention, each of these combinations may be applied to information extracted or identified by monitoring a user's interaction with a network. For example, the content of a web site or page the user is viewing, or the terms a user provides to conduct a search or to request or provide information, may be assessed under each of the contextual information schemes. If a web site or page validates any of the combinations for a concept scheme—e.g. Volkswagen appears three (3) times and Touareg appears four (4) times—then the concept scheme may be validated and used to target contextual information that may then be provided to the user. In some embodiments, a rule(s) may assess keyword nearness, such as keyword1 must be within a predetermined number of words from keyword2, for example. In various embodiments, a rule(s) may assess keyword ordering, such as keyword1 must be found before/after keyword2, for example. Other rules are of course possible.

In some embodiments, tokens associated with a validated concept scheme, for example, may be used to target contextual information relating to the user's interaction with a network. In the above example, the token SUV may be used to obtain contextual information relating to SUV's in general or to obtain information about competing SUV's, for example. Tokens may be used to obtain contextual information from a database, or transmitted to a third party for generation and provision of relevant contextual information. Tokens may comprise any information (e.g., term, phrase, word, digits) that may identify define, particularize, broaden or narrow targeted contextual information.

Contextual information may comprise any information related to the user's interaction with the network. For example, assume a user is browsing a web site or page related to digital cameras and that the URL, content of the web site or page visited, and/or search terms entered, indicate that the user is interested in a digital camera of a particular make and model. An embodiment may provide the user with specific advertising, promotional information, incentive programs, or any other information related to the particular digital camera, such as advertising of stores or web sites were the user may purchase the camera, coupons or discounts currently available, or connect the user to a check-out page(s) of a sponsor or program partner offering the camera for purchase, for example. In some embodiments, check-out page(s) may, with the user's permission, be pre-populated with user information (name, address and payment information) so that the user may readily initiate purchase, for example.

In some embodiments, the contextual information provided may originate from a database affiliated with or operated by the entity that operates the concept scheme validation. In various embodiments the contextual information may be obtained from third party entities, such as from the web site or page, network, and/or database of a sponsor or program partner, for example. Thus, in the digital camera example discussed above, the concept determination system may send the make, model, the keywords “digital camera,” and/or any other information that may identify relevant contextual information, for example, to any number of third party web sites, to obtain such relevant contextual information to present to the user.

According to various embodiments, contextual information provided to the user may be provided via a web page that appears on the user's screen, for example. The contextual information may be appear behind pages the user is currently viewing, or may be presented prominently on the user's screen. In some embodiments, the user may be alerted that the contextual information has been provided, such as by sounding a distinctive tone or ring.

FIG. 1 illustrates a system 100 for providing contextual information according to one embodiment of the invention. System 100 may comprise a contextual information module 105 which may operate on a client station 110, which in turn may connect to or communicate with any number of other stations (e.g., client stations 110, central command station 130, and/or sponsor or provider stations 115) through any number of communication networks, such as communication networks 120, for example. In some embodiments, contextual information module 105 may be installed as part of a user's client station 110 to provide contextual information relevant to the user's interaction with communication network 120. Such contextual information may comprise advertising, promotion or incentive information, or any other type of information relevant to the user's interaction over the network.

According to various embodiments, contextual information module 105 may host one or various modules that operate to perform the various steps and functions of the claimed invention, such as monitoring user interaction with a network, and the identification of corresponding concept(s) that are identified to serve contextual information to the user. In some embodiments, such module(s) may be hosted by contextual information module 105, in which case the user's interaction over a network would be monitored locally, while in other embodiments, the module(s) may operate over a network so that such monitoring may be done remotely.

According to various embodiments, client station 110 may comprise a typical home or personal computer system whereby a user may interact with a network, such as the Internet, for example. Client station 110 may comprise or include, for instance, a personal or laptop computer. Client station 110 may include a microprocessor, a microcontroller or other general or special purpose device operating under programmed control. Client station 110 may further include an electronic memory such as a random access memory (RAM) or electronically programmable read only memory (EPROM), a storage such as a hard drive, a CDROM or a rewritable CDROM or another magnetic, optical or other media, and other associated components connected over an electronic bus, as will be appreciated by persons skilled in the art. Client station 110 may be equipped with an integral or connectable cathode ray tube (CRT), a liquid crystal display (LCD), electroluminescent display, a light emitting diode (LED) or another display screen, panel or device for viewing and manipulating files, data and other resources, for instance using a graphical user interface (GUI) or a command line interface (CLI). Client station 110 may also include a network-enabled appliance, a browser-equipped or other network-enabled cellular telephone, or another TCP/IP client or other device.

Client station 110 may be utilized by a user to browse a network, make online purchases, and/or simply conduct online searches, such as through a search engine or site, for example. User interaction with the network through client station 110 may be monitored by contextual information module 105 to determine information on the user's interest or focus. In some embodiments, such information may comprise uniform resource locators (URLs), web site or page content, and/or search terms used by the user to initiate online searches.

Sponsor or provider stations 115 may comprise any sponsor or provider of contextual information capable of being provided to a user. In some embodiments, sponsor or provider stations 115 may comprise a web site or page that may be populated and presented to the user with relevant contextual information. For example, if a user expresses interest in a particular product, the appropriate sponsors or providers may be called upon to provide a pre-populated “check-out” page for the product, or any other relevant contextual information. In some embodiments, contextual information module 105 may identify one or more concept(s) corresponding to the user's interaction with the network, and provide the sponsor provider with a request that is based on the particular concept(s).

Central control station 130 may enable administration of the contextual information module 105 on the user's computers. In some embodiments, central command station 130 may determine or set concept schemes that are downloaded to client stations 105 or resolved at central control station 130. Downloading of contextual information module 105 to a client station 110, for example, may occur periodically, or as needed, such as in response to an update of any number of concept schemes, contextual information, or other information, for example.

Central command station 130 may comprise a single server or engine. In some embodiments, central command station 130 may comprise a plurality of servers or engines, dedicated or otherwise, which may further host modules for performing desired system features and functionality. Central command station 130, for example, may host or download to client stations 110 one or more applications or modules that function to permit interaction between contextual information module 105, client stations 110 and sponsor or provider stations 115 as it relates to the transmission of keywords and contextual information, for example. Central command station 130 may download to client stations 110 modules that enable contextual information module 105 to receive information or data for storage in database 140, for example.

Central command station 130 may include an administration module for an agent of central command station 130, for example, to input information related to concept schemes, including but not limited to contextual information corresponding to concept(s)/keyword(s) and/or rules for determining whether a concept is to be designated, e.g., used to identify particular contextual information to present to the user. According to various embodiments, an agent of central control station 130 may interface with a graphical user interface (or GUI) to input: (1) terms, words, phrases, digits, tokens and/or concepts that the one or more contextual information modules 105 look for in monitoring user interaction over a network and/or provide in targeting contextual information, (2) the particular contextual information to be targeted by particular keywords/concepts/tokens, (3) URL's and/or search terms or phrases, for example, used to designate particular concepts/keywords, and (4) rules and corresponding parameters and parameter sets used to assess user interaction over a network and to identify particular concept(s)/keyword(s). An agent of command control station 130 may also input information relating to information or data regarding the contextual information that may be stored in a database 140, for example. Other modules are possible (See FIGS. 2 and 2a). The features of functionality described herein may be performed by central command station 130 via a single module or set of modules.

Contextual information maintained by central command station 130 may be stored and cataloged in database 140 which may be or interface with a searchable database. Database 140 may comprise, include or interface to a relational database. Other databases, such as a query format database, a Standard Query Language (SQL) format database, a storage area network (SAN), or another similar data storage device, query format, platform or resource may be used. Database 140 may comprise a single database or a collection of databases, dedicated or otherwise. In one embodiment, database 140 may store or cooperate with other databases to store contextual information described herein.

Communications network 120 may comprise any type of communication network such as one able to transmit and receive data or information relating to any number of trade transactions, such as product, good or service information and/or price information, for example. Communications network 120 may be comprised of, or may interface to any one or more of, the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1 or E3 line, a Digital Data Service (DDS) connection, a Digital Subscriber Line (DSL) connection, an Ethernet connection, an Integrated Services Digital Network (ISDN) line, a dial-up port such as a V.90, a V.34 or a V.34bis analog modem connection, a cable modem, an Asynchronous Transfer Mode (ATM) connection, a Fiber Distributed Data Interface (FDDI) connection, or a Copper Distributed Data Interface (CDDI) connection. Communications network 120 may also comprise, include or interface to any one or more of a Wireless Application Protocol (WAP) link, a General Packet Radio Service (GPRS) link, a Global System for Mobile Communication (GSM) link, a Code Division Multiple Access (CDMA) link or a Time Division Multiple Access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based radio frequency link. Communications network 120 may further comprise, include or interface to any one or more of an RS-232 serial connection, an IEEE-1394 (Firewire) connection, a Fibre Channel connection, an infrared (IrDA) port, a Small Computer Systems Interface (SCSI) connection, a Universal Serial Bus (USB) connection or another wired or wireless, digital or analog interface or connection.

In some embodiments, communication network 120 may comprise a satellite communications network, such as a direct broadcast communication system (DBS) having the requisite number of dishes, satellites and transmitter/receiver boxes, for example. Communications network 120 may also comprise a telephone communications network, such as the Public Switched Telephone Network (PSTN). In another embodiment, communication network 120 may comprise a Personal Branch Exchange (PBX), which may further connect to the PSTN.

FIG. 2 illustrates exemplary modules that may be associated with contextual information module 105 for carrying out (or administering) the various functions and features of the embodiments described herein. In some embodiments, the modules may: (1) be accessed by an agent of central command station 130, (2) monitor the activities of a user interfacing with client station 110, and/or (3) coordinate with central command station 130 and/or sponsor or provider station 115 the identification and presentation of contextual information to a user of client station 110. While the modules may not be used in all embodiments to perform some or all of the functions of the present invention, they are nonetheless presented as possible embodiments:

User interaction module 200 may monitor user interaction with a network using client stations 110, for example. By monitoring user interaction, user interaction module 200 may determine or identify the user's particular interests or areas of focus. Thus, a user browsing the Internet, for example, may be viewing web sites or pages relating to new and used cars the user is interested in purchasing. User interaction module may refer to the uniform resource locators (URLs) of the web pages or sites visited by the user to determine that the user is interested in buying a car. For example, a user's history of web pages or sites may read as follow: www.carsdirect.com, www.cars.com, www.autotrader.com, and www.vw.com. User interaction module 200 may use this information to determine that the user is interested in purchasing a car.

In some embodiments, user interaction module 200 may refer to the content of the web pages or sites visited by the user. For example, user interaction module 200 may extract information from the HTML layout of the various web pages or sites visiting, including the various metatags that may appear on the pages or sites. Thus, if the various pages indicate repeated use of particular terms such as automobile, engine, two-door, sedan, for example, or include metatags such as www.cars.com, www.autotrader.com, and www.vw.com, user interaction module can determine the user is interested in purchasing a car.

In some embodiments, user interaction module 200 may also refer to search terms used by the user to conduct on an online search or to provide or request information. For example, a user may use a search engine to conduct a search for new and used car deals by using terms such as “new,” “used,” “car,” and “deals,” for example. User interaction module 200 may refer to these terms and determine that the user is interested in purchasing a car. Likewise, user interaction module 200 may monitor user interaction with a sponsor or provider. For example, a user interacting with a web site or page of a particular airline, for example, may transmit (e.g., populate the airline's web site or page) particular request information, such as information requesting information about flights between New York and Orlando, for example. The information may be intercepted and, in some embodiments, converted to any number of words, terms, phrases, digits, or concepts, for example, that serve identify the information.

Concept identification module 205 may determine or identify at least one concept based on user interaction information provided by user interaction module 200. In some embodiments, the concept may be used to determine the contextual information to be provided the user by contextual information module 105, for example. In various embodiments, concept identification module 205 may compare the information provided by user interaction module 200 to a plurality of rules and/or concept schemes associated with a plurality of concepts. Concepts, and/or other information such as tokens, that correspond to rules and/or schemes that are satisfied may be designated or used to obtain particular contextual information for transmission to the user.

Contextual information input module 210 may generate and/or designate particular contextual information to provide the user based on the concepts identified by the concept identification module 205. In some embodiments, contextual information may be stored in database 140, in which case contextual information input module 210 pulls all corresponding contextual information from database 140 and presents it to the user. In some embodiments, contextual information may be received from a sponsor or provider in response to transmitting the keyword(s), concept(s), URL(s), token(s) or any other appropriate information to the sponsor or provider. In either case, the concept(s), keyword(s), URL(s), token(s) or other information is/are used to identify contextual information to provide the user. In various embodiments, a sponsor or provider may be transmitted a GET or POST instruction(s) containing particular information about the user, and/or his or her interaction with the Internet, for example, in order to personalize the contextual information received. For example, the GET or POST instruction(s) may include the user's name, address, payment information, and/or interest information that the sponsor or provider may use to generate and deliver personalized contextual information.

Sponsor or provider interface module 220 may interface with various sponsors or providers of contextual information. In some embodiments, sponsor or provider interface module 220 may transmit keyword(s), concept(s), URL(s), token(s), GET or POST commands, or any other appropriate information to a sponsor or provider for identification of contextual information to provide the user. In some embodiments, contextual information obtained from a sponsor or provider comprises a web page from the sponsor or provider providing information relevant to the user's interaction over the network. Thus, if the user is browsing for a particular digital camera, contextual information from the sponsor or provider may comprise a web page offering the user the particular digital camera or a competing or comparable camera. The web page may, with the user's permission, be pre-populated with the user's information and payment information so that the user need only confirm purchase of the camera, in one specific example.

Prioritization module 225 may prioritize contextual information to be presented to a user. For example, if a plurality of concept schemes are validated for a user interaction, thus indicating the possibility of a plurality of contextual information (e.g. advertisements), prioritization module 225 may determine which should be presented and in which order, for example. In some embodiments, prioritization module 225 may only present contextual information that are known to work (i.e. to which user's react positively), or which the particular user has not been presented with recently, for example. Other prioritization rules or schemes are of course possible.

Exemplary methods that may be performed by the various systems described above will now be discussed.

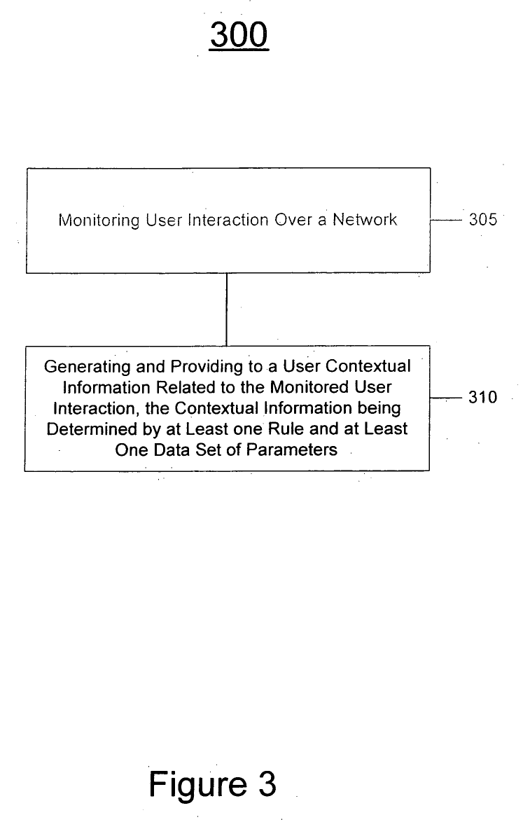

FIG. 3 illustrates one embodiment of a method 300 for providing contextual information to a user. In some embodiments, method 300 may be performed by system 100. At step 305, a user's interaction over a network, such as the Internet, for example, may be monitored to determine the user's particular interest, focus, or purpose in browsing the Internet. In some embodiments, user monitoring may be performed by contextual information module 105. A user, for example, may be looking to purchase a particular product, good or service, or to simply obtain information on a particular topic or subject. Monitoring the user interaction may comprise tracking and/or cataloguing the various web sites or pages the user visits. Such interaction may be identified based on the uniform resource locators (URLs) of web sites or pages visited, by the content of web sites or pages visited, or by particular terms or phrases used by the user to conduct online searches, for example. In either case, monitoring user interaction results in information indicative of the user's interest or focus.

In the case of URLs, the information indicative of the user's interest may comprise the particular URL itself. For example, www.amazon.com might indicate that the user is interested in making an online purchase, while www.ford.com might specifically indicate the user's interest in an automobile. Some URLs, for example, may trigger the presentation of particular contextual information, while other URLs do not allow the presentation contextual information. Which URLs allow contextual information may be determined by the system administrator of contextual information module 105.

In the case of web site or page content, the information indicative of the user's interest may comprise particular words, phrases, digits, or concepts that appear throughout the site or page. In some embodiments, site or page content is determined by assessing the HTML layout and/or metatags of the page or site. Thus, a page on Ford's web site, for example, might contain numerous terms, phrases and/or metatags indicating the user is viewing a page or site relating to a particular make and model automobile.

In the case of search terms or phrases used by the user to conduct online searches, the information indicative of the user's interest may comprise the search terms or phrases themselves. A user conducting a search on a popular search engine portal using the phrase “cheap fares,” for example, is likely interested in obtaining information about reduced rate travel. According to various embodiments, the particular search terms or phrases used by a user to conduct an online search may be used to identify particular contextual information to provide to the user.

At step 310, contextual information module 105 may generate and/or receive particular contextual information based on a concept scheme(s), concept(s) and/or keyword(s). In some embodiments, the concept scheme is determined based on the information indicative of the user's interest or purpose behind browsing the Internet, for example. Thus, the URLs visited, the content of the web sites or pages visited, and/or the search terms or phrases used by the user to conduct an online search may be used to determine at least one concept that may be used to identify contextual information to present to the user.

In some embodiments, one or more concept schemes may be used to determine the information indicative of the user's interest to a plurality of rules that assess the content of web sites or pages visited. For example, a particular concept scheme, “TravFlight” might be associated with the following rules:
KEYWORD1 must appear 1 time in the page or site,
KEYWORD2 must appear 2 times in the page or site, and
KEYWORD3 must appear 3 times in the page or site.

In some embodiments, KEYWORD1, KEYWORD2, and KEYWORD3, may correspond to terms, words, numbers or phrases that indicate or are related to a user's interest in a particular area. For example, if KEYWORD1=“details,” KEYWORD2=“flight,” and KEYWORD3=“travel,” the occurrence of “details” one times, “flight” two times, and “travel” three times would likely indicate that the user is interested in making travel arrangements with an airline. If the above rule is satisfied or validated, i.e., if the content of a page or site includes detail, flight and travel the requisite number of times, then the concept scheme associated with the rules, TraveFlight, would be designated and contextual information corresponding to TravFlight may be retrieved and presented to the user. In some embodiments, the retrieved contextual information may comprise a specific advertisement, for example. In various embodiments, the retrieved contextual information may comprise a category or collection of contextual information, the presentation of which may be based on any number of ways, including random presentation, rotating presentation, for example. An administrator of contextual information module 105 may define the various meanings of KEYWORD1, KEYWORD2, and KEYWORD3, such as in a database table, for example. This way, the concept scheme, TravFlight may correspond to any number of possible keyword arrangements and permutations that are determined to indicate relevance to that concept scheme. In some embodiments, concept schemes and/or particular keyword arrangements and permutations, for example, may be associated with tokens that may serve to target contextual information.

In various embodiments, the actual URLs and/or search terms or phrases used by the user to conduct an online search may be used to identify one or more concepts using one or more concept schemes. For example, the URL www.amazon.com may identify at least one concept that may be used to identify particular contextual information to present to the user. Likewise, particular search terms or phrases, such as “cheap fares, for example, may be used to identify particular contextual information to present to the user that relate to the user's apparent desire to obtain information on reduced travel rates.

Once the concept schemes are applied, the particular contextual information to provide to the user may be identified. In some embodiments, contextual information module 105 may pull contextual information directly from database 140. In these embodiments, the contextual information stored in database 140 may correspond with various concepts. That is, particular contextual information, such as a given advertisement, for example, may be triggered by any number concepts. Likewise, each concept may correspond to numerous forms of contextual information. For example, a concept scheme might designate an advertisement relating to reduced airline rates as well as a coupon or other promotional material from a particular airline. Which particular contextual information to present to the user may be determined by contextual information module 105 based on any number of considerations, such as contextual information previously viewed by the user, effectiveness of the contextual information, etc.

In some embodiments, concepts may be transmitted to a third party sponsor or provider to pull corresponding contextual information maintained by the sponsor or provider. For example, assume the sponsor or provider maintains a web site wherein customers can make travel arrangements. A user whose interaction with the Internet is being monitored by contextual information module 105 might be interested in booking travel to Orlando, Fla. Sensing this, contextual information module 105 may identify at least one concepts that relates to such information and forward the concept to the sponsor or provider to identify relevant contextual information. In some embodiments, the forwarded concept may result in the sponsor or provider presenting a page to the user offering to book travel to Orlando, such as presenting the user with a page from its web site which, with the user's permission, has been pre-populated with the user's information and requested travel to Orlando, Fla. The user may then opt to book travel by further engaging the contextual information provided by the sponsor or provider.

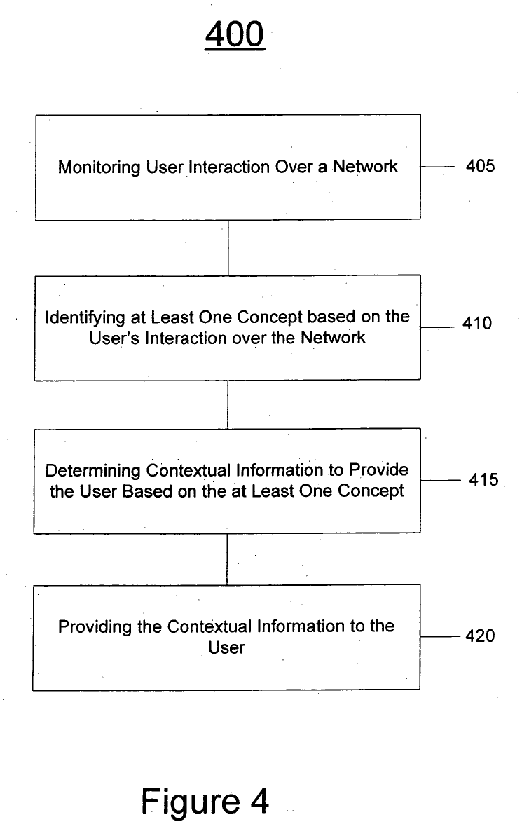

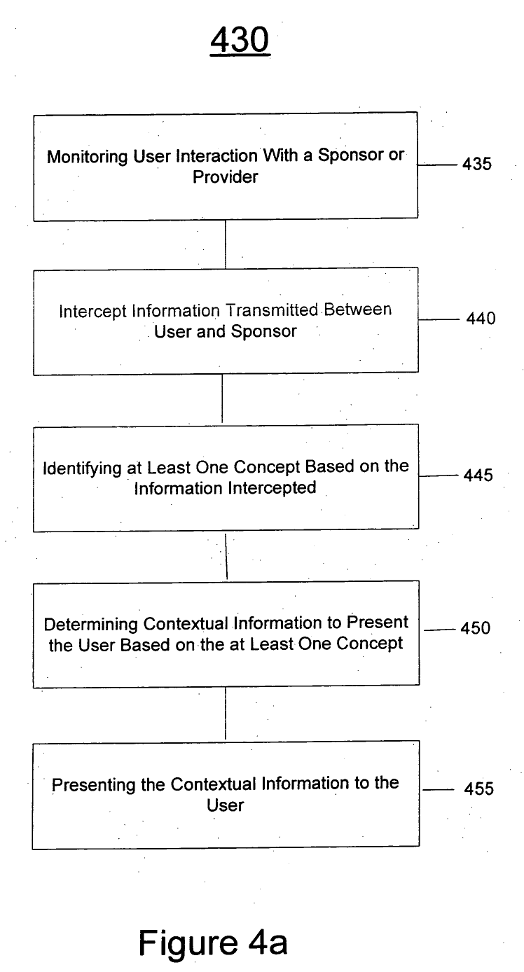

FIG. 4 illustrates one embodiment of a method 400 for providing contextual information. At step 405, user interaction over a network may be monitored. In some embodiments, monitoring may be conducted by a user monitoring module associated with contextual information module 105. At step 410, at least one concept is identified based on the user's interaction over the network. In some embodiments, the at least one concept is determined by concept identification module 205 associated with contextual information module 105. In some embodiments, the at least one concept is determined based on URLs visited by the user, the content of web sites or pages visited by the user, and/or search terms or phrases used by the user to conduct online searches and/or provide or request information.

In various embodiments, the concept identification module 205 may determine a plurality of concept schemes associated with the at least one concept, each scheme comprises at least one rule resolved against a parameter set from a plurality of parameter sets associated with the at least one rule. The plurality of parameter sets may comprise a set of terms, words, phrases, digits, concepts or other information that may be resolved against the user's interaction over the network for rule validation purposes. In some embodiments, each concept scheme may be associated with at least one rule and at least one item or category of contextual information to present to the user.

At step 415, contextual information to provide to a user is determined based on the at least one concept. In some embodiments, contextual information is determined by contextual information input module 210 associated with contextual information module 105. In some embodiments, contextual information input module 210 cooperates with a sponsor interface module 220 to engage sponsors or providers in the provision of contextual information. At step 420, the contextual information is provided to the user. In some embodiments, the contextual information is presented by contextual information module 105. Contextual information may be provided to the user in the form of a web page that is placed behind any page(s) the user is currently viewing so as to not interfere with the user's browsing, or displayed prominently on the user's screen. In some embodiments, the user may be notified that contextual information has been delivered, such as by sounding a distinctive tone or ring, for example.

FIG. 4a illustrates one embodiment of a method 430 for providing contextual information. At step 435, a user's interaction with a sponsor, provider or third party is monitored. At step 440, information transmitted between the user and the sponsor, provider or third party is intercepted or otherwise obtained. In some embodiments, the intercepted information may comprise information indicative of the user's reason, purpose or interest in communicating with the sponsor, provider or third party. In some embodiments, the intercepted information may be winnowed down to select words, terms, phrases, digits or concepts, for example. At step 445, at least one concept may be identified based on the information intercepted. In some embodiments, the at least one concept may be identified by resolving the intercepted information against at least one concept scheme employing one or more rules and having one or more target items of contextual information. Concepts corresponding to satisfied rules and/or schemes may then be identified.

Next, at step 450, contextual information to present the user may be determined based on the at least one concept identified. In some embodiments, contextual information may be identified by a uniform resource locator, for example. In other words, each identified concept scheme may be associated with any number of targets (e.g., URLs) that designate particular contextual information to be displayed to the user. In some embodiments, the content may be customized, such as by requesting a URL be populated with additional information about the user and/or a user request, for example. At step 455, the contextual information may be presented to the user.

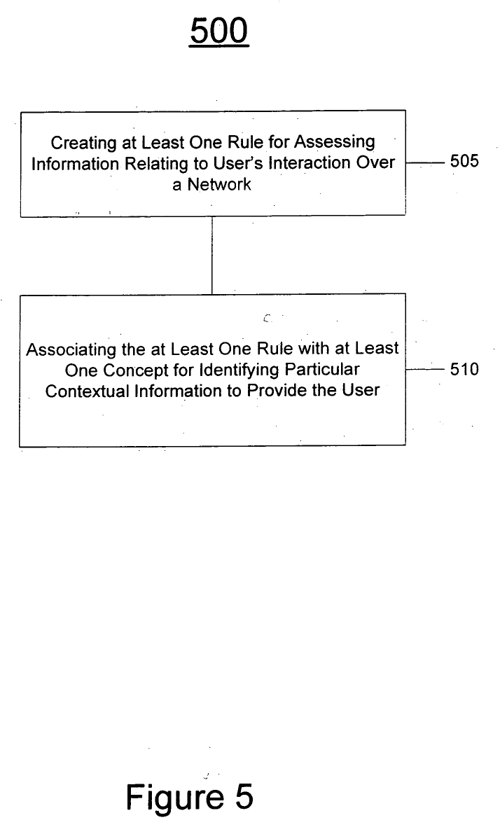

FIG. 5 illustrates one embodiment of a method 500 for creating a plurality of concept schemes. At step 505, at least one rule for assessing information relating to a user's interaction over a network may be created. In some embodiments, the at least one rule assesses the frequency of particular keywords on a web site or page visited by the user. A rule may require that KEYWORD1 appear two (2) times, that KEYWORD2 appear three (3) times, and that KEYWORD3 appear one (1) time. Other types of rules may of course be provided. At step, 510, the at least one rule may be associated with at least one concept for identifying particular contextual information to provide the user. In some embodiments, the at least one concept (and any corresponding rule(s)) may then be associated with contextual information that may be presented to a user upon validation of the at least one rule. Particular contextual information may be retrieved, for example, whenever the user visits a web site or page having content that satisfies a given rule, e.g., KEYWORD1 appears two (2) times, KEYWORD2 appears three (3) times, and KEYWORD3 appears one (1) time. In some embodiments, the contextual information may be retrieved locally from a database or remotely from a sponsor or provider.

In some embodiments, the method 500 for creating a plurality of concept schemes may further comprise the step of associating at least one target (e.g., a uniform resource locator) with at the least one concept scheme. The target may comprise the location of contextual information to deliver if the concept scheme validates. Likewise, the method of creating a plurality of concept schemes may further comprise the step of associating at least one search term or phrase with the at least one concept scheme. The contextual information may comprise advertisement, promotional information, incentive information, or any other type of information related to the user's interaction over the network.

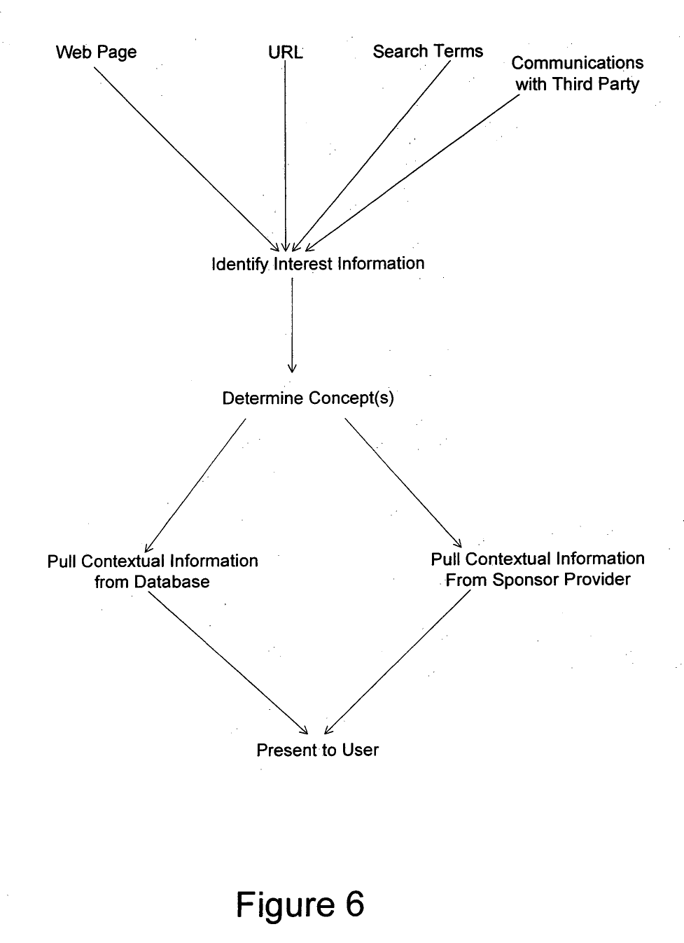

FIG. 6 illustrates the overall process flow 600 of another embodiment. As shown, the monitoring of a user's interaction with a network comprises monitoring URLs visited by the user, the content of web sites or pages visited by the user, and/or the search terms or phrases used by the user to conduct online searches, and/or communications with third party(ies). By monitoring the user's interaction, interest information may be extracted which indicates the user's interest, focus or purpose for browsing the network or Internet, for example. In the case of URLs, the URLs may comprise the interest information. In the case of search terms or phrases, the terms or phrases may comprise the interest information. In the case of web site or page content, the interest information may comprise the identity of various keywords that appear throughout the site or page.

Once the interest information is extracted, at least one concept may be determined. Identified URLs and search terms or phrases, for example, may have corresponding concepts that may be used to identify contextual information related to the URLs and search terms or phrases. Regarding the content of a web site or page content, the concept(s) may be determined according to satisfied or validated rules, as discussed above.

Once the concept(s) is/are determined, contextual information may be provided from a database, or from a third party sponsor or provider. In some embodiments, retrieving contextual information from a sponsor or partner or designated site may comprise transmitting information to the third party sponsor or provider to enable the provision of the contextual information. Such information may comprise, for example, select concept(s) or other token(s) that enable particular identification of contextual information. Once obtained, contextual information may be presented to the user.

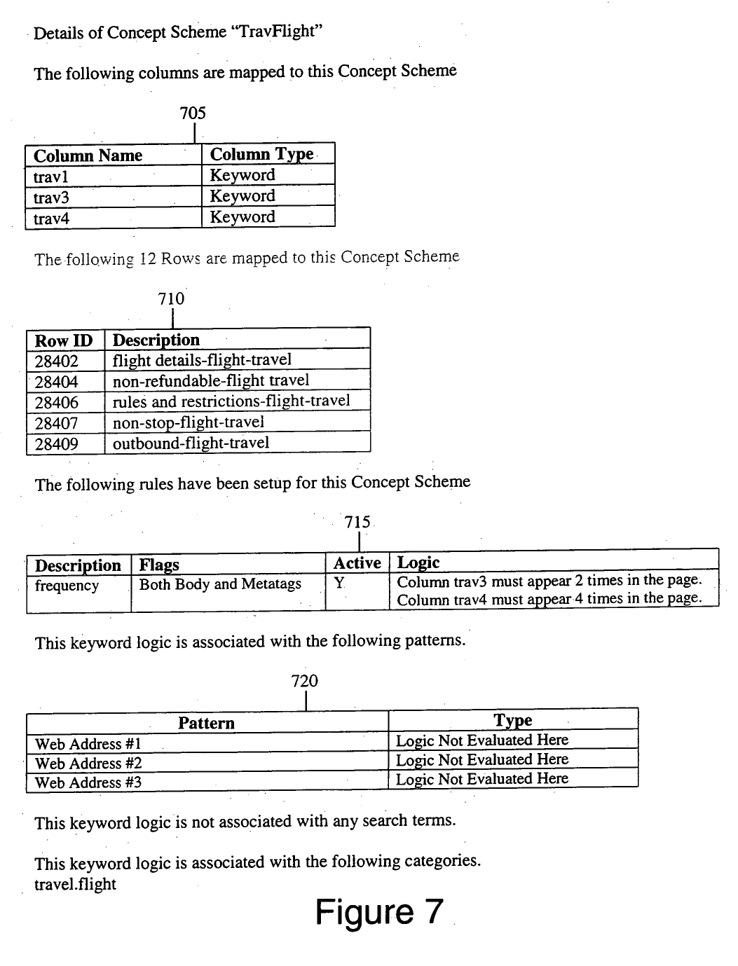

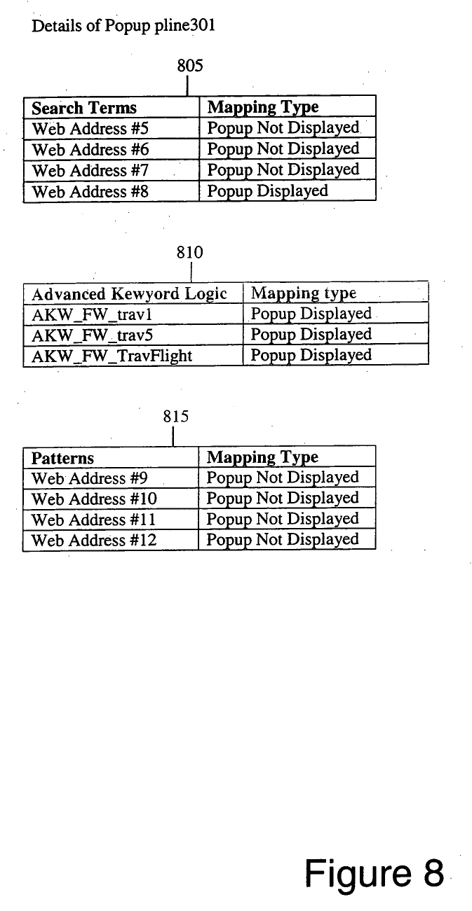

FIGS. 7 and 8 illustrate information relating to a concept and corresponding contextual information, respectively. The information illustrated in FIGS. 7 and 8 may be stored and maintained in database 140, for example. An administrator of contextual information module 105 may add, delete, edit, or revise any of the data entries and other information reflected therein that is used to monitor user interaction over a network, identify keywords, determine contextual information based on identified keywords, and provide contextual information to a user.

FIG. 7 illustrates particulars about the concept scheme “TravFlight.” As shown in 705, this concept scheme has three keywords that are used to assess web site or page content: trav1, trav2, and trav3. Table 710 illustrates an example of the possible permutations for these keywords. For example, in the first column of table 710 trav1 is defined as “flight details,” trav3 is defined as “flight,” and trav4 is defined as “travel.” Table 715 illustrates two rules that are used to determine whether the concept scheme “TravFlight” is designated. The rules are:

Column trav3 must appear 2 times in the page.

Column trav4 must appear 4 times in the page.

As a default, the absence of a specific rule regarding trav1 may be interpreted as indicating that trav1 must appear only once on a page.

In some embodiments, each web site or page viewed by a user is assessed under these rules. For example, a page viewed by a user may be scanned to see if it contains any of the keywords listed in table 710 as specifically required by the rules. That is, if a page includes “flight details” once, “flight” two times, and “travel” four times, then the concept scheme “TravFlight” is designated. Likewise, the rules may also assess information extracted or intercepted from communications between a user and a sponsor or provider, for example. This process is done for each of the sets of data shown in table 710.

Table 720 illustrates various uniform resource locators (URLs) that trigger designation of the concept scheme “TravFlight.” Table 725 illustrates that no search terms have been designated as triggering the concept scheme “TravFlight.”

FIG. 8 illustrates a form of contextual information (pline301) that may be identified in response to the concept scheme “TravFlight” being designated. As shown in table 805, this contextual information is also pulled when any of the search terms shown are used by a user to conduct an online search. Thus, if the user conducts a search for “airlines,” pline301 may be designated. Table 810 further illustrates various concept schemes that designate pline301. “TravFlight” is one such concept scheme. Table 815 illustrates various uniform resource locators (URLs) that designate pline301.

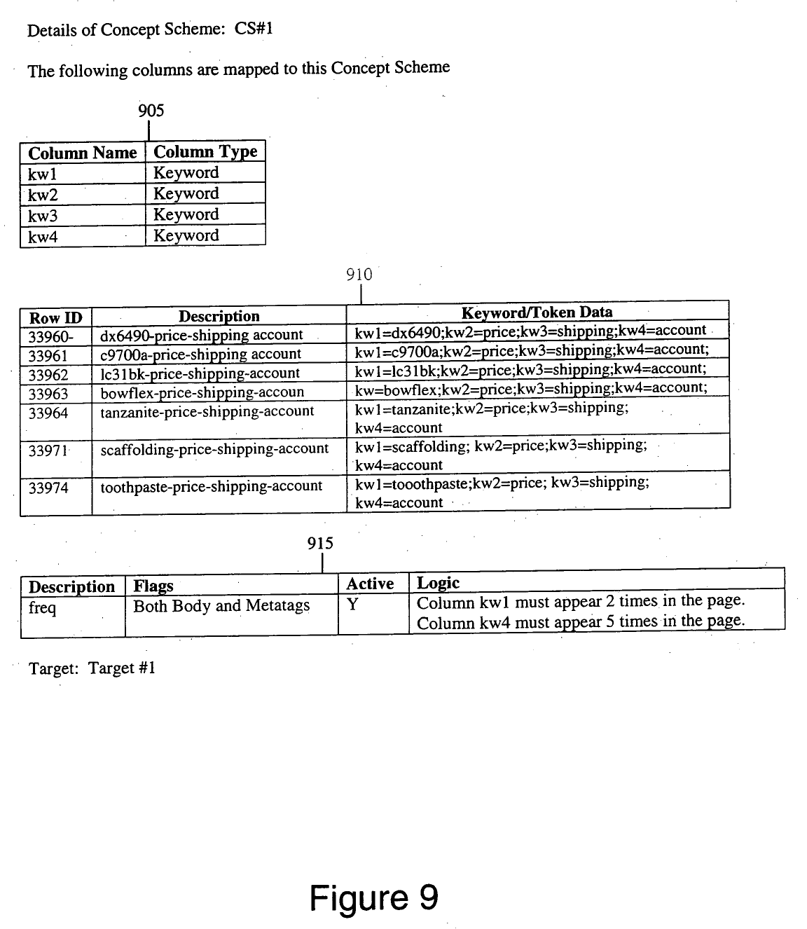

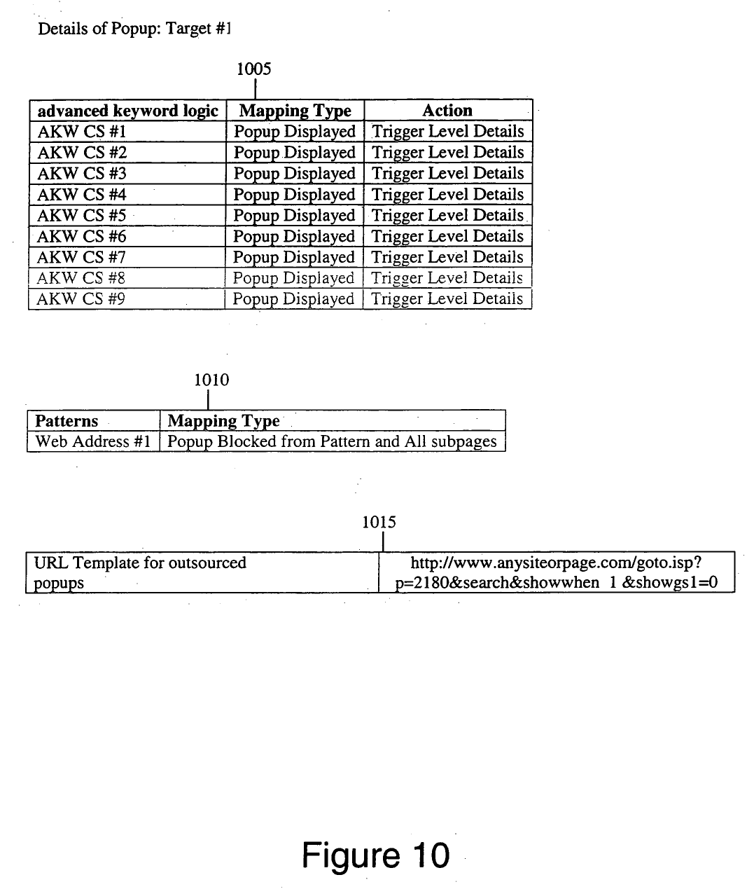

FIGS. 9 and 10 illustrate information relating to a concept scheme and corresponding contextual information, respectively. The information illustrated in FIGS. 9 and 10 may be stored and maintained in database 140, for example.

FIG. 9 illustrates a concept scheme “CS #1” that is used to trigger contextual information maintained by a sponsor or provider. As shown in table 905, in this example there are four keywords that are used to assess web site or page content: kw1, kw2, kw3, and kw4. Table 810 illustrates the possible permutations for these keywords. For example, in the first column of table 810 kw1 is defined as “dx6490,” kw2 is defined as “price,” kw3 is defined “shipping,” and kw4 is defined as “account.” The various permutations of table 810 aim to capture user interaction involving online purchases. Table 815 illustrates two rules that are used to determine whether the concept scheme “CS #1” is validated. The rules state as follows:

Column kw1 must appear 2 times in the page.

Column k4 must appear 4 times in the page.

As a default, the absence of a specific rule for kw2 and kw3 merely means that kw2 and kw3 must appear only once on a page. Thus, if a page includes “dx6490,” twice, “price” once, “shipping” once, and “account” four times, then the concept scheme “CS #1” is validated. This process is done for each of the sets of data shown in table 810. Note, however, that “CS #1” in this example may not be limited by URL or search term or phrase.

FIG. 10 illustrates a form of contextual information (Target #1) that may be identified in response to the keyword “CS #1” being designated. Table 1005 illustrates various keywords, along with “CS #1” that may designate or pull Target #1. In some embodiments, Target #1 may be blocked, for example, from appearing while a user is visiting a particular web site or page, for example, as shown in 1010. In some embodiments, Target #1 may include a URL (shown in 1015) that may be sent to a sponsor or provider to obtain contextual information. For example, if the user is browsing for a particular digital camera, the URL shown in 1015 may be constructed or composed in such a way as to particularized or personalized contextual information from the sponsor or provider, such as web site or page offering the user the particular digital camera he or she is looking for. In some embodiments, the URL may be composed in such a way that the web page received from the sponsor or provider, with the user's permission, is pre-populated with the user's information and payment information so that the user need only confirm purchase of the camera. Other information may be provided.

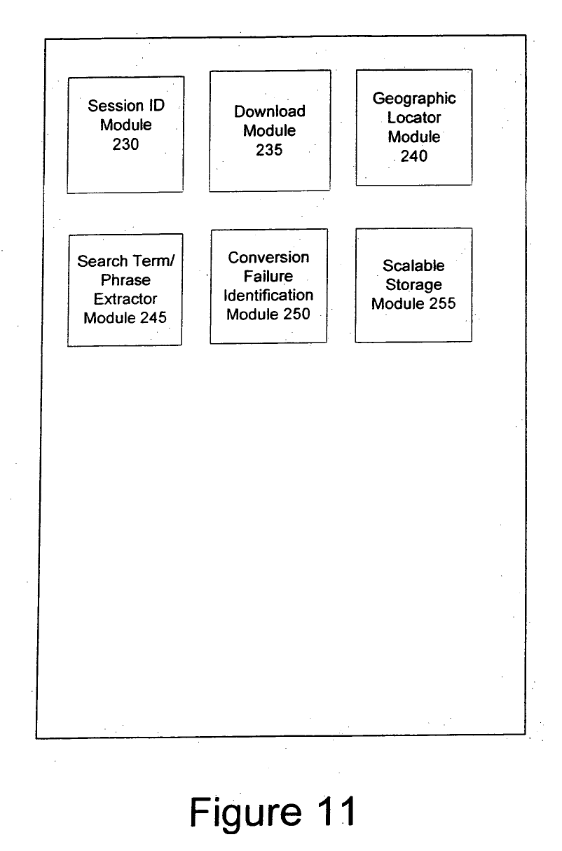

FIG. 11 illustrates additional exemplary modules that may be associated with contextual information module 105 to provide enhancement or diagnostic tools for the various functions and features of the embodiments described herein. While the modules may not be used in all embodiments to perform some or all of the functions of the present invention, they are nonetheless presented as possible embodiments. As shown, the following modules may be provided: (1) session ID module 230; (2) download module 235; (3) geographic locator module; (4) search term/phrase extractor module 245; (5) conversion failure identification module 250; and (6) scalable storage module 255. In some embodiments, each of these modules may reside on any of client stations 110 and may cooperate with any of the various features and described herein for providing contextual information. All of the modules operate and perform their respective functions while protecting the personally identifiable information (PII) of users, without in any way uniquely identifying any user or deriving any behavior that specifically identifies a user. Each is described below.

Session ID module 230 may track or trace sessions and/or user-initiated actions throughout the server network of system 100, for example. In some embodiments, session ID module 230 may enable an administrator of central control station 130, for example, to monitor actions throughout system 100 (and other systems or networks) that correspond to a particular user-initiated request(s), activity(ies), or behavior. Such a feature may be used to improve the user experience by providing a technique for debugging and/or tracing, for example, user-initiated actions through a particular system(s) or network(s), such as system 100, for example. In some embodiments, session ID module 230 may track or trace the full circuit or path of user-initiated actions taking place or occurring inside a system or network in response to a particular user-initiated activity, such as initiation of online advertising, for example. In some embodiments, session ID module 230 may be used for diagnostic purposes or to simply develop and maintain statistics on system operation and behavior. For example, if a particular online advertisement experiences a problem with its initiation, generation, presentation and/or delivery session ID module 230 may be used to monitor system behavior by tracking corresponding system actions to isolate or locate the problem, such as, for example, the identity of a particular file, server, system, and/or network where an error or failure may be occurring.

In some embodiments, session ID module 230 may generate at least one unique identifier that gets associated with or tagged onto at least one action initiated by a user. For example, assume a user is browsing the Internet and initiates (e.g., clicks on) a particular online advertisement. The action(s) resulting from the user's initiation of the advertisement may be associated or tagged with at least one unique identifier that then follows the action(s) throughout any number of files, servers, system(s) and/or network(s), thus enabling an administrator of system 100, for example, to selectively trace or monitor the path or life of the action(s) throughout any number files, servers, systems and/or networks.

In some embodiments, session ID module 230 may generate a unique identifier which gets associated with or tagged onto an entire circuit of actions (e.g., session associated with a particular piece of contextual information. For example, a unique identifier may be associated with or tagged onto a particular advertisement when the advertisement is generated, as well as to data or information indicating when and where the advertisement gets displayed. The unique identifier may also be associated with data or information indicating a user's initiation of the advertisement, as well as with all action(s) resulting from the user's initiation of the advertisement. This way, an administrator of system 100, for example, may track or trace all events associated with the advertisement, from its generation, presentation, initiation by a user, through all subsequent actions, including any generation and presentation of related contextual information, for example. The unique identifier may also be used to monitor the entire path of computations that were performed on system 100, for example, to accomplish all actions related to the advertisement.

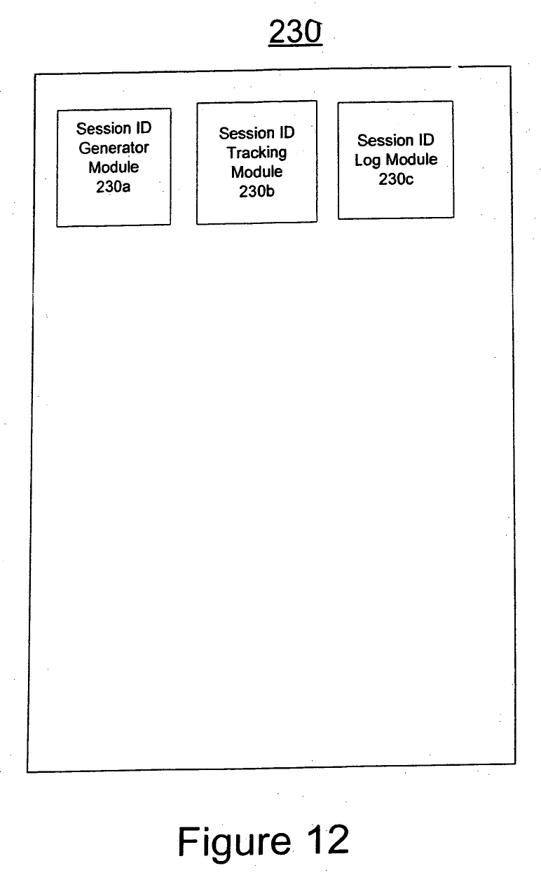

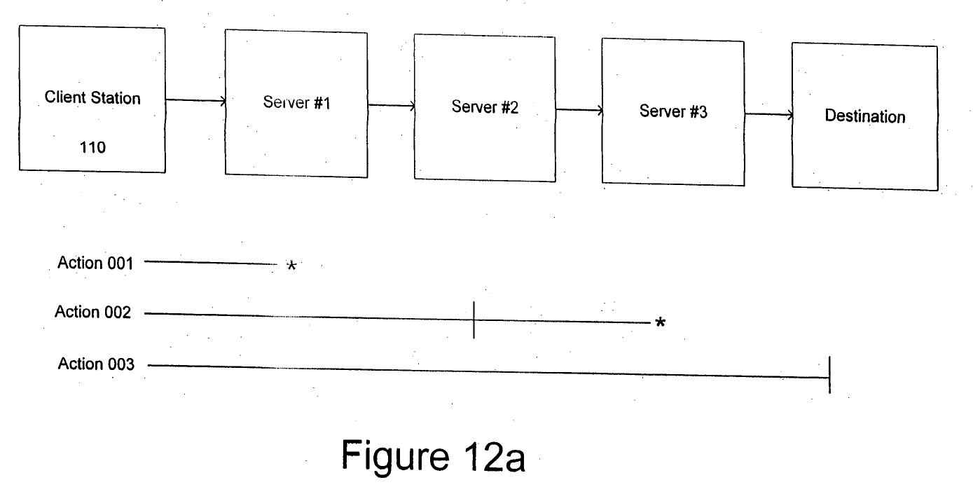

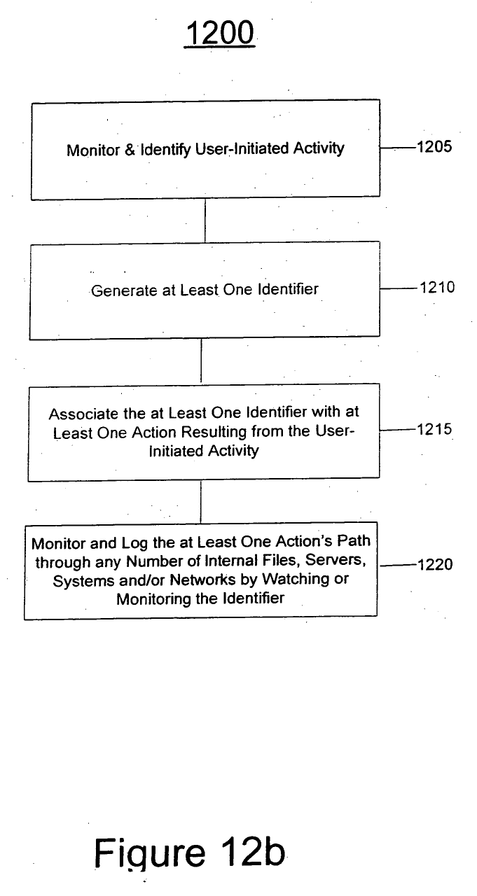

FIG. 12 depicts one embodiment of a session ID module 230 comprising a session ID generator module 230a, a session ID tracking module 230b, and a session ID log module 230c. In some embodiments, session ID generator module 230a may operate to generate or create at least one identifier that may be associated with or tagged onto a particular user-initiated action and/or contextual information. In some embodiments, session ID generator module 230 may generate the at least one identifier randomly, while in some embodiments the at least one identifier may be generated sequentially, or according to a predetermined protocol or rule. In various embodiments, the at least one identifier may comprise a number, while in some embodiments it may comprise at least one character (e.g., alphanumeric), or at least one symbol. In some embodiments, session ID generator module 230a may store and maintain a list of correlated contextual information actions and/or identifiers which a user may then access as needed (see e.g., session ID log module 230c) to monitor, track or trace system integrity.

Session ID tracking module 230b may enable a user—such as an administrator of system 100, for example—to track or trace a particular session or user-initiated action while maintaining the user's privacy and without using, accessing, obtaining, transmitting, deriving, or recording any personally identifiable information (PII). For example, a user may want to track the action path that takes place following initiation of a particular advertisement relating to a certain automobile. In such a case, the action may work through a certain path of files, servers, systems and/or networks in connection with accomplishing a certain task, such as the loading of a website or page, or determining related contextual information to present to a user, for example.

Session ID log module 230c may operate to maintain and provide access to a list of correlated sessions, user-initiated actions, and identifiers. In some embodiments, sessions actions and identifiers may also be correlated to particular user-initiated activity that triggered or gave rise to action in the first place. For example, session ID log module may maintain the following information:

| | | USER-INITIATED |
|---|---|---|
| SESSION/ACTION | IDENTIFIER | ACTIVITY |
| Path through Log file 1, | 0001 | User clicks on particular |
| server 1, and system 1. | | advertisement. |
| Path through log file 2, | 0002 | User enters particular search |
| server 2, and system 2. | | term/phrase. |
| Path through log file 3, | 0003 | User visits or views |
| server 3, and system 3. | | particular web site or page. |
| Advertisement #1 | 0004 | user visits or views |
| | | particular website or page. |

Referring to the above table, a system administrator of system 100, for example, may be able to track or trace action 0001's circuit or path through file 1, server 1, and system 1 by interfacing with session ID tracking module 230b and providing the identifier associated with such an action. In some embodiments, the identifier may be provided through a graphical user interface (GUI) that enables the administrator to interface with session ID monitor 230, for example. Session ID log module 230c may maintain other relevant data or information, such as a field indicating whether a particular action was realized (e.g., reached its ultimate destination). Other data fields are possible.

In some embodiments, a particular identifier may reference each and every step of the circuit or path taken by the corresponding action. For example, by inputting identifier 0001 in session ID tracking module 230b, a user may obtain specific information about the activities of the action at log file 1, the activities at server 1, and the activities at system 1. This way, the system administrator may monitor system integrity, and be able to identify where and how errors may be occurring.

FIG. 12a illustrates one embodiment of a process followed by actions resulting from particular user-initiated activity. For example, an initiated action may work through a particular series of files, servers, systems, and/or networks in order to accomplish the user-initiated activity. For example, if a user initiates a particular advertisement corresponding to a particular car manufacturer, an action may be triggered that performs the process of loading the manufacturer's web site or pages by working through various files, servers, systems and/or networks to load and/or process the appropriate data and information. As shown, action 001 may result from a user initiating such an online advertisement. Action 002 may result from the user performing a particular online search. Action 003 may result from the user's browsing history or path, such as visiting or viewing specific web sites or pages that result in a particular action being triggered. Other user-initiated activities are of course possible. In some embodiments, the numbers 001, 002, and 003 may comprise the identifier that gets generated by session ID generator module 230a and subsequently associated with or tagged to the particular action.

As shown in FIG. 12a, a system administrator checking on the status of any of action # would determine that it broke down somewhere in Server #1, as indicated by the asterisk (*). In some embodiments, this may be the result of an erroneous computation or failure that occurred in server #1. Action # 2, on the other hand, made it through server #1, stalled at server #2 (as indicated by the “|”), but ultimately broke down somewhere in Server #3. Action #3, however, successfully worked its way through the three server on its way to its destination.

FIG. 12b illustrates one embodiment of a method 120 for monitoring, tracking and/or tracing at least one action resulting from user-initiated activity, according to embodiment of the invention. In some embodiments, the various steps may be performed by session ID module 230. At step 1205, session ID module 230 may monitor and identify user-initiated activity. For example, a user may be browsing the Internet and come across online information that the user is interested in learning more about, such as an online advertisement for a particular automobile, for example. The user may initiate (e.g., click) the advertisement to initiate an action that loads additional information about the automobile, such as loading the manufacturer's web site or page corresponding to the automobile, for example. Such an action may comprise the performance of numerous steps through any number of files, servers, systems, and/or networks. Other user-initiated activity may comprise the performance of online searches, and a user's browsing history, for example.

At step 1210, identification of online information may result in generation of at least one identifier that, at step 1215, may be associated with the session or action. In some embodiments, the identifier may enable monitoring, tracking and/or tracing of the action as it works it way through various files, servers, systems and/or networks. For example, the at least one identifier may comprise a unique number(s) or character(s) that gets associated with or tagged onto to any session or action(s) that are triggered by the user's initiation of the particular advertisement. In some embodiments, the unique identifier may be stored (e.g., in a searchable database) to enable subsequent access thereto by an administrator of system 100, for example. This way, such an administrator may follow or trace the path of session or action triggered by initiation of a particular advertisement, for example, thus enabling the administrator to diagnose trouble spots within any files, servers, systems and/or networks, for example.

As shown in FIG. 11, the various systems and methods of the invention may also include a download module 235 that, in some embodiments, may enable central control station 130, for example, to provide downloads to or updates of contextual information module 105 to client station 110. In some embodiments, download module 235 may provide downloads or updates to contextual information module 105 residing at a client station 110 on a piecemeal or segmented basis. For example, contextual information module 105 may be updated periodically, according to a predetermined schedule, or upon the request of either a user of client station 110 or an administrator of system 100, for example.

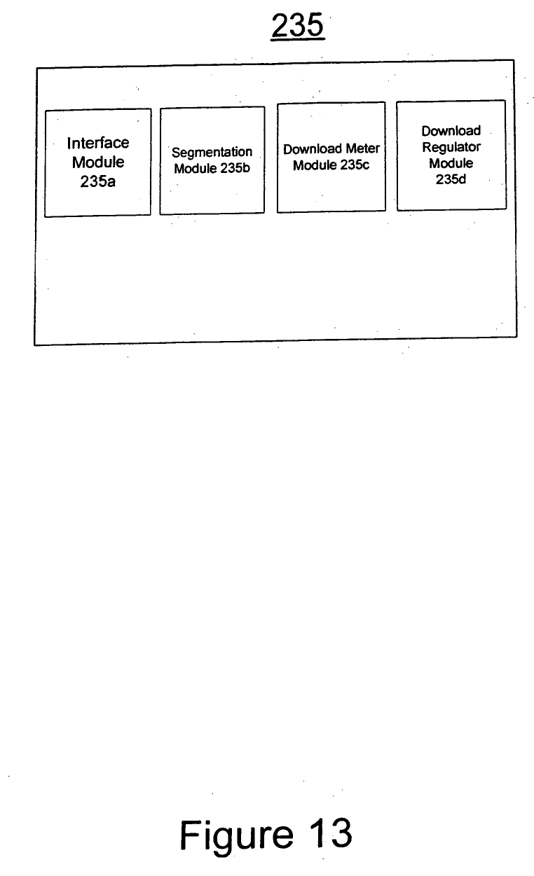

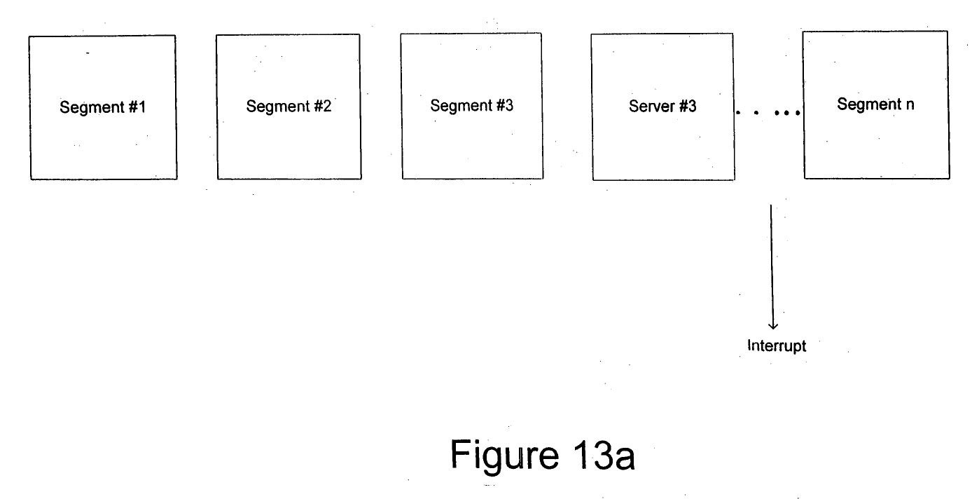

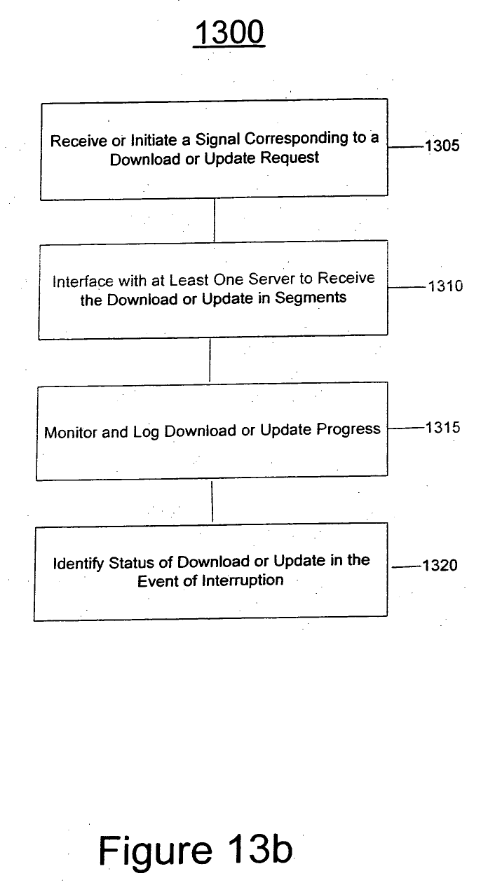

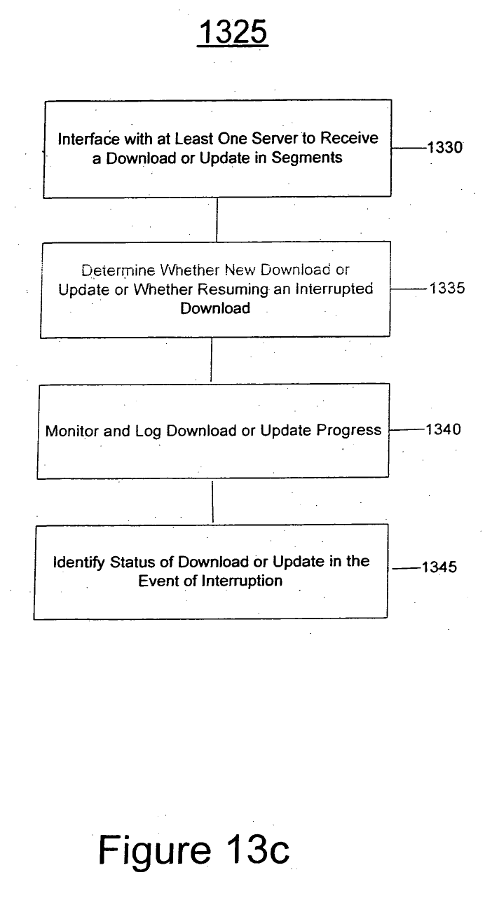

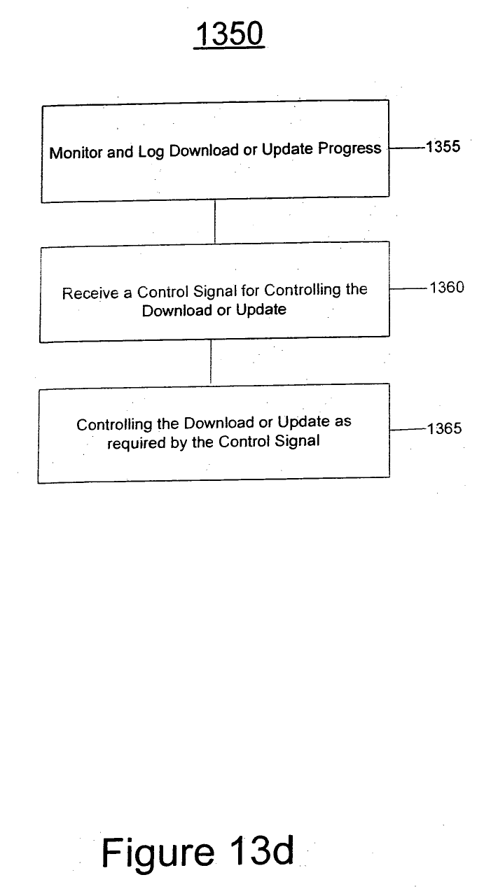

FIG. 13 illustrates one embodiment of a download module 235 comprising an interface module 235a, a segmentation module 235b, a download meter module 235c, and a download control module 235d. In some embodiments, interface module 235a may operate to interface with central control station 130, for example, and receive downloads and or updates therefrom. Such a download or update may be initiated by control station 130, in which case download module 230 may receive an initiation signal from control station 130, while in some embodiments the download or update may be initiated by contextual information module 105, in which case download module 230, for example, may transmit to control station 130 an appropriate initiation signal. Downloads or updates may comprise data or information related to various features and functions described herein, such as those associated with the coordination, determination, and presentation, and provision of contextual information, for example. In some embodiments, downloads and updates are provided in central control station 130 and retrieved through by download module 235.

Download module 235 may also comprise a segmentation module 235 that segments the file, script, or module to be downloaded or updated into any number of downloadable segments. In some embodiments, the segments may be downloaded to client station 130, for example, in serial fashion to enable a measured and download process. In some embodiments segmentation module 235b may reside in control station 130, contextual information module 105, or any other site or location that cooperates with system 100 to provide any of the features and functionality described herein.

Download module 235 may also include a download meter module 235c that monitors the downloading of segments from central control station 130, for example. In some embodiments, download meter module 235 may register the reception of incoming segments and indicate which segments are properly received, downloaded and/or updated. In some embodiments, download meter module 235c may also identify a system failure or error that results in interruption of a download or update. For example, download meter module 235c may identify the last segment to be properly downloaded so that once the failure or error is corrected, the download process may resume where it left off and thus avoid the need to commence the download process at the beginning.

Download regulator module 235d may enable the regulation or control of downloads or updates through download module 235. In some embodiments, a user of client station 110, or an administrator of system 100, for example, may control the speed by segments are being downloaded or updated. In some embodiments, this may be done by changing the size of individual segments and/or the interval between segments, for example. Other techniques for regulating or controlling downloads or updates are possible.

FIG. 13a illustrates one embodiment of a process flow for downloading or updating files, scripts, or modules. As shown, a file, script or module to be downloaded onto client station 110 may be segmented into “n” segments by download module 235. Each segment may then be downloaded to client station 110 in serial fashion: segment #1 is downloaded, followed by segment #2, and so on. Such a download protocol may ensure that the occurrence of a failure or error will not contaminate or affect the integrity of a properly downloaded segment or segments. For example, as shown, segments #1-#3 have been properly downloaded. During (or prior to) download of segment n, however, a failure or interrupt event occurs that interrupts or interferes with the download or update process. In some embodiments, a failure or interrupt event may comprise a failure in the communication between client station 110 and central control station 130, for example, or an unintended log off by the user of client station 110. Other failure events are of course possible. In some embodiments, once the failure event is corrected—for example, the user logs back on to client station 110 or communication is restored—download module 235 may resume the download or update process where it left off.

FIG. 13b illustrates a method 1300 for downloading or updating data files, scripts and/or modules, according to one embodiment of the invention. At step 1305, download module 235 may receive or initiate a signal corresponding to a download or update request. In some embodiments, such a download request signal may be received or initiated according to a predetermined schedule (e.g., periodically or as needed), or request by a user of client station 110 or an administrator of system 100, for example. At step 1310, download module 235 may interface with a download or update station, such as central control station 130, for example, to receive the download or update. In some embodiments, the file, script or module to be downloaded may be broken down into segments that are individually downloaded to client station 110, for example. Segmentation may take place at the download station, or at client station 110. At step 1315, download module 235 may monitor and log the download process. At step 1320, download module 235 may identify the status of a download or update upon the occurrence of an failure or interrupt event. For example, download module 235 may designate which individual segments are properly or incompletely downloaded, and which have been corrupted or improperly received. In some embodiments, download module 235 may record such designations in a searchable database.

FIG. 13c illustrates a method 1325 for downloading or updating data or information, according to one embodiment of the invention. At step 1330, download module 235 may interface with at least one download station to receive a download or update in segments. At step 1335, download module 235 may determine whether the download or update is new, or whether it resumes a previously interrupted download or update. In the event the download or update resumes a previously interrupted download or update, then download module 235 may determine the last segment to be properly downloaded, or the segment during which the failure or interrupt occurred. At step 1340, download module 235 may commence or resume the download or update and monitor and log its progress. At step 1345, download module 235 may identify the status of a download or update in the event of a failure or interrupt event.

FIG. 13d illustrates a method 1350 for regulating or controlling the download or update of files, scripts, or modules, according to one embodiment of the invention. At step 1355, download module 235 may monitor and/or log download or update process. At step 1360, download module 235 may receive a control signal for controlling the download or update. In some embodiments, the control signal may direct an increase or decrease in the speed in which segments are being downloaded. While ultimately constrained by the connection between a client station 110 and a download station, for example, a user of client station 110 (or an administrator of system 100) may control or regulate the speed of the download or update as necessary. In some embodiments, such control may be effected through a graphical user interface (GUI) that enables interaction between a user or administrator and download module 235.

As shown in FIG. 11, the various systems and methods of the invention may also include a geographic locator module 240 that, in some embodiments, may enable contextual information module 105, for example, to determine the geographic location of a particular user and/or client station 110. In some embodiments, geographic locator module 240 may determine the geographic location of a user and/or client station based on the user or client station's internet protocol (IP) address. In some embodiments, geographic locator module 240 may transmit the IP address of the client station 110 where it resides to a geography locator station, such as central control station 130, for example. The IP address may be transmitted according to a predetermined schedule, such as on a weekly or bi-weekly basis, for example. In some embodiments, IP address may be transmitted to a geography locator station where it gets resolved into a geographic location, while in other embodiments such resolution may take place at the client station terminal 110, or at a third party site or location capable of making such a determination.

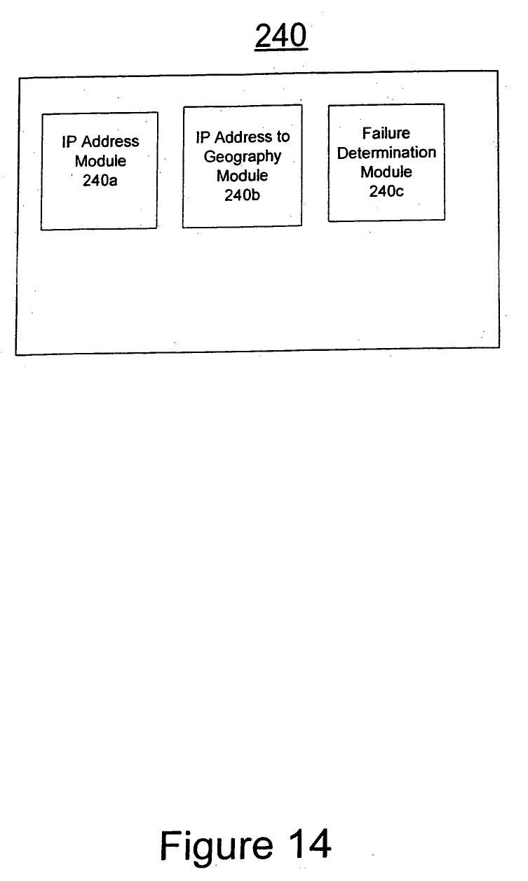

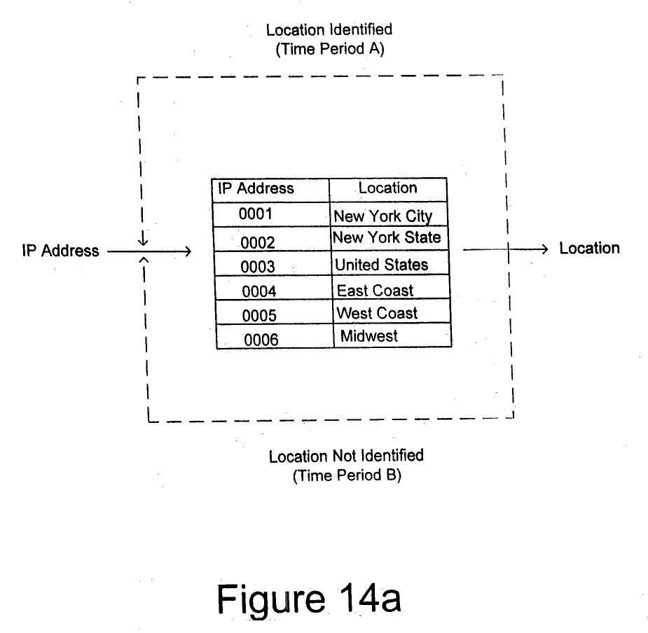

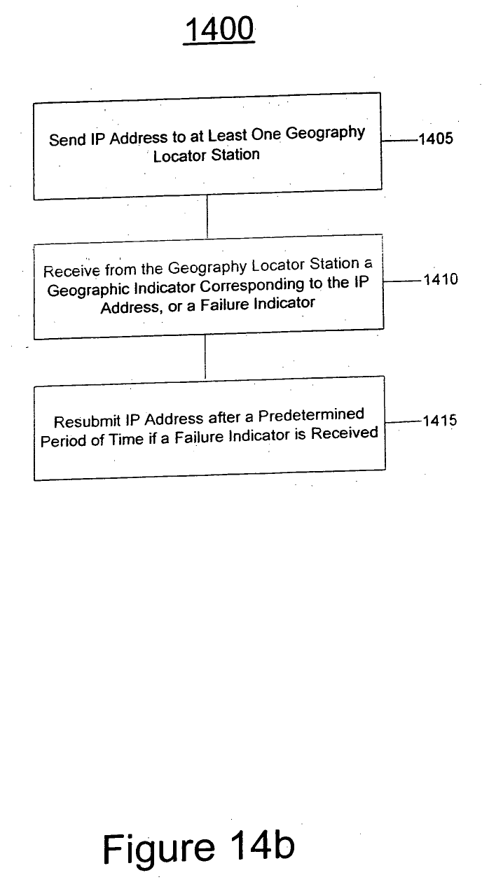

FIG. 14 illustrates one embodiment of geographic locator module 240 comprising an IP address module 240a, an IP address to geography module 240b, and a failure determination module 240c. In some embodiments, IP address module may determine or retrieve the IP address of the particular client station 110 on which it resides, and thereafter transmit such IP address to an geography locator station, such as central control station 130, for example. In some embodiments, the geography locator station may comprise the client station 110 itself. Transmission of the IP address to a geography locator station may occur randomly, according to a predetermined schedule, or upon request by the user of client station 110 or an administrator of system 100, for example.

IP address to geography module 240b may, in some embodiments, receive the IP address from the client station 130 and resolve it against a database of IP addresses that are correlated to particular geographic locations, such as country, state, city, region, time zone, continent, or any other geographically-based parameter. In some embodiments, IP address to geography module 240b may reside in central control station 130, while in other embodiments it may reside in client station 110.

Failure determination module 240c may, in some embodiments, determine whether a geographic location corresponding to an IP address is successfully determined and/or received, or whether a failure signal is determined or received. A failure signal may also result from a lack of response from the central control station 130, for example, after a certain period of time. For example, this might occur as a result of disconnect or if central control station 130 is temporarily unavailable. Failure determination module 240c may also coordinate retransmission of an IP address in the event of success or failure in determining a geographic location(s) corresponding to the IP address. In some embodiments, a IP address may be retransmitted after a first predetermined period of time if a geographic location was determined, and after a second predetermined period of time if a geographic location could not be determined.

FIG. 14a depicts one embodiment of a process flow for determining the geographic location of a user or client station using an IP address. As shown, an IP address of the user or client station may be resolved against a database or table that correlates IP addresses to particular geographic locations. Typically, such correlated data and information may be obtained, purchased, and/or updated from a third party vendor that aggregates data and information relating to users, IP addresses, and geographic locations, for example. As shown, if a particular IP address results in successful determination of a geographic location, then geographic locator module 240 may check to see if the geographic location corresponding to the IP address changes by submitting the IP address to the geography locator station after time period A. In some embodiments, upon successful resolution, the IP address may be periodically submitted, such as on a weekly, bi-weekly, or monthly basis, for example. However, if a geographic location could not be identified, then the IP address may be transmitted to the geography locator station after time period B. In some embodiments, because a geographic location could not be determined, then time period B may be less than time period A so that more frequent attempts may be made to determine the geographic location of the user or client station.

For example, if the IP address sent to the geography locator station is 0001, then the corresponding geographic location will be New York City. If the IP address is 0002, then the geographic location will be New York State. Under either of these scenarios, or if the IP address is 0003, 0004, 0005, or 0006, then the geographic location module 240 may check again at a later date (determined by time period A) to see if the location corresponding to the IP changes. However, if the IP address is 0007, then a failure signal will be transmitted indicating that the IP address could not be located. In this case, geographic locator module 240 may check again after time period B passes (e.g., twenty-four (24) hours) to see if by chance the failure signal was a mistake, or if new data or information has been received correlating the IP address with geographic information.

FIG. 14b illustrates a method 1400 for determining the geographic location of a user based on the user's IP address, according to one embodiment of the invention. At step 1405, the geographic locator module 240 may transmit the IP address of the user or client station to at least one geography locator station, which may then resolve the IP address against a database or table that correlates IP addresses with geographic locations. Resolution of the IP address with the database or table will result in either a geographic location being identified, or a failure signal indicating that the IP address was not found or is not associated with a particular geographic location. At step 1410, the geographic locator module 240 may receive a geographic indicator corresponding to the IP address, or a failure signal indicating that the geographic location could not be determined. If a geographic indicator is successfully received, then the IP address of the user or client station may be submitted to at least one geography location station after a first predetermined period of time. If a failure indicator is received, then, at step 1415, the IP address of the user or client station may be resubmitted to at least one geography locator station after a second predetermined period of time. In some embodiments, the second period of time is less than the first predetermined period of time.

As shown in FIG. 11, the various systems and methods of the invention may also include a search term/phrase extractor module 245 that, in some embodiments, may enable contextual information module 105, for example, to better extract search terms and/or phrases from a uniform resource locator (URL), irrespective of the particular search tool (e.g., engine, web page or site) used to conduct an online search. In some embodiments, search term/phrase extractor module 245 may determine that a user is performing an online search, determine which search tool is being used, determine which rules to use for extracting search terms and/or phrases from a URL, and extract search terms and/or phrases from a URL.

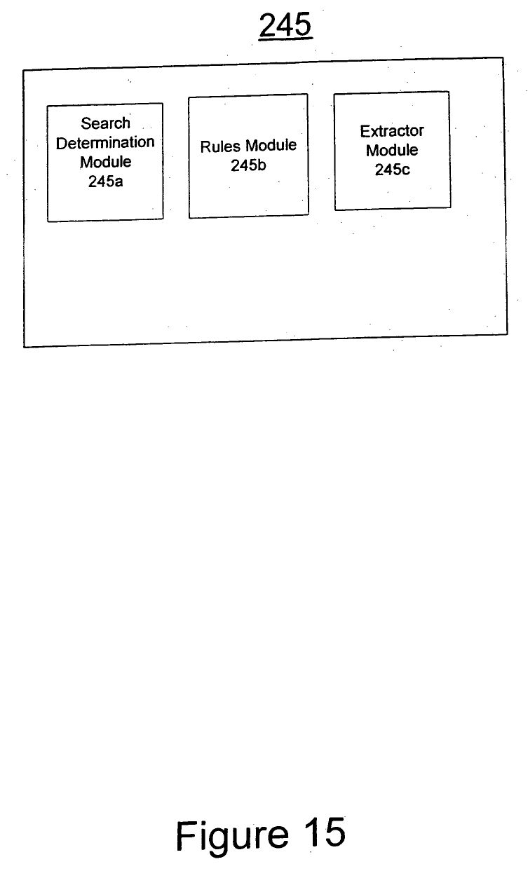

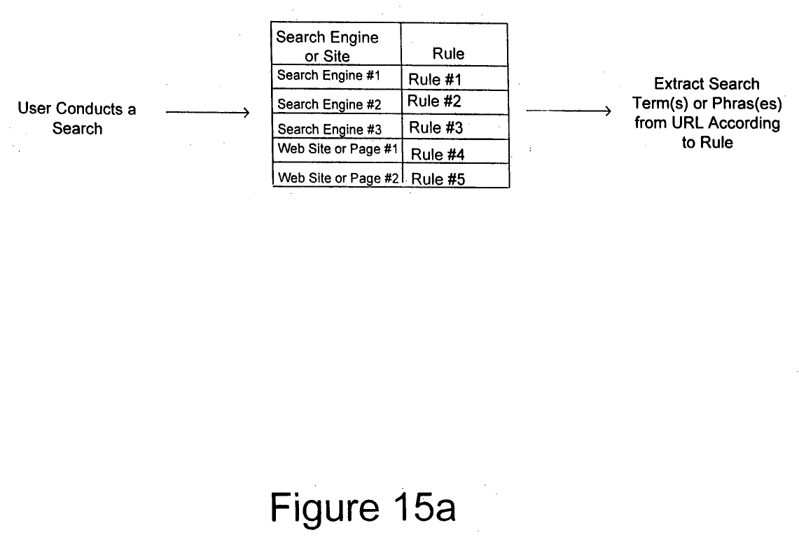

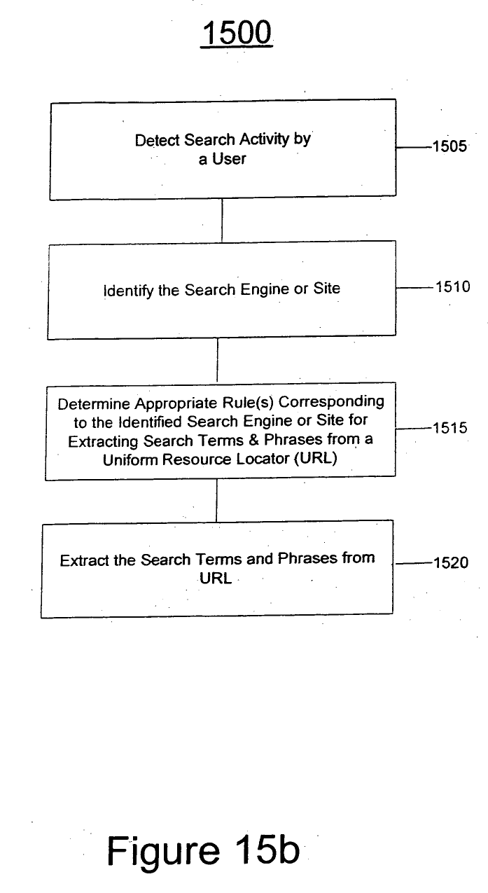

FIG. 15 illustrates one embodiment of a search term/phrase extractor module 245 comprising a search determination module 245a, a rules module 245b, and an extractor module 245c. In some embodiments, search determination module 245a may determine whether a user of client station 110, for example, is conducting an online search using a particular search tool(s), such as on a search engine, or a popular consumer web site, for example. Other types of searches are possible. Search determination module 245a may also determine the particular search tool being used to conduct the search. For example, if search determination module 245a determines that a search is being conducted, it may also determine that it is being conducted through a particular search engine, for example. Other search tools are possible.

Rules module 245b may determine the particular rule(s) to use for extracting search terms and/or phrases from a URL. In some embodiments, the particular search tool used to conduct an online search may compose URL's in a unique and particular manner. For example, a particular search engine (e.g. searchengine1) may encode and submit search requests using the following URL structure:
http://search.searchengine1.com/plasma-TV_W0QqfromZR8QQhtZ1QqsokeywordredirerctZ!QqsosortpropertyZ1

Rule module 245b, therefore, may determine the appropriate rules for extracting search terms and/or phrases from URL's composed or encoded by searchengine1. The rule(s) may be maintained in a searchable database, and may be edited or revised as necessary. In some embodiments, a particular rule may: (1) comprise a free-form expression, (2) specify that certain characters have be used to identify the search terms/phrases within a URL, (3) specify that certain characters have to be replaced by others (e.g., one search engine may separate search terms with a space while another search engine does so with a backslash); and (4) specify any logic or expression that properly extracts search terms or phrases from an encoded URL. In some embodiments, a rule may search for and replace a substring by another substring or string. In some embodiments, a rule may augment and assist in the parsing and formulation of a resulting contextual conclusion. Extractor module 245c may then extract search terms or phrases according to the rules provided or identified by rules module 245b.

FIG. 15a illustrates one embodiment of a process flow for determining appropriate rule(s) for extracting search terms/phrases from encoded URLs. As shown, a user conducting a search may be monitored by search term/phrase extractor module 245. Search term/phrase extractor module 245 may determine that a user is conducting a search as well as which search tool is being used to conduct the search. Search term/phrase extractor module 245 may then resolve the identity of the search tool against a database or table correlating search tools with rule(s) for extracting search terms or phrases from encoded URLs. Search term/phrase extractor 245 may then extract search terms or phrases according to the rule(s) identified. For example, for a user conducting a search on search engine #1, search term/phrase extractor 245 may determine that Rule #1 should be used, for a user using search engine #2 Rule #2 should be used, etc.

FIG. 15b illustrates a method 1500 for determining the appropriate rule(s) for extracting search term(s)/phrase(s) from a URL, according to one embodiment of the invention. At step 1505, search term/phrase extractor 245 may detect search activity by a user. For example, the user may conduct an online search on a major online search engine portal for “SUV ratings,” or search for “digital cameras” on a popular consumer shopping web site. At step 1510, the search term/phrase extractor 245 may identify the particular search tool(s) used to conduct the search. At step 1515, search term/phrase extractor 245 may determine the appropriate rule(s) corresponding to the identified search tool(s) for extracting search terms and/or phrases from a URL. At step 1520, the search term/phrase extractor 245 may extract search terms and/or phrases from the URL.

As shown in FIG. 11, the various systems and methods of the invention may also include a conversion failure identification module 250 that, in some embodiments, may enable contextual information module 105, for example, to track or trace user-initiated actions through any number of files, servers, systems and/or networks without relying on personally identifiable information (PII). In some embodiments, conversion failure identification module may identify and monitor actions resulting from user initiation of online information, such as an online advertisement, for example. In some embodiments, such actions may comprise direct or indirect actions to an ultimate destination, such as an ultimate URL, for example. The click tracing features and functions of conversion failure identification module 250 may enable an administrator of system 100, for example, to monitor overall click-through success rates and to identify potential error or failure points and/or sources. Click-through refers to the successful transfer of a user to an ultimate destination (e.g., URL) following initiation of online information. In some embodiments, conversion failure identification module 250 may identify failure or path information regarding third-party hosted content, thus allowing information flow to be captured from systems and networks both internal and external to system 100, for example.

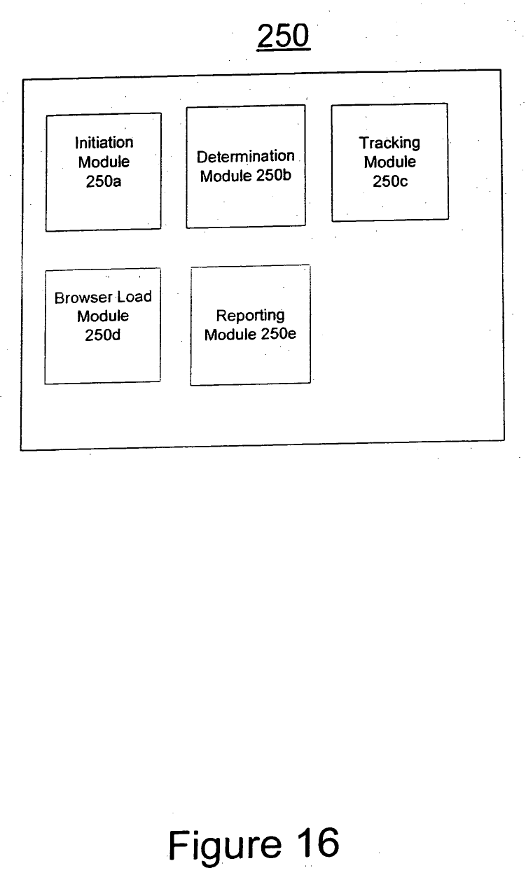

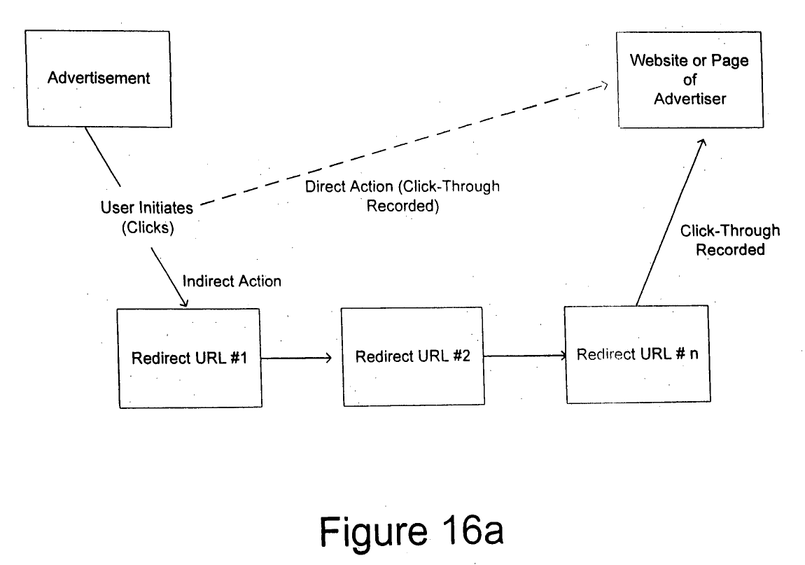

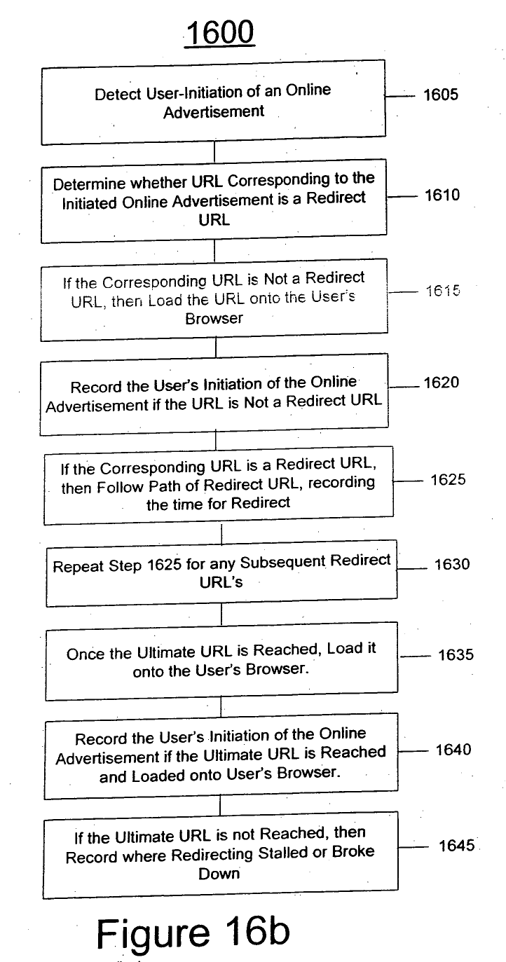

FIG. 16 illustrates one embodiment of a conversion failure identification module 250 comprising an initiation module 250a, a determination module 250b, a tracking or tracing module 250c, a browser load module 250d, and a reporting or sponsor interface module 250e. In some embodiments, initiation module 250a may monitor and detect user initiation of online advertisement. For example, initiation module 250a may detect when a user of client station 110 clicks on a particular online advertisement while browsing the Internet, for example. In some embodiments, user initiation of online information may result in at least one action for resolving the user's initiation of online information. In some embodiments, the at least one action comprises the process of loading of additional data or information relating to the initiated online information, such as the web site or page of a manufacturer in the case of online advertisement, for example. In some embodiments, the at least one action may comprise a URL encoded to load particular data or information. The at least one action may comprise a direct action in which case the action may comprise an ultimate URL, for example, or an indirect action comprising an indirect or redirect URL preceding the ultimate URL.

For example, a user initiating an online advertisement for a particular automobile may result in manufacturer's URL being formulated and loaded onto the user's browser. However, in some cases, an indirect or redirect URL may be loaded instead, taking the user through various intermediate files, servers, systems or networks before ultimately arriving at the ultimate URL. Typically such intermediate files servers, systems or networks may comprise or correspond to third party systems and networks that monitor or process user initiation patterns, for example.

Upon user initiation of online information, determination module 250b may determine whether the resulting at least one action comprises a direct or indirect action. In some embodiments, determination module may determine whether initiation of online information results in the ultimate URL or an indirect or redirect URL. If an indirect or redirect action (or URL) results, tracking module 250c may trace or track the process or path of indirect or redirect actions prior to loading or arriving the ultimate URL. Should an error or failure occur at any point throughout the path of indirect or redirect actions, tracking module 250c may record such an event and report its occurrence as necessary. In some embodiments, an error or failure event may be reported to an administrator of system 100, to the sponsor or entity associated with the initiated online information, or to any third party that monitors or processes initiation of online information. However, if determination module 250b determines that an ultimate URL results, or once the indirect or redirect URL's arrive at the ultimate URL, browser load module 250d may load the ultimate URL onto the user's browser and register a successful click-through of the online information. In some embodiments, once the ultimate URL is loaded onto a user's browser, a successful click-through may be recorded.

Reporting module 250e may report successful click-throughs and/or errors or failures as necessary. In some embodiments, reports may be generated and presented to an administrator of system 100, to a sponsor of online information, or to a third party that monitors or processes click through statistics of online information.

FIG. 16a illustrates one embodiment of a process flow of the various features and functions of conversion failure identification module 250. As shown, a user may initiate a particular online advertisement, such as by clicking on it, for example. Upon initiation, either a direct or indirect action (e.g., URL) may result. If a direct URL (e.g., ultimate URL) results, the sponsor's ultimate URL may be loaded onto the user's browser, thus routing the user to the web site or page of the sponsor of the advertisement, for example. However, if an indirect URL results, then the user may have to be routed through several indirect or redirect URLs before ultimately reaching the sponsor's web sit or page. In some embodiments, rather than loading each indirect or redirect URL onto the user's browser, conversion failure identification module 250 may internally follow, track or trace the path taken by each of the redirect URLs, loading only the ultimate URL if and when it is reached. In some embodiments, conversion failure identification module 250 may record the time consumed by each or all indirect or redirect URL's leading up to the ultimate URL. In some embodiments, conversion failure identification module 250 may record an error or failure in reaching the ultimate URL.

FIG. 16b illustrates a method 1600 for tracking or tracing at least one action resulting from user initiation of online information. At step 1605, conversion failure identification module 250 may detect user initiation of online information. At step 1610, conversion failure identification module 250 may determine whether the action (e.g., URL) resulting from the user's initiation of online information comprises a direct or indirect/redirect action. At step 1615, if the action is direct, then the user's browser may be loaded with the ultimate URL corresponding to the initiated information. In some embodiments, at step 1620, a successful click-through of the online information may be recorded. However, if the action is indirect or redirect, then at step 1625 conversion failure identification module 250 may internally, for example, track, trace or follow the path of all indirect or redirect URLs up to such time as the ultimate URL is reached. In some embodiments, conversion failure identification module 250 may record the total time consumed by the indirect or redirect action. At step 1630, conversion failure identification module 250 may repeat step 1625 for each subsequent indirect or redirect action that occurs prior to the ultimate URL being reached.

At step 1635, once the ultimate URL is reached, conversion failure identification module 250 may load it onto the user's browser. At step 1640, conversion failure identification module 250 may record the successful click-through and associated path of the online information. At step 1645, however, if the ultimate URL is not reached, for whatever reason, then conversion failure identification module 250 may record the failure event, and, if known, the reason for failure, along with the external path along which the failure was encountered.

As shown in FIG. 11, the various systems and methods of the invention may also include a scalable storage module 255 that, in some embodiments, may store onto at least one file on the user's computer data or information relating to the contextual environment which may then be leveraged in the contextual decision making process. Such data or information may comprise, for example, particulars on the user's browsing history, web sites or pages frequently visited, favorite web sites or pages, contextual information presented or viewed, and purchases or transactions conducted, for example. In some embodiments, contextual environment data or information may be used to determine whether the user should be shown a particular piece or form of contextual information.

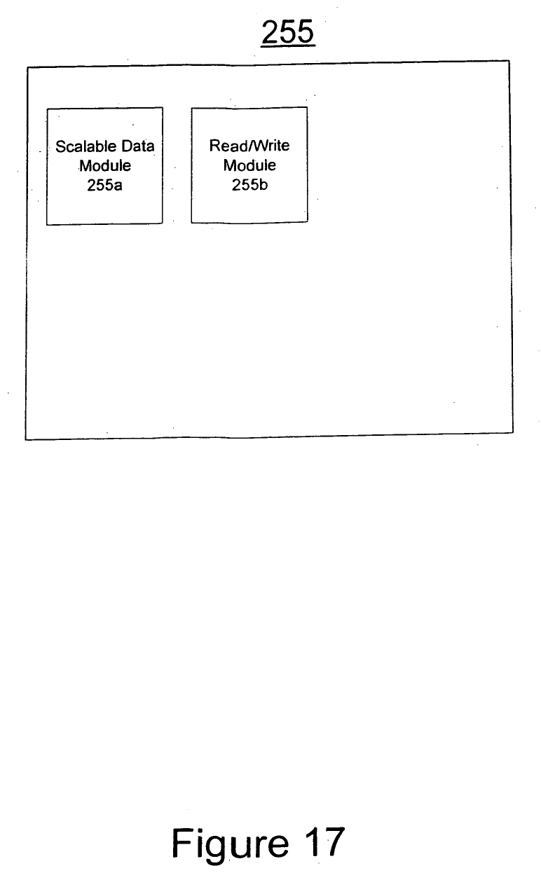

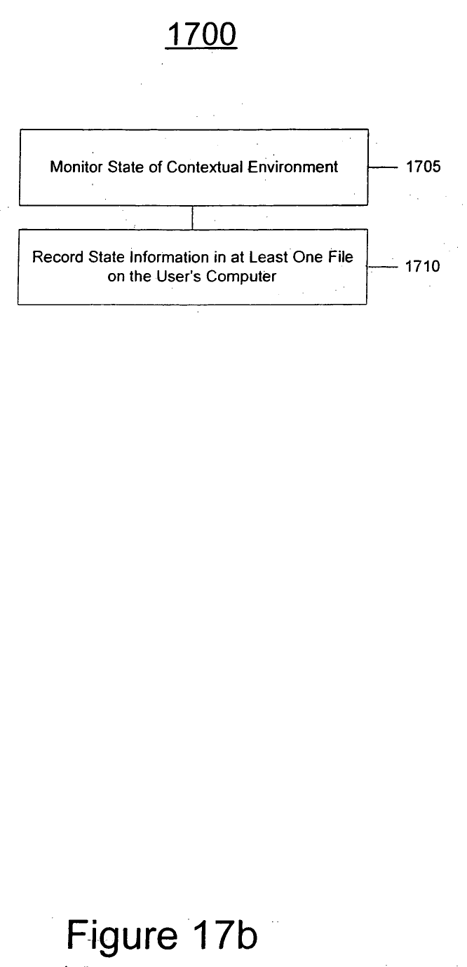

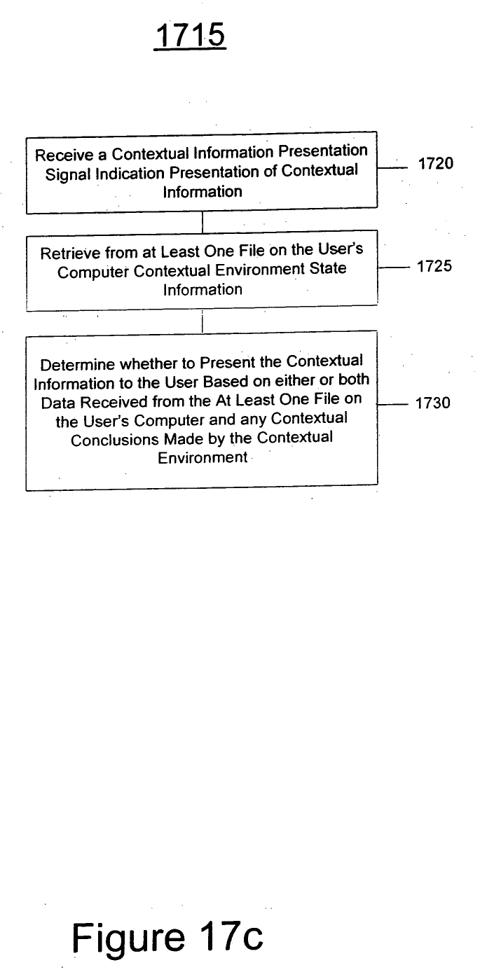

FIG. 17 illustrates one embodiment of a scalable storage module 255 comprising a scalable data module 255a and a read/write module 255b. In some embodiments, scalable storage module 255 may comprise a general purpose storage module that may make use of disk storage on a local computer (e.g., client station 110) to store all forms of state information that may be relevant to the contextual environment. In some embodiments, state information may comprise history of contextual environment events, behavioral statistics or activities, and/or other similar variables or parameters.

In some embodiments, scalable data module 255a may monitor and record a contextual environment activities over a network, such as the Internet, for example. For example, scalable data module 255a may monitor a user's browsing history, the web sites or pages frequently visited or viewed by the user, particular transactions the user engages in online, and categories of content the user favors, for example. Scalable data module 255a may also monitor and record contextual information viewed by the user, taking particular note of when, and under what circumstances, the user viewed the contextual information. For example, if a user is presented with contextual information comprising a particular advertisement, scalable data module 255a may note the date, time, and/or circumstances (e.g., upon viewing a particular website or page) under which the user was presented with the advertisement.

Read/write module 255b may interface with the user's computer to coordinate the storing (and retrieval) of behavioral data and information monitored by behavioral data module 255a. In some embodiments, read/write module 255b may store (and later access) such behavioral data and information onto at least one file stored on the user's computer.

FIG. 17a illustrates one embodiment of a process flow for using contextual environment data and information to determine whether particular contextual information should be presented to a user. As shown, a particular contextual information (e.g., advertisement) may be eligible to be presented to a user. In some embodiments, scalable storage module 255b may retrieve contextual environment data or information from at least one file on the user's computer to determine whether the advertisement should be presented to the user. Resolving particulars of the advertisement against the data and information on the user's computer, scalable storage module 255 may then determine whether to present the advertisement to the user. For example, the user may be presented with advertisement if the user has not previously viewed the advertisement or if the user typically responds to similar advertisements. Other rules are of course possible.

FIG. 17b illustrates a method 1700 for storing data or information relating to a user's online behavior or activities. At step 1705, scalable storage module 255 may monitor the state of contextual environment. In some embodiments, state information may comprise any of the above and/or contextual conclusions, temporary variables, and/or persistent variables used in the contextual decision process or maintenance of persistence of the contextual environment on the user's desktop, for example.

At step 1710, scalable storage module 255 may store or record state of contextual environment data and information in at least one file on the user's computer.

FIG. 17c illustrates a method 1715 for using behavior data or information stored on a user's computer to determine whether to present the user with contextual information. At step 1720, scalable storage module 255 may receive a signal indicating that a particular piece of contextual information is about to be presented to a user. In some embodiments, the signal may be received from contextual information module 105. At step 1725, scalable storage module 255 may retrieve from at least one file on the user's computer contextual environment state information. At step 1730, scalable storage module 255 may determine whether to present the contextual information to a user. In some embodiments, the determination may be based on either or both of data received from at least one file on the user's computer and any contextual conclusions made by the contextual environment.

The various embodiments of the systems and methods described and claimed herein provide numerous advantages. For example, the systems and methods permit systems and methods for providing contextual information to enhance and refine accurate delivery and presentation of contextual information to users based on demonstrated interest, past user behavior, particulars about a session and/or station, and/or any other factors or parameters.

Other embodiments, uses and advantages of the present invention will be apparent to those skilled in the art from consideration of the specification and practice of the invention disclosed herein. The specification and examples should be considered exemplary only.

1. A method for processing a request for contextual information, comprising:
receiving a request for contextual information from a client;
determining particulars of the request; and
determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

2. The method of claim 1 wherein the request for information comprises information about a user's interaction with a network or at least one application or program.

3. The method of claim 1 wherein the step of determining particulars about the request comprises determining uniform resource locators (URLs), keywords, terms, phrases, strings, tokens, concepts, categories or other data or information relevant to a user's interaction with a network or at least one application or program.

4. The method of claim 1 wherein the request is composed at the client.

5. The method of claim 1 wherein the request is received by a service provider module.

6. The method of claim 5 wherein the request is transmitted by the client to the service provider module over a communications network.

7. The method of claim 1 wherein determining an appropriate response further comprises resolving particulars of the request against at least one table.

9. The method of claim 1 further comprising the step of providing contextual information to the client, the contextual information being based on the response.

10. A system for processing a request for contextual information, comprising:
a request interface module for receiving a request for contextual information from a client;
a request processing module for determining particulars of the request; and
determination means for determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

11. The system of claim 10 wherein the request for information comprises information about a user's interaction with a network or at least one application or program.

12. The system of claim 10 wherein determining particulars about the request comprises determining uniform resource locators (URLs), keywords, terms, phrases, strings, tokens, concepts, categories or other data or information relevant to a user's interaction with a network or at least one application or program.

13. The system of claim 10 wherein the request is composed at the client.

14. The system of claim 10 wherein the request is received by a service provider module.

15. The system of claim 14 wherein the request is transmitted by the client to the service provider module over a communications network.

16. A system for processing a request for contextual information, comprising:
request reception means for receiving a request for contextual information from a client;
request determination means for determining particulars of the request; and
response determination means for determining an appropriate response to the request, the appropriate response comprising at least one selected from the group comprising of: (1) enhancing, adding, or deleting select particulars of the request, (2) determining at least one appropriate sponsor or provider to fulfill the request, and (3) determining appropriate contextual information to present to the client in response to the request.

17. The system of claim 16 wherein the request for information comprises information about a user's interaction with a network or at least one application or program.

18. The system of claim 16 wherein determining particulars about the request comprises determining uniform resource locators (URLs), keywords, terms, phrases, strings, tokens, concepts, categories or other data or information relevant to a user's interaction with a network or at least one application or program.

19. The system of claim 16 wherein the request is composed at the client.

20. The system of claim 16 wherein the request is received by a service provider module.

21. The system of claim 16 further comprising a response formatting means for formatting the response prior to delivery to the client.

22. The system of claim 16 wherein the format of the response is based on the sponsor or provider selected, the partner from which the response came, or the client or user on which the request is based.
